(19) United States
(12) Patent Application Publication
(10) Pub. No.: US 2025/0126009 A1
(43) Pub. Date: Apr. 17, 2025

(54) PAPR REDUCTION BASED ON PULSE SHAPING OPERATION IN WIRELESS COMMUNICATION SYSTEM

(71) Applicant: Samsung Electronics Co., Ltd., Suwon-si (KR)

(72) Inventors: Soheil Rostami, Carrollton, TX (US); Fabrizio Carpi, Brooklyn, NY (US); Joonyoung Cho, Portland, OR (US)

(21) Appl. No.: 18/649,887

(22) Filed: Apr. 29, 2024

Related U.S. Application Data
(60) Provisional application No. 63/543,595, filed on Oct. 11, 2023.

(51) Int. Cl. H04L 27/26

(52) U.S. Cl. CPC H04L 27/2636; H04L 27/2614; H04L 27/26536

(57) ABSTRACT

Methods and apparatuses for PAPR reduction based on a pulse shaping operation in a wireless communication system. A method of operating a UE includes: converting, using a DFT, a modulated block of data symbols to a first symbol block in a frequency domain; extending, based on a spectral extension ratio associated with extended subcarriers (Nₛₑ), the first symbol block to a second symbol block with a length that is identified based on a number of scheduled subcarriers (N_{SC}), wherein the second symbol block is symmetrically extended DFT symbol block; generating, using an FDSS filter with a number of tap values (N_{P}), third symbol block based on the second symbol block that is symmetrically extended DFT symbol block; mapping the generated third symbol block to the N_{SC}; generating, based on the mapped third symbol block, OFDM symbols in a time domain using an IFFT; and transmitting, to a BS, signals including the OFDM symbols.

### CROSS-REFERENCE TO RELATED APPLICATIONS AND CLAIM OF PRIORITY

The present application claims priority to U.S. Provisional Patent Application No. 63/543,595, filed on Oct. 11, 2023. The contents of the above-identified patent documents are incorporated herein by reference.

### TECHNICAL FIELD

The present disclosure relates generally to wireless communication systems and, more specifically, the present disclosure relates to a peak-to-average power ratio (PAPR) reduction based on a pulse shaping operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a PAPR reduction based on a pulse shaping operation in a wireless communication system.

In one embodiment, a user equipment (UE) in a wireless communication system is provided. The UE comprises a processor configured to: convert, using a discrete Fourier transform (DFT), a modulated block of data symbols to a first symbol block in a frequency domain; extend, based on a spectral extension ratio associated with extended subcarriers (Nₛₑ), the first symbol block to a second symbol block with a length that is identified based on a number of scheduled subcarriers (N_{SC}), wherein the second symbol block is symmetrically extended DFT symbol block, generate, using a frequency domain spectrum shaping (FDSS) filter with a number of tap values (N_{P}), third symbol block based on the second symbol block that is symmetrically extended DFT symbol block, and map the generated third symbol block to the N_{SC}, and generate, based on the mapped third symbol block, orthogonal frequency division multiplexing (OFDM) symbols in a time domain using an inverse fast Fourier transform (IFFT). The UE further comprises a transceiver operably coupled to the processor, the transceiver configured to transmit, to a base station (BS), signals including the OFDM symbols.

In another embodiment, a method of UE in a wireless communication system is provided. The method comprising: converting, using a DFT, a modulated block of data symbols to a first symbol block in a frequency domain; extending, based on a spectral extension ratio associated with Nₛₑ, the first symbol block to a second symbol block with a length that is identified based on the N_{SC}, wherein the second symbol block is symmetrically extended DFT symbol block; generating, using an FDSS filter with N_{P}, third symbol block based on the second symbol block that is symmetrically extended DFT symbol block; mapping the generated third symbol block to the N_{SC}; generating, based on the mapped third symbol block. OFDM symbols in a time domain using an IFFT; and transmitting, to a BS, signals including the OFDM symbols.

In yet another embodiment, a BS in a wireless communication system, the BS comprises a processor and a transceiver operably coupled to the processor, the transceiver configured to receive, from a UE, signals including OFDM symbols, wherein: a modulated block of data symbols is converted to a first symbol block in a frequency domain using a DFT, based on a spectral extension ratio associated with Nₛₑ, the first symbol block is extended to a second symbol block with a length that is identified based on N_{SC}, wherein the second symbol block is symmetrically extended DFT symbol block, using an FDSS filter with a number of tap values (N_{P}), third symbol block is generated based on the second symbol block that is symmetrically extended DFT symbol block, the generated third symbol block is mapped to the N_{SC}, and based on the mapped third symbol block, the OFDM symbols are generated in a time domain using an IFFT.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C. B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRA WINGS

For a more complete understanding of the present disclosure and its advantages, reference is now made to the following description taken in conjunction with the accompanying drawings, in which like reference numerals represent like parts:

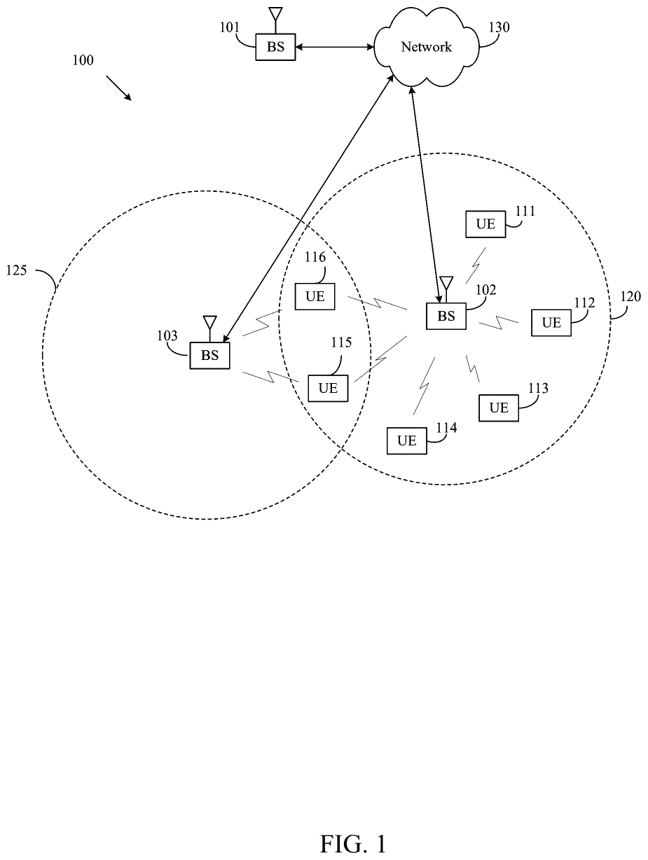

FIG. 1 illustrates an example of wireless network according to embodiments of the present disclosure;

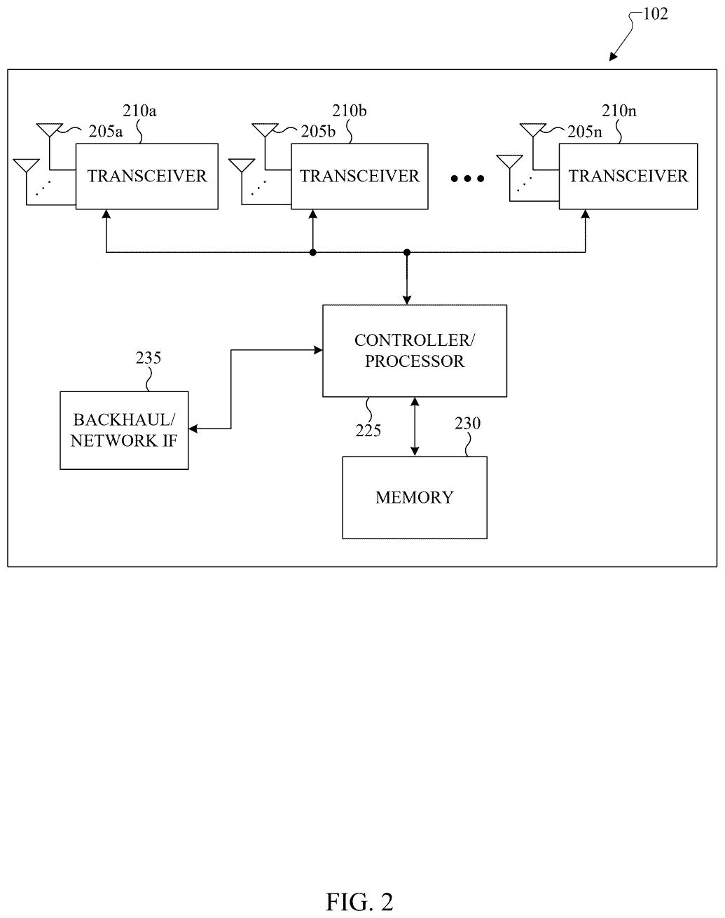

FIG. 2 illustrates an example of gNB according to embodiments of the present disclosure;

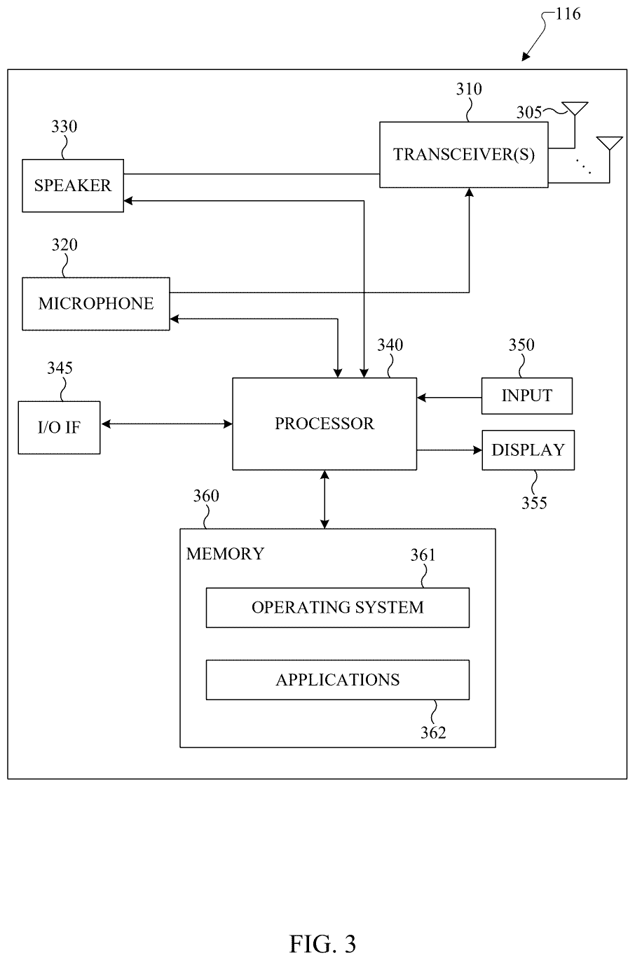

FIG. 3 illustrates an example of UE according to embodiments of the present disclosure;

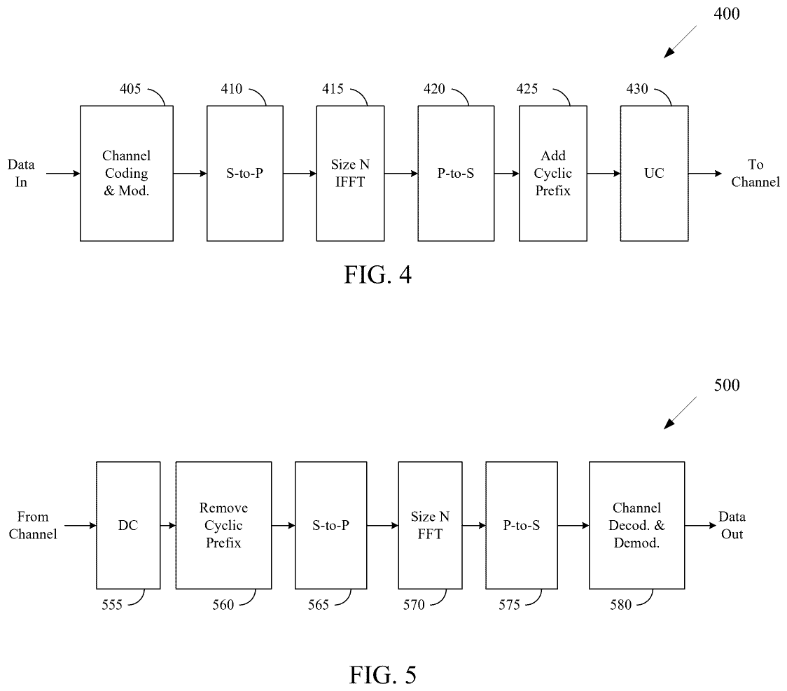

FIGS. 4 and 5 illustrate example of wireless transmit and receive paths according to this disclosure;

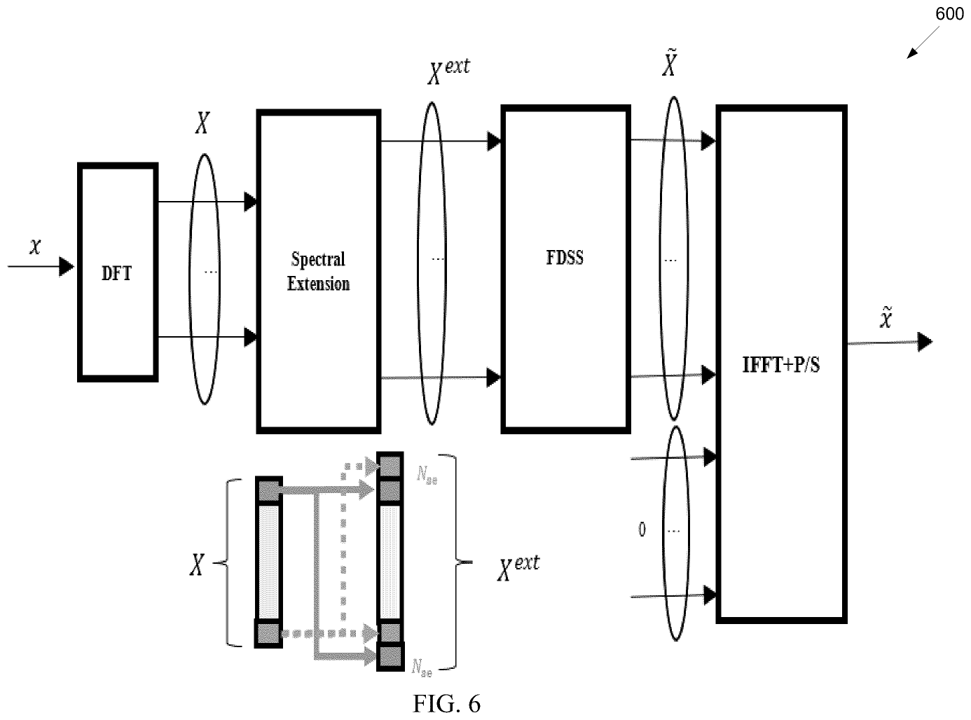

FIG. 6 illustrates an example of Tx architecture for FDSS-DFT-S-OFDM and spectral extension operation according to embodiments of the present disclosure;

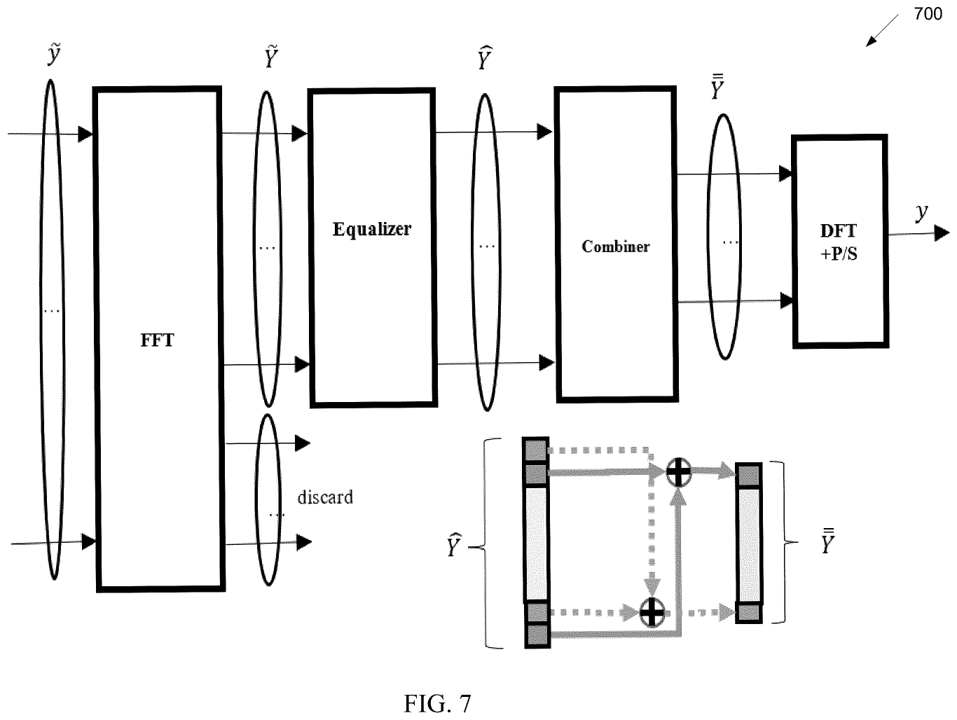

FIG. 7 illustrates an example of Rx architecture for FDSS-DFT-S-OFDM and combiner operation according to embodiments of the present disclosure;

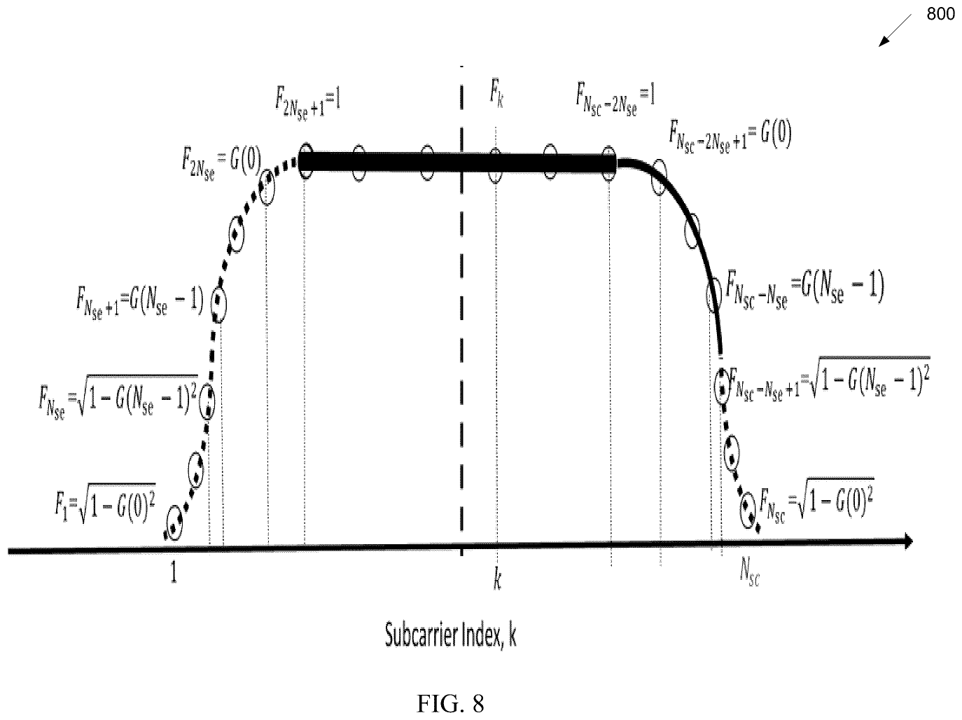

FIG. 8 illustrates an example of ISI-free flat structure according to embodiments of the present disclosure;

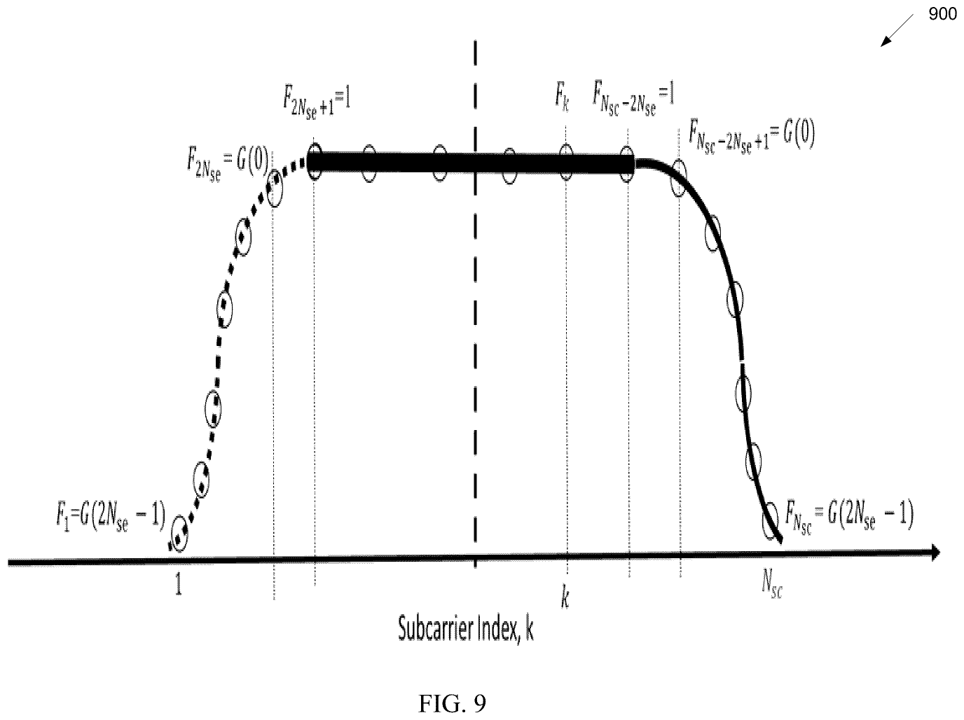

FIG. 9 illustrates an example of flat structure according to embodiments of the present disclosure;

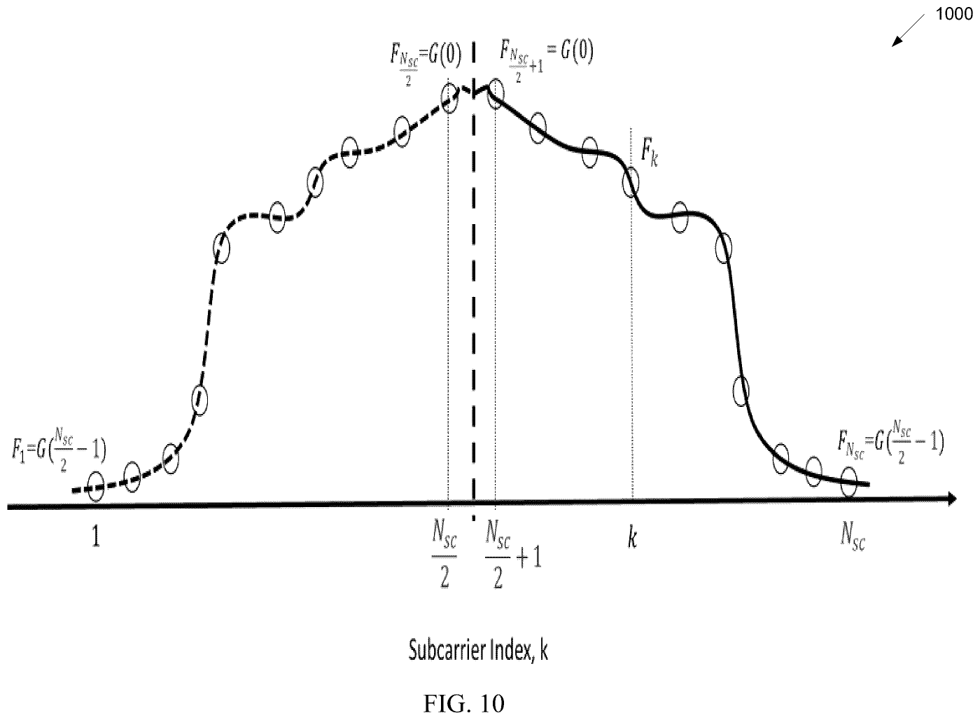

FIG. 10 illustrates an example of non-flat structure according to embodiments of the present disclosure;

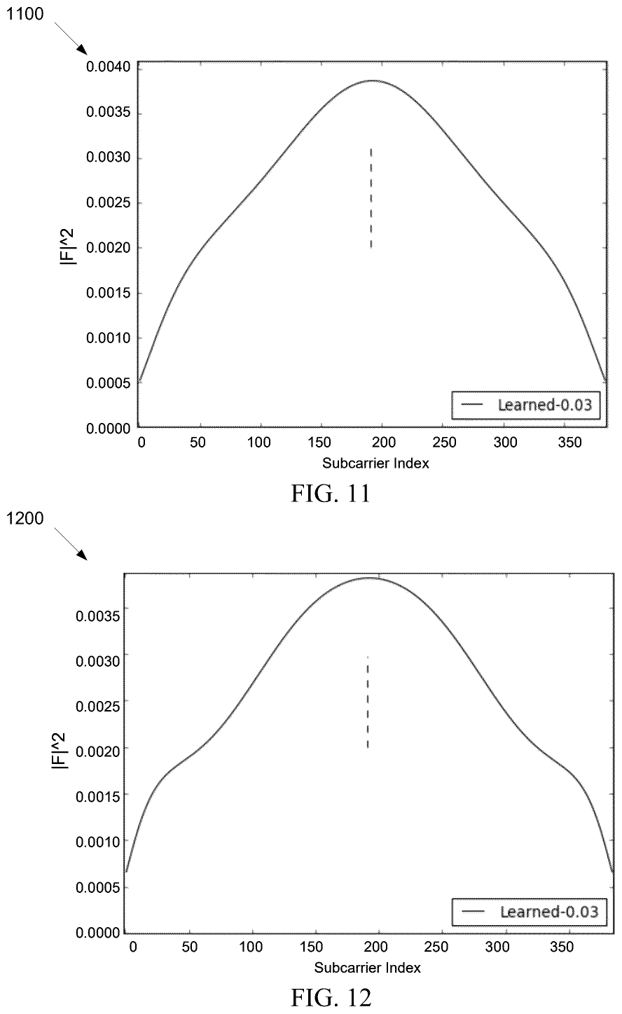

FIGS. 11-14 illustrate examples of polynomial design for non-flat structure according to embodiments of the present disclosure;

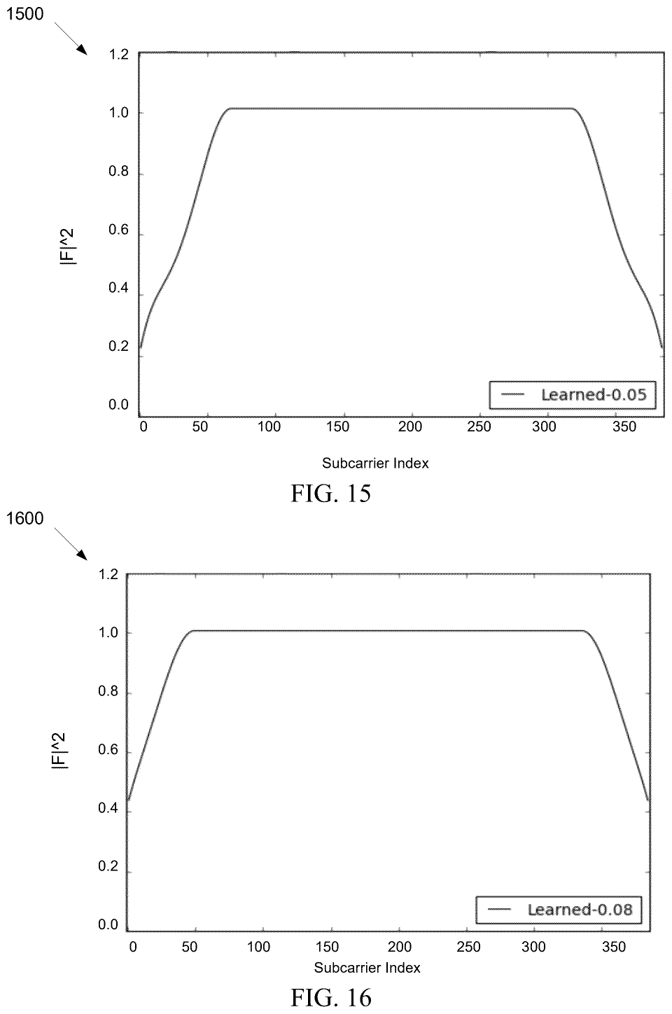

FIGS. 15-18 illustrate examples of polynomial design for flat structure according to embodiments of the present disclosure;

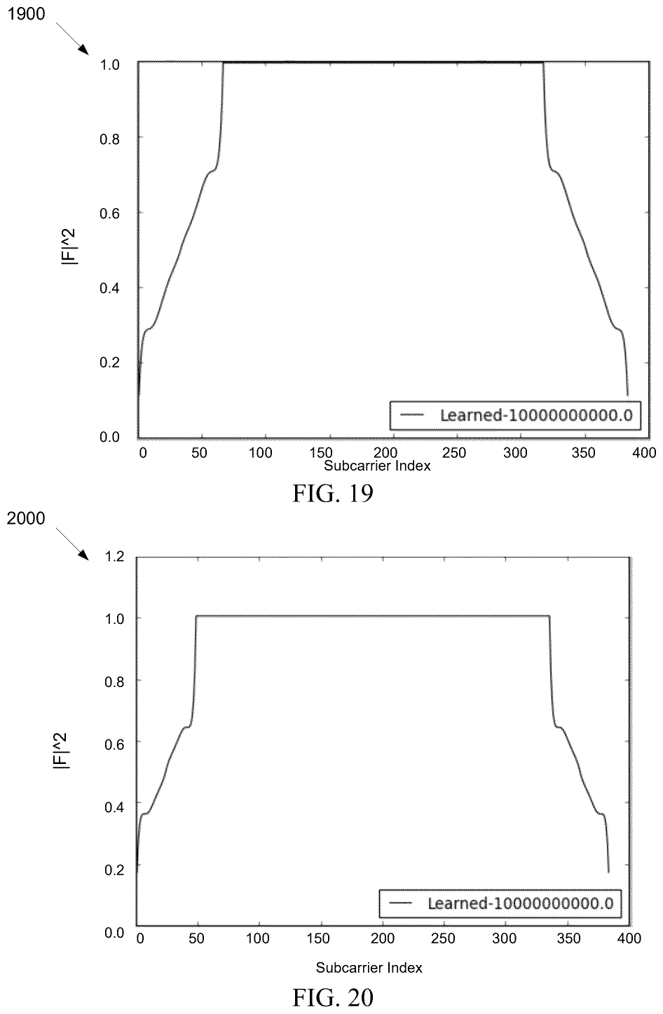

FIGS. 19-25 illustrate examples of polynomial design for ISI-free flat structure according to embodiments of the present disclosure;

FIGS. 26-28 illustrate examples of polynomial design for flat structure according to embodiments of the present disclosure;

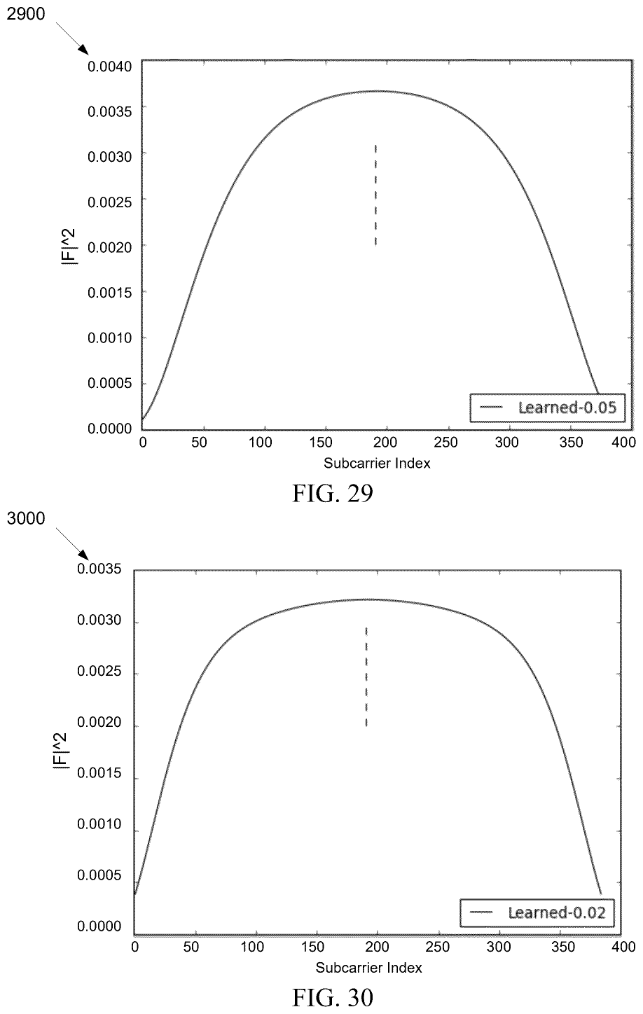

FIGS. 29-31 illustrate examples of polynomial design for non-flat structure according to embodiments of the present disclosure;

FIG. 32 illustrates an example of ISI-free flat according to embodiments of the present disclosure;

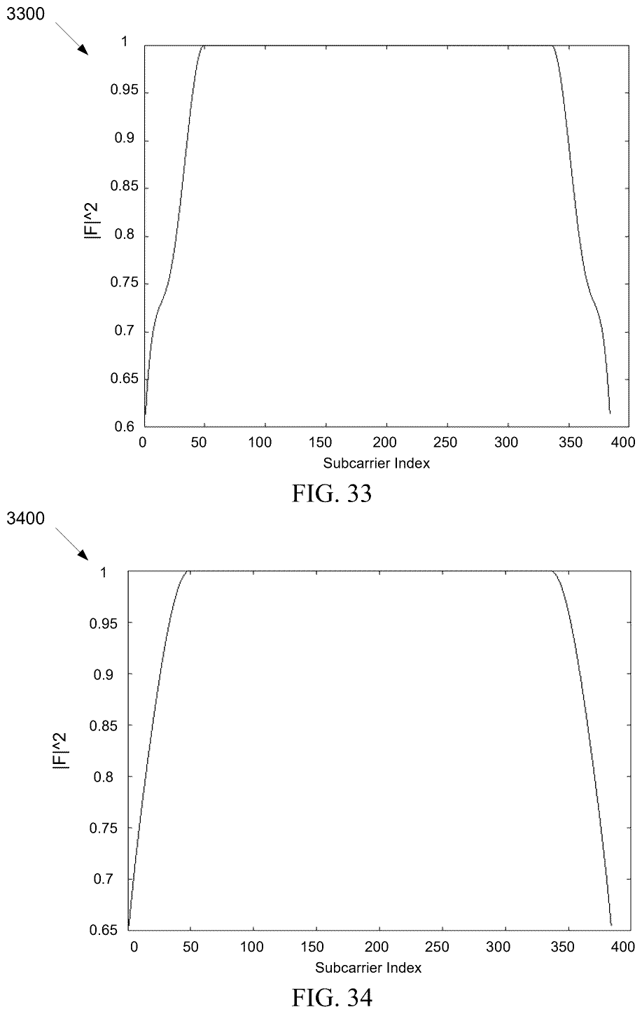

FIG. 33 illustrates an example of flat 2 design according to embodiments of the present disclosure;

FIG. 34 illustrates an example of flat 1 design according to embodiments of the present disclosure;

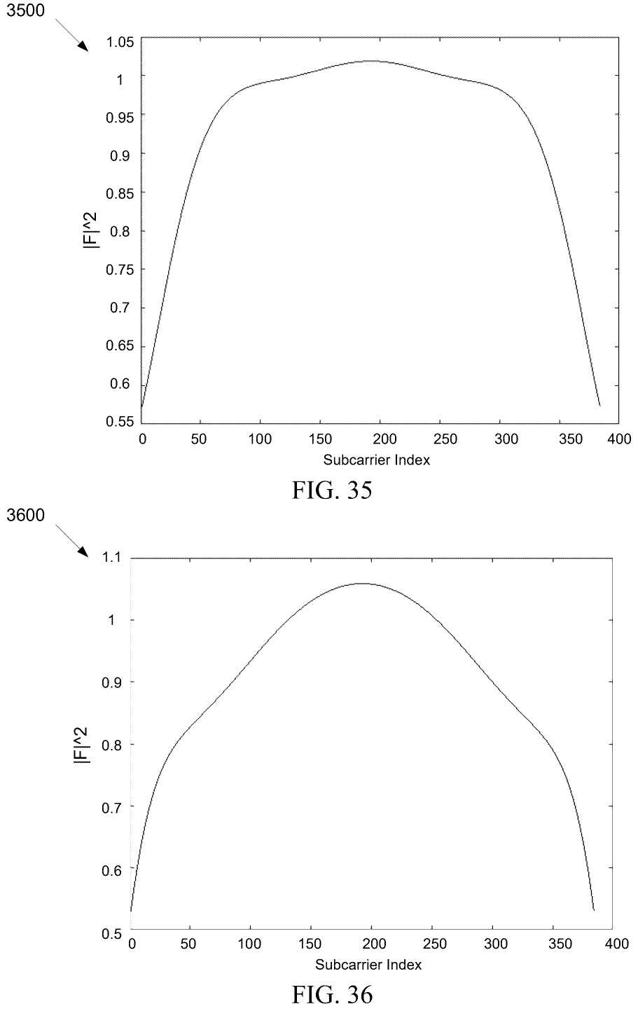

FIG. 35 illustrates an example of almost flat 2 design according to embodiments of the present disclosure;

FIG. 36 illustrates an example of almost flat 1 design according to embodiments of the present disclosure;

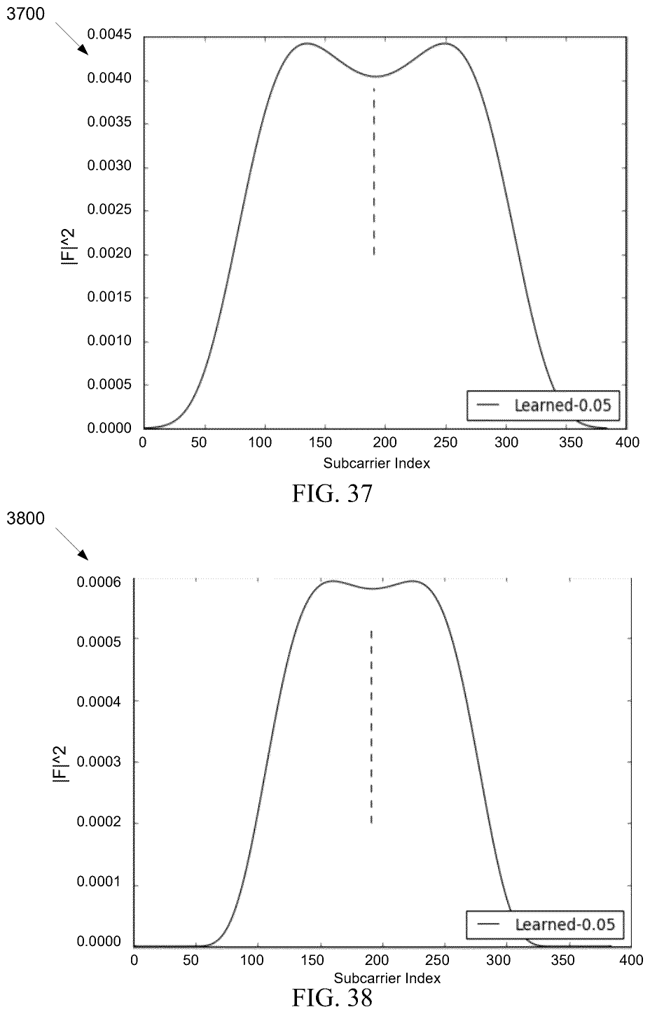

FIGS. 37 and 38 illustrate examples of filter design for non-flat structure according to embodiments of the present disclosure; and

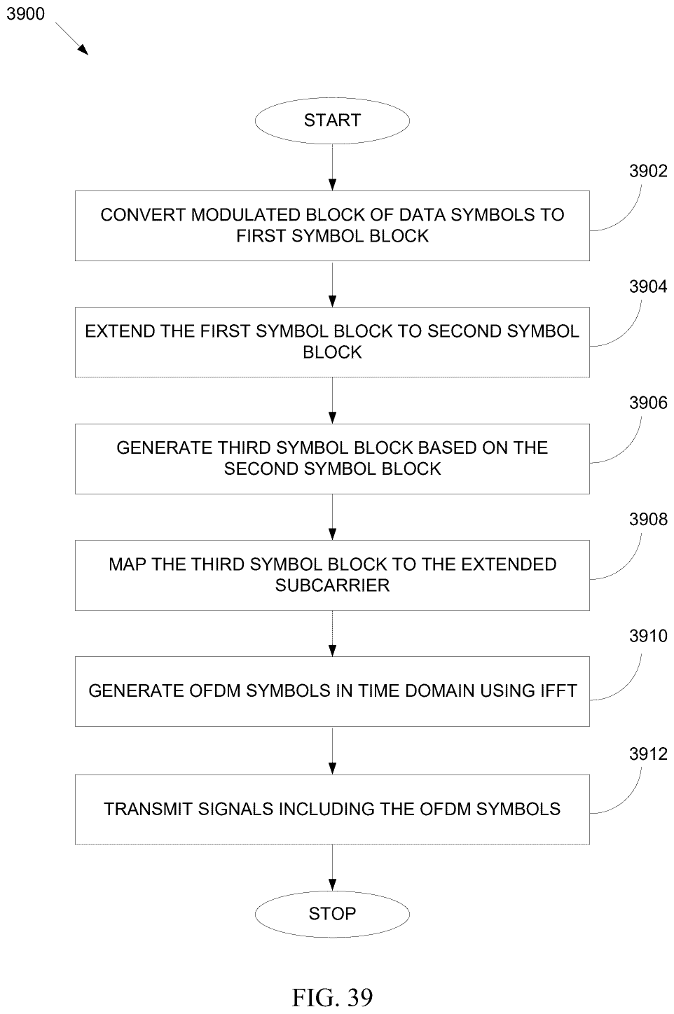

FIG. 39 illustrates a flowchart of a method for a PAPR reduction based on a pulse shaping operation in a wireless communication system according to embodiments of the present disclosure.

### DETAILED DESCRIPTION

FIGS. 1-39, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz. (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a Wifi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols. e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station.” “subscriber station.” “remote terminal.” “wireless terminal.” “receive point.” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a PAPR reduction based on a pulse shaping operation in a wireless communication system. In certain embodiments, and one or more of the gNBs 101-103 includes circuitry, programing, or a combination thereof, for supporting a PAPR reduction based on a pulse shaping operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a PAPR reduction based on a pulse shaping operation in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a PAPR reduction based on a pulse shaping operation in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support a PAPR reduction based on a pulse shaping operation in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Discrete Fourier transform spreading OFDM (DFT-s-OFDM) is a single carrier waveform with low peak-to-average power ratio (PAPR) and could be a promising candidate waveform for B5G and 6G systems. Improving PAPR of DFT-s-OFDM may improve power amplifier efficiency, uplink coverage range and power consumption of UEs.

There are different PAPR reduction techniques for DFT-S-OFDM (such techniques may introduce signal distortion and sacrifice SE). Among them, a pulse shaping (also known as spectrum shaping) is known as a data-independent and low-complexity technique to reduce DFT-s-OFDM's PAPR at the cost of spectral extension (additional required subcarriers) and potentially higher symbol-error rate (SER).

Frequency domain spectrum shaping (FDSS) and time domain spectrum shaping (TDSS) are two equivalent solutions to implement spectrum shaping. However, due to DFT-s-OFDM, FDSS method is a more computationally efficient and flexible. Moreover, the power of the side lobes for FDSS is lower than the TDSS.

The Discrete Fourier transform spreading OFDM (DFT-s-OFDM) has been adopted and commercialized as a key uplink waveform for the 3GPP 4G/5G mobile communication systems and widely regarded as the baseline waveform of B5G/6G systems.

In DFT-s-OFDM, the application of DFT spreading operation prior to subcarrier mapping spreads the signal's energy across subcarriers, effectively achieves lower PAPR compared to OFDM, and improves power amplifier efficiency and reduces the risk of distortion. The pulse shaping filter is preceded by the spectral extension (SE) operation to reduce PAPR at the expense of the spectral extension.

While DFT-s-OFDM offers notable advantages, optimizing the pulse shaping filter presents a unique challenge, considering a tradeoff between SER, PAPR, spectral extension, complexity and spectral flatness requirements.

Conventionally, pulse shaping filters have been defined using well-established mathematical functions, such as cosine or exponential, offering limited flexibility in tailoring the filter to specific requirements. Recent works have explored parametric construction for the pulse shaping and combination of hyperbolic functions. However, such pulse shapes may not achieve the best SER-PAPR trade-offs for given spectral extension.

It can be shown that end-to-end learning process to obtain filter values in a data-driven fashion can outperform conventional baselines in terms of PAPR, with minimal SER degradation. By imposing specific filter structures, such FDSS parameters could be learned to achieve desired SER-PAPR-flatness-complexity trade-off, in which could be flexibly adapted for different number of resource blocks without re-training/learning of parameters.

The present disclosure introduces a novel approach to enhance the performance of DFT-s-OFDM systems by learning FDSS filter parameters over specific spectrum shapes. Leveraging advances in machine learning and deep learning techniques, a method is provided to train FDSS filters to achieve superior PAPR reduction while maintaining SER.

The learned parameters of FDSS for given SE can be utilized for arbitrary number of scheduled resource blocks. Moreover, different shapes/structures for FDSS are introduced to impose flatness and ISI-free constraints on filter design. Disclosed by methods for configuring filter values based on different SE ratio and number of RBs. Additionally, the abovementioned methods to adapt the learned parameters for different number of resource blocks without re-training parameters could be utilized for different objectives (not necessarily for PAPR improvement, e.g., sensing).

FDSS-DFT-S-OFDM offers flexibility a backward compatible with 4G/5G(rectangular pulse shaping without SE), while striking better SER, PAPR, complexity and spectral flatness requirements. Low implementation complexity, no side information at the Rx, small modification of original architecture of DFT-s-OFDM, backward compatibility can make FDSS-DFT-s-OFDM a waveform candidate for B5G and 6G systems.

The embodiments of the present disclosure are applicable in general to any communication system.

A modulated (e.g., π/2 BPSK, QPSK) block of N_{data} symbols x=[x₁, . . . , x_{N}_{_{data}}] is converted into the symbol block in frequency domain as X=[X₁, . . . , X_{N}_{_{data}}] by DFT with length N_{data}.

FIG. 6 illustrates an example of Tx architecture 600 for FDSS-DFT-S-OFDM and spectral extension operation according to embodiments of the present disclosure. An embodiment of the Tx architecture 600 shown in FIG. 6 is for illustration only.

FIG. 6 illustrates an example of signal processing block diagram at Tx side to generate FDSS-DFT-s-OFDM signal for input symbols x. It can be shown that the output of IFFT (x) is equivalent to time domain version of filtered signal of DFT-S-OFDM.

The DFT symbol block is circularly extended to a symbol block with length N_{sc} as X^{ext}=[Xₑₓₜ¹, . . . , X_{N}_{_{sc}}^{ext}]=[X_{N}_{_{data}}−Nₛₑ₊₁, . . . , X_{N}_{_{data}}, X₁, . . . , X_{N}_{_{data}}, X₁, . . . , X_{N}_{ₛₑ}], where 2Nₛₑ is the number of extended subcarriers and N_{sc}=N_{data}+2Nₛₑ is the total number of subcarriers. Spectral extension (SE) ratio is defined as

$$S E = \frac{2 {N}_{s e}}{{N}_{data}} = \frac{2 {N}_{s e}}{{N}_{s c} - 2 {N}_{s e}} ,$$

ranging from 0 (no spectral extension) to 1 (100% spectral extension).

The symmetrically extended DFT symbol block with length N_{sc} goes through the FDSS filter with the tap values of F=[F₁, . . . , Fₖ, . . . , F_{N}_{_{sc}}], where Fₖ is frequency domain filter tap corresponding to k^{th} subcarrier. This could be achieved by computationally efficient operation of element wise multiplication \tilde{X}=X^{ext}⊙F.

The filtered symbol block \tilde{X} is mapped to the scheduled subcarriers and is converted into the OFDM symbol in time domain by IFFT with length of N_{fft} as \tilde{x}=[\tilde{x}₁, . . . , \tilde{x}_{N}_{_{fft}}], and the CP is attached for transmission by a UE.

An operation of DMRS is similar to the operation of data from the spectrum extension module, where UE applies same FDSS for both data and DMRS.

The receiver (e.g., gNB) removes the CP of the received OFDM symbol, obtains the samples with length N_{fft} as \tilde{y}=[\tilde{y}₁, . . . , \tilde{y}_{N}_{_{fft}}], then converts the samples into the symbol block in frequency domain and extracts corresponding number of subcarriers with length N_{SC}, i.e., \tilde{Y}=[\tilde{Y}₁, . . . , \tilde{Y}_{N}_{_{sc}}].

FIG. 7 illustrates an example of Rx architecture 700 for FDSS-DFT-S-OFDM and combiner operation according to embodiments of the present disclosure. An embodiment of the Rx architecture 700 shown in FIG. 7 is for illustration only.

FIG. 7 illustrates an example of signal processing block diagram at Rx side to demodulate FDSS-DFT-S-OFDM.

Moreover, the receiver equalizes the symbols on scheduled subcarriers with element wise multiplication,

$$\hat{Y} = \tilde{Y} ⊙ \frac{{F}^{*}}{{\vert \tilde{F} \vert}^{2}}$$

where F* is conjugate of F and \tilde{F}=[F_{N}_{ₛₑ}₊₁+F_{N}_{_{sc}}_{-N}_{ₛₑ}₊₁, . . . , F_{2N}_{ₛₑ}+F_{N}_{_{sc}}, F_{2N}_{ₛₑ}₊₁, . . . , F_{N}_{_{sc}}_{-2N}_{ₛₑ}, F_{N}_{_{sc}}_{-2N}_{ₛₑ}₊₁+F₁, . . . , F_{N}_{_{sc}}_{-N}_{ₛₑ}+F_{N}_{ₛₑ}].

After equalization, to obtain the DFT symbol block with length N_{data}, the corresponding symbols on the spectrum extension and data subcarriers can be combined as schematic is shown in FIG. 7 and can be expressed as follows: Y̅=[Ŷ_{N}_{ₛₑ}₊₁+Ŷ_{N}_{_{sc}}_{-N}_{ₛₑ}₊₁, . . . , Ŷ_{2N}_{ₛₑ}+Ŷ_{N}_{_{sc}}, Ŷ_{2N}_{ₛₑ}₊₁, . . . , Ŷ_{N}_{_{sc}}_{-2N}_{ₛₑ}, Ŷ_{N}_{_{sc}}_{-2N}_{ₛₑ}₊₁+Ŷ₁, . . . , Ŷ_{N}_{_{sc}}_{-N}_{ₛₑ}+ŶNₛₑ].

The DFT symbol block with length N_{data}, Y̅ is converted into the modulated symbol block in time domain with IDFT length N_{data}, y=[y₁, . . . , y_{N}_{_{data}}].

Different FDSS structures/shapes are provided to facilitate learning process of FDSS parameters and achieve desired SER-PAPR-flatness-complexity trade-off.

Real-valued pulses in a time domain exhibit even symmetry in frequency domain, and three symmetrical FDSS structures are introduced to achieve desired trade-off between SER, PAPR, flatness and Complexity. “ISI-free-flat” and “flat” FDSSs are flat over passband, hence does not need any signal processing operation for passband. However, “non-flat” may require higher number of multiplication and memory storage. For “ISI-free-flat,” Nyquist condition of zero-ISI is imposed and does not have any SER loss compared to a case with rectangular pulse shaping without spectral extension. “Non-flat” may achieve lower PAPR (spectrum is bell-shaped) but it may have SER degradation.

For this purpose, G(b) for b=0,1, . . . , Nₚ−1 is defined as a function of b that can completely represent introduced filter structures; Nₚ is number of taps and its value is dependent on FDSS structure, number of extended subcarriers and number of total subcarriers as follows:

$${N}_{p} = \{ \begin{matrix}\begin{matrix}{N}_{se} , & ISIFreeFlat\end{matrix} \\ \begin{matrix}2 {N}_{se} , & Flat\end{matrix} \\ \begin{matrix}\frac{{N}_{sc}}{2} & NonFlat\end{matrix}\end{matrix} . \qquad ( Equation 1 )$$

FIG. 8, FIG. 9, and FIG. 10 illustrate three different FDSS structures with relevant parameters.

FIG. 8 illustrates an example of ISI-free flat structure 800 according to embodiments of the present disclosure. An embodiment of the ISI-free flat structure 800 shown in FIG. 8 is for illustration only.

FIG. 9 illustrates an example of flat structure 900 according to embodiments of the present disclosure. An embodiment of the flat structure 900 shown in FIG. 9 is for illustration only.

FIG. 10 illustrates an example of non-flat structure 1000 according to embodiments of the present disclosure. An embodiment of the non-flat structure 1000 shown in FIG. 10 is for illustration only.

In one example of ISI-free-flat, Nyquist condition is imposed by design (zero-ISI pulse) and FDSS is flat (equals to one) for passband:

$${F}_{k} = \{ \begin{matrix}\begin{matrix}\sqrt{1 - {G ( k - 1 )}^{2}} , & 1 \leq k \leq {N}_{se}\end{matrix} \\ \begin{matrix}G ( - k + 2 {N}_{se} ) , & {N}_{se} + 1 \leq k \leq 2 {N}_{se}\end{matrix} \\ \begin{matrix}1 , & 2 {N}_{se} + 1 \leq k \leq {N}_{sc} - 2 {N}_{se}\end{matrix} \\ \begin{matrix}G ( k - ( {N}_{sc} - 2 {N}_{se} + 1 ) ) , & {N}_{sc} - 2 {N}_{se} + 1 \leq k \leq {N}_{sc} - {N}_{se}\end{matrix} \\ \begin{matrix}\sqrt{1 - {G ( - k + {N}_{sc} )}^{2}} , & {N}_{sc} - {N}_{se} + 1 \leq k \leq {N}_{sc}\end{matrix}\end{matrix} . \qquad ( Equation 2 )$$

For “ISI-free-flat” FDSS, a number of filter parameters Nₚ=Nₛₑ taps determines the FDSS completely: in other words, to construct “ISI-free flat” FDSS, Fₖ with 1≤k≤N_{sc}, Nₛₑ taps (or equivalently G(b)) for subcarrier indexes of N_{sc}−2Nₛₑ+1≤k≤N_{sc}−Nₛₑ (or equivalently for b=0,1, . . . , Nₛₑ−1) is sufficient.

In one example of flat, the passband is constrained to be one and each sideband has 2Nₛₑ taps. For flat structure, number of parameters is Nₚ=2Nₛₑ frequency domain tap values (or equivalently G(b)) of subcarriers with index of N_{sc}−2Nₛₑ+1≤k≤N_{sc} (or equivalently for b=0,1, . . . , 2Nₛₑ−1) is adequate to define FDSS filter Fₖ with 1≤k≤N_{sc}, completely:

$${F}_{k} = \{ \begin{matrix}\begin{matrix}1 - G ( - k + 2 {N}_{s e} ) , & 1 \leq k \leq 2 {N}_{s e}\end{matrix} \\ \begin{matrix}1 , & 2 {N}_{s e} + 1 \leq k \leq {N}_{s c} - 2 {N}_{s e}\end{matrix} \\ \begin{matrix}G ( k - ( {N}_{s c} - 2 {N}_{s e} + 1 ) ) , & {N}_{s c} - 2 {N}_{s e} + 1 \leq k \leq {N}_{s c}\end{matrix}\end{matrix} . \qquad ( Equation 3 )$$

In one example of Non-flat, this filter may not have flat passband, therefore filter has only symmetrical constraint, Fₖ=F_{N}_{_{sc}}₋ₖ₊₁ for k=1, . . . , N_{sc}/2, hence

$${N}_{p} = \frac{{N}_{s c}}{2}$$

is adequate number of taps to define non-flat FDSS. In other words, G(b) for b=0,1, . . . , N_{sc}/2−1 can describe the FDSS, Fₖ with 1≤k≤N_{sc}, completely:

$${F}_{k} = \{ \begin{matrix}\begin{matrix}G ( - k + {N}_{sc} / 2 ) , & 1 \leq k \leq {N}_{sc} / 2\end{matrix} \\ \begin{matrix}G ( \frac{k - 1 - {N}_{sc}}{2} ) , & \frac{{N}_{sc}}{2} + 1 \leq k \leq {N}_{s e}\end{matrix}\end{matrix} . \qquad ( Equation 4 )$$

As it can be seen from FIGS. 8-10 and aforementioned equations (2 to 4), once G(b) for b=0,1, . . . , Nₚ−1 is defined, the complete FDSS filter can be constructed.

AI-based techniques can be exploited to obtain the FDSS parameters with objective of minimizing a loss function for given SE and “FDSS Structure.” Loss function can be defined as a weighted sum of SER, PAPR and spectral flatness.

FDSS parameters can be learnt and optimized based on one of the following ways: (1) polynomial coefficients; (2) frequency domain tap values of FDSS; and (3) time domain tap values of FDSS.

The learnt filter taps provide consistent PAPR improvement for given SE ratio, regardless of QAM order.

In one embodiment of polynomial coefficients, FDSS parameters (i.e., G(b) for b=0,1, . . . , Nₚ−1) are modeled as coefficients using polynomial approximations. By selecting an appropriately high polynomial order, this approach offers the requisite expressiveness to capture the filter's behavior effectively. For this purpose, standard may specify D^{th} order polynomial coefficients (e.g., AI learned), α_{d} for d=0, . . . , D for given FDSS structure and SE. Therefore, UE or BS can calculate G(b) for b=0,1, . . . , Nₚ−1 as follows: G(b)=Σ_{d=0, . . . ,D} α_{d} s(b)^{d} where s(0), . . . , s (Nₚ−1) is the support vector representing equally spaced values with step-size of

$$\frac{2}{{N}_{p} - 1}$$

over interval [−1, +1], and b^{th} element (b=0, . . . , Nₚ−1) of support vector can be calculated as:

$$s ( b ) = - 1 + \frac{2 b}{{N}_{p} - 1} .$$

Finally, once G(b) for b=0,1, . . . , Nₚ−1 is calculated, based on utilizing corresponding equations per FDSS structure (Equation 2 to 4), the complete FDSS can be constructed. The order of D can be specified in the standard, and D could be as small as 2 (e.g., for case of π/2 BPSK).

In one embodiment of frequency domain tap values of FDSS, it is assumed that Pₘ, m=1, . . . , N_{pref} are FDSS taps corresponding to specific set of reference FDSS subcarriers (that is sufficient to define G( )) as follows:

$${P}_{m} , m = 1 , … , {N}_{{p}_{ref}} = \qquad ( Equation 5 )$$

$$\{ \begin{matrix}\begin{matrix}G ( k - ( {N}_{{sc}_{ref}} - 2 {N}_{{se}_{ref}} + 1 ) ) , \\ {N}_{{sc}_{ref}} - 2 {N}_{{se}_{ref}} + 1 \leq k \leq {N}_{{sc}_{ref}} - {N}_{{se}_{ref}} , ISIFreeFlat\end{matrix} \\ \begin{matrix}G ( k - ( {N}_{{sc}_{ref}} - 2 {N}_{{se}_{ref}} + 1 ) ) , \\ {N}_{{sc}_{ref}} - 2 {N}_{{se}_{ref}} + 1 \leq k \leq {N}_{{sc}_{ref}} , Flat\end{matrix} \\ G ( k - 1 - \frac{{N}_{{sc}_{ref}}}{2} ) , \frac{{N}_{{sc}_{ref}}}{2} + 1 \leq k \leq {N}_{{sc}_{ref}} , NonFlat\end{matrix}$$

$$where {N}_{{p}_{ref}} = \{ \begin{matrix}{N}_{se {,}_{ref}} & ISIFreeFlat \\ 2 {N}_{{se}_{ref}} , & Flat \\ \frac{{N}_{{sc}_{ref}}}{2} & NonFlat\end{matrix} .$$

2Nₛₑ_{_{ref}} and N_{sc}_{_{ref}} are reference number of extended subcarriers and a number of total subcarriers, respectively. Pₘ, m=1, . . . , N_{pref} can be specified in standard as a reference for specific FDSS structure and SE ratio.

The following two-step procedure can be taken (by UE or gNB) to covert N_{pref} taps to complete FDSS with N_{sc} taps: (1) resampling of reference taps: in this step N_{pref} taps are resampled to Nₚ taps; and (2) FDSS construction: Nₚ taps are utilized to construct complete N_{sc} FDSS taps.

In one design, N_{pref} parameters can be specified in standard for smallest subcarrier spacing (e.g., 15 KHz) and max number of subcarriers (e.g., N_{sc}_{_{ref}}=3300). This can help with finer FDSS values for different subcarrier numbers and spacing. For example, for SE ratio of 20%, N_{pref}=330, 660 and 1650 (based on Equation 5) for ISI-free-flat, flat and non-flat structures, respectively. Or for SE ratio of 10%, N_{pref}=165, 330 and 1650 (based on Equation 4) for ISI-free-flat, flat and non-flat structures, respectively.

In another design, reference number of subcarriers can be selected for intermediate number of subcarriers (e.g., N_{sc}_{_{ref}}=384 subcarriers). Because of intermediate number of subcarriers, the memory for storying reference FDSS values (N_{pref}) is lower than first design (N_{sc}_{_{ref}}=3300) without much degradation on performance results. For example, for SE ratio of 1/7, N_{pref}=24, 48 and 192 (based on Equation 5) for ISI-free-flat, flat and non-flat structures, respectively.

Depending on FDSS type, a reference number of taps, Pₖ for k=1, . . . , N_{pref} N_{pref} can be specified in standard (learnt based on AI). An arbitrary number of taps with size of Nₚ (Tₖ for k=1, . . . , Nₚ) can be generated from resampling reference tap values. Value of Nₚ can be obtained based on Equation 1.

For this purpose, the ratio Nₚ/N_{pref} can be simplified to a rational number L/M, i.e.,

$$\frac{{N}_{p}}{{N}_{{p}_{ref}}} = \frac{L}{M} .$$

This is accomplished by L-fold up-sampling, followed by low-pass filtering and then M-fold down sampling.

In one embodiment of L-fold up-sampling, Wₖ for k=1, . . . , N_{pref} are up-sampled parameters of reference taps (P), is calculated as follows:

$${W}_{k} = \{ \begin{matrix}{P}_{\frac{k}{L}} , if k / L is integer \\ 0 , otherwise\end{matrix} .$$

In one embodiment of low-pass filtering, output of L-fold up-sampling (W) goes through ideal low-pass filter via convolution operation (or equivalently multiplication for Fourier transform of W) as follows: Eₖ=convolution (W, 2f_{c} sinc(2f_{c}k)) where

$${f}_{c} = min ( \frac{1}{2 L} , \frac{1}{2 M} ) .$$

In one embodiment of M-fold down-sampling, in this step, a number of samples are reduced from LN_{pref} to Nₚ by discarding M−1 samples for every M samples in the original sequence, i.e., Tₖ=E_{Mk} for k=1, . . . , Nₚ.

Once Nₚ taps (Tₖ for k=1, . . . , Nₚ) are obtained, they can be mapped to subcarrier indexes k according to following equation:

$${T}_{k} , k = 1 , … , {N}_{p} = \{ \begin{matrix}G ( k - ( {N}_{sc} - 2 {N}_{se} + 1 ) ) , {N}_{sc} - 2 {N}_{se} + 1 \leq k \leq {N}_{sc} - {N}_{se} , ISIFreeFlat \\ G ( k - ( {N}_{sc} - 2 {N}_{se} + 1 ) ) , {N}_{sc} - 2 {N}_{{se}_{ref}} + 1 \leq k \leq {N}_{sc} , Flat \\ G ( k - 1 - \frac{{N}_{sc}}{2} ) , \frac{{N}_{sc}}{2} + 1 \leq k \leq {N}_{sc} , NonFlat\end{matrix} .$$

Then, Equations 2, 3, and 4 can be utilized to construct a complete FDSS as G(b), b=0, . . . , Nₚ−1 is determined.

For example, if N_{pref}=330, SE=20%, N_{sc}=240 and ISI-free flat structure is utilized, it can be shown that Nₛₑ=24 and based on Equation 1, Nₚ=24. Based on

$$\frac{{N}_{p}}{{N}_{{p}_{ref}}} = \frac{L}{M} ,$$

L=4 and M=55; first Pₘ, m=1, . . . , N_{pref}=330, is up sampled by 4 and resulting on 1320 samples: after convolution with ideal low pass filter with

$${f}_{c} = \frac{1}{110} ,$$

the resultant samples are down sampled by 55 and becomes 24 samples corresponding to target FDSS taps for taps N_{sc}−2Nₛₑ+1=193≤k≤N_{sc}-Nₛₑ=216 (according to Equation 2). By utilizing Equation 2, full FDSS can be constructed.

In one embodiment of time domain tap values of FDSS, time domain filter taps h=[h₀, . . . , h_{z-1}] (Z is number of time domain taps) can be: (1) learned directly using AI or any other techniques; or obtained by time domain representation of complete frequency domain reference FDSS taps (i.e., Fₖ_{_{ref}}, k_{ref}=1, . . . , N_{sc}_{_{ref}}), using inverse Fourier transform as follows:

$${h}_{z} = {\sum }_{{k}_{ref} = 0}^{{N}_{{sc}_{ref}} - 1} {F}_{( {k}_{ref} + 1 )} {e}^{j \frac{2 π}{{N}_{{sc}_{ref}}} {zk}_{ref}} .$$

In both above-mentioned approaches, time domain filter taps can be specified in standard.

For a total subcarrier allocation of N_{SC}, N_{sc} frequency domain filter taps F₁, . . . , F_{N}_{_{sc}}, can be calculated based on Fourier transform as follows:

$${F}_{k + 1} = {\sum }_{z = 0}^{Z - 1} {h}_{z} {e}^{- j \frac{2 π}{{N}_{SC}} kz} ,$$

0≤k≤N_{sc}−1 (Equation 6).

With this approach, a UE or a gNB can calculate complete frequency domain FDSS filter taps based on number of subcarriers directly from the Fourier transform. Examples of time domain representation of complete frequency domain reference FDSS taps (learned using AI) is given in TABLE 8.

The summary of all three methods is given in TABLE 1.

TABLE 1
A number of learned parameters for each method

| | | D^{th} order | | | |
|---|---|---|---|---|---|
| Learned | Time Domain | Polynomial | Frequency domain tap values of | | |
| Parameters | Taps values | Coefficients | FDSS | | |
| Number of learned | Z | D + 1 | ISI-Free | | |
| parameters Nₚ | | | Flat | Flat | Non-flat |
| | | | Nₛₑ | 2Nₛₑ | $\frac{{N}_{s c}}{2}$ |

| | | | |
|---|---|---|---|
| Construction | Fourier | Resampling of | Resampling of discrete FDSS Taps |
| Method of | Transform of | Polynomial | values and FDSS construction |
| Complete FDSS | Time Domain | and FDSS | Or |
| | Taps' values | construction | Utilizing Fourier transform of time |
| | | | domain representation of FDSS |

The 10^{th} order polynomial function (D=10) is utilized to learn coefficients α_{d}, d=0, . . . ,10. The example coefficients are given per example structure and PAPR gain/SNR loss compared to baseline root-raised-cosine filter (RRC) is provided in TABLE 2 under QPSK modulations when 384 subcarriers are utilized as reference. The given filter values may need to be normalized to have unit energy.

TABLE 2
PAPR Gain and SNR Loss due to SER compared to RRC
(same SE ratio is considered for RRC and designs)

| | SNR loss at | | PAPR gain at | |
|---|---|---|---|---|
| | SER = 10⁻² | | CCDF = 10⁻³ | |
| Polynomial Design for “non-flat” structure with N_{sc} = 384, Nₛₑ = 33, | 0.1 | dB | 1 | dB |
| SE = 33/160 ≅ 20% | | | | |
| Polynomial Design for “non-flat” structure with N_{sc} = 384, Nₛₑ = 24, | 0.17 | dB | 1.2 | dB |
| SE = 1/7 ≅ 14% | | | | |
| Polynomial Design for “non-flat” structure with N_{sc} = 384, Nₛₑ = 19, | 0.16 | dB | 1.2 | dB |
| SE = 19/174 ≅ 10% | | | | |
| Polynomial Design for “non-flat” structure with N_{sc} = 384, Nₛₑ = 9, | 0.21 | dB | 1.05 | dB |
| SE = 3/61 ≅ 5% | | | | |
| Polynomial Design for “flat” structure with N_{sc} = 384, Nₛₑ = 33, | 0.03 | dB | 0.7 | dB |
| SE = 33/160 ≅ 20% | | | | |
| Polynomial Design for “flat” structure with N_{sc} = 384, Nₛₑ = 24, | 0.07 | dB | 0.75 | dB |
| SE = 1/7 ≅ 14% | | | | |
| Polynomial Design for “flat” structure with N_{sc} = 384, Nₛₑ = 19, | 0.1 | dB | 0.4 | dB |
| SE = 19/174 ≅ 10% | | | | |
| Polynomial Design for “flat” structure with N_{sc} = 384, Nₛₑ = 9, | 0.04 | dB | 0.35 | dB |
| SE = 3/61 ≅ 5% | | | | |
| Polynomial Design for “ISI-free-flat” structure with N_{sc} = 384, | 0 | dB | 0.42 | |
| Nₛₑ = 33, SE = 33/160 ≅ 20% | | | | |
| Polynomial Design for “ISI-free-flat” structure with N_{sc} = 384, | 0 | dB | 0.5 | |
| Nₛₑ = 24, SE = 1/7 ≅ 14% | | | | |
| Polynomial Design for “ISI-free-flat” structure with N_{sc} = 384, | 0 | dB | 0.45 | dB |
| Nₛₑ = 19, SE = 19/174 ≅ 10%, | | | | |
| Polynomial Design for “ISI-free-flat” structure with N_{sc} = 384, | 0 | dB | 0.25 | dB |
| Nₛₑ = 9, SE = 3/61 ≅ 5% | | | | |

FIGS. 11-14 illustrate examples of polynomial design for non-flat structure 1100-1400 according to embodiments of the present disclosure. An embodiment of the polynomial design for non-flat structure 1100-1400 shown in FIGS. 11-14 are for illustration only.

In one embodiment of polynomial design for “non-flat” structure with N_{sc}=384, Nₛₑ=33,

$$SE = \frac{33}{160} ≅ 20 \% ,$$

QPSK, the polynomial coefficients are given as follows for this scenario, and the FDSS shape is illustrated in FIG. 11: α₀=−0.0529785, α₂=0.0983036, α₄=−0.463223, α₆=1.07354, α₈=1.86169, α₁₀=1.57603.

In one embodiment of polynomial design for “non-flat” structure with N_{sc}=384, Nₛₑ=24,

$$SE = \frac{1}{7} ≅ 14 \% ,$$

QPSK, the polynomial coefficients are given as follows for this scenario, and the FDSS shape is illustrated in FIG. 12, α₀=−0.00584552, α₂=0.0077575, α₄=0.0393273, α₆=−0.486898, α₈=0.804519, α₁₀=2.2363.

In one embodiment of polynomial design for “non-flat” structure with N_{sc}=384, Nₛₑ=19,

$$SE = \frac{19}{174} ≅ 10 \% ,$$

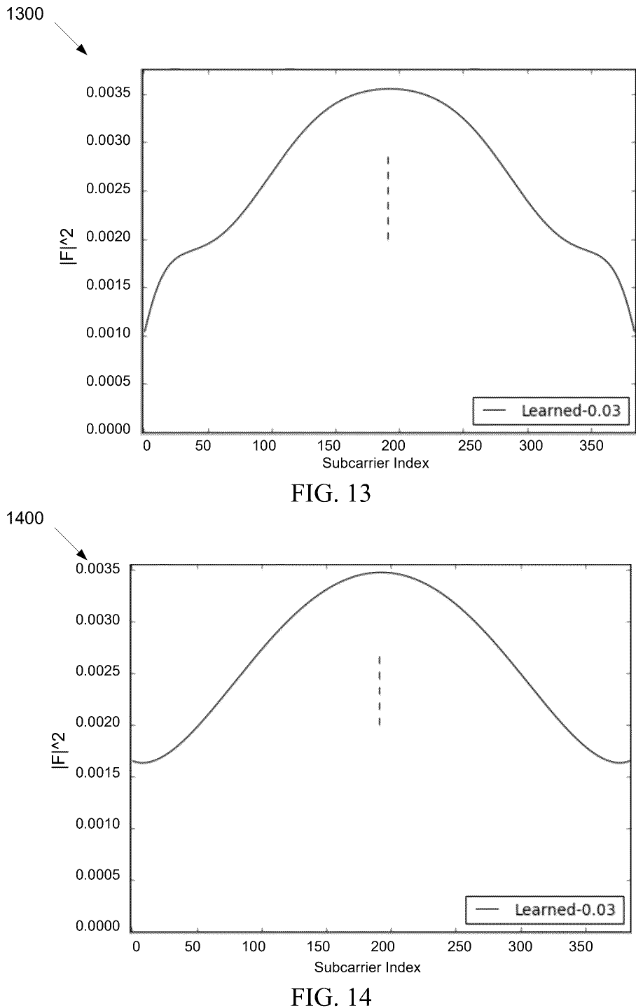

QPSK, the polynomial coefficients are given as follows for this scenario, and the FDSS shape is illustrated in FIG. 13: α₀=0.00918057, α₂=−0.00687915, α₄=−0.118361, α₆=0.944597, α₈=−0.905439, α₁₀=−4.68289.

In one embodiment of polynomial design for “non-flat” structure with N_{sc}=384, Nₛₑ=9,

$$SE = \frac{3}{61} ≅ 5 \% ,$$

QPSK, the polynomial coefficients are given as follows for this scenario, and the FDSS shape is illustrated in FIG. 14: α₀=0.160183, α₂=−0.160933, α₄=−0.0870746, α₆=0.838472, α₈=1.23434, α₁₀=0.574932.

FIGS. 15-18 illustrate examples of polynomial design for flat structure 1500-1800 according to embodiments of the present disclosure. An embodiment of the polynomial design for flat structure 1500-1800 shown in FIGS. 15-18 are for illustration only.

In one embodiment of polynomial design for “flat” structure with N_{sc}=384, Nₛₑ=33,

$$SE = \frac{33}{160} ≅ 20 \% ,$$

QPSK, the polynomial coefficients are given as follows for this scenario, and the FDSS shape is illustrated in FIG. 15: α₀=0.0649062, α₂=−0.165784, α₄=0.715932, α₆=−0.830618, α₈=−2.34837, α₁₀=−2.04461.

In one embodiment of polynomial design for “flat” structure with N_{sc}=384, Nₛₑ=24,

$$SE = \frac{1}{7} ≅ 14 \% ,$$

QPSK, the polynomial coefficients are given as follows for this scenario, and the FDSS shape is illustrated in FIG. 16: α₀=−0.145166, α₂=0.15231, α₄=−0.2765, α₆=0.168351, α₈=0.88368, α₁₀=0.979279.

In one embodiment of polynomial design for “flat” structure with N_{sc}=384, Nₛₑ=19,

$$S E = \frac{19}{174} ≅ 10 \% ,$$

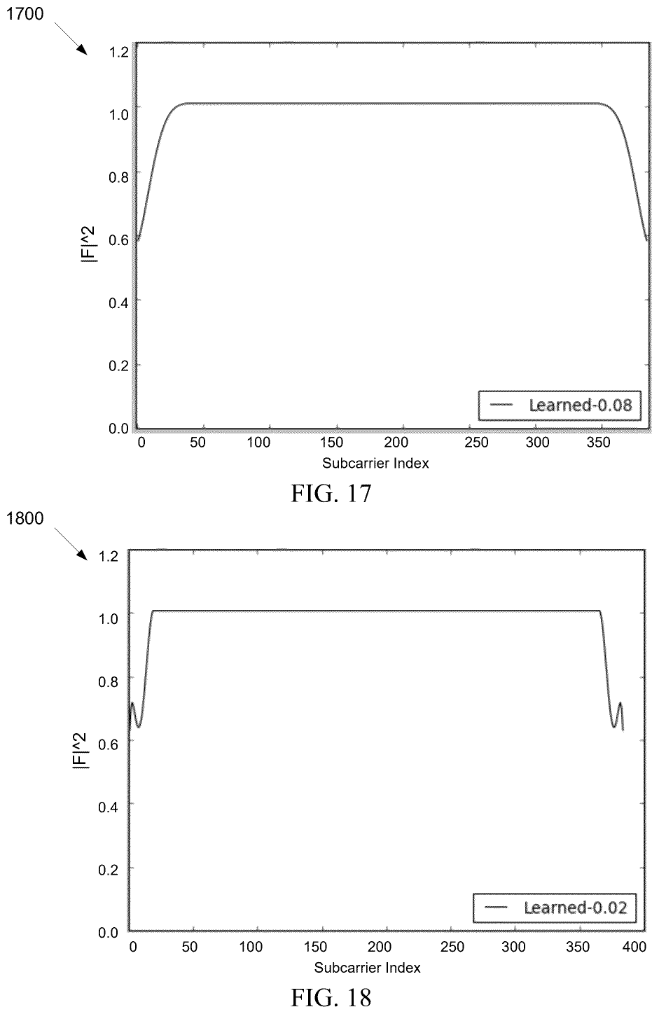

QPSK, the polynomial coefficients are given as follows for this scenario, and the FDSS shape is illustrated in FIG. 17: α₀=0.164951, α₂=−0.0205031, α₄=−0.513601, α₆=0.531625, α₈=1.56285, α₁₀=1.31094.

In one embodiment of polynomial design for “flat” structure with N_{sc}=384,

$${N}_{s e} = 9 , S E = \frac{3}{61} ≅ 5 \% ,$$

QPSK, the polynomial coefficients are given as follows for this scenario, and the FDSS shape is illustrated in FIG. 18: α₀=−0.0232315, α₂=0.0620294, α₄=−0.457765, α₆=0.809897, α₈=0.573089, α₁₀=1.33872.

FIGS. 19-25 illustrate examples of polynomial design for ISI-free flat structure 1900-2500 according to embodiments of the present disclosure. An embodiment of the polynomial design for ISI-free flat structure 1900-2500 shown in FIG. 19-25 are for illustration only.

In one embodiment of polynomial design for “ISI-free-flat” structure with N_{sc}=384, Nₛₑ=33,

$$SE = \frac{33}{160} ≅ 20 \% ,$$

QPSK, the polynomial coefficients are given as follows for this scenario, and the FDSS shape is illustrated in FIG. 19: α₀=0.354746, α₁=−1.21943, α₂=0.350104, α₃=2.5578, α₄=5.25952, α₅=6.49352, α₆=7.49824, α₇=7.55008, α₈=8.15313, α₉=8.22729.

In one embodiment of polynomial design for “ISI-free-flat” structure with N_{sc}=384, Nₛₑ=24,

$$SE = \frac{1}{7} ≅ 14 \% ,$$

QPSK, the polynomial coefficients are given as follows for this scenario, and the FDSS shape is illustrated in FIG. 20: α₀=−0.373267, α₁=1.024, α₂=−0.55165, α₃=−2.97696, α₄=−4.68577, α₅=−6.22985, α₆=−6.74941, α₇=−7.81221. α₈=−7.60142, α₉=−8.2079.

In one embodiment of polynomial design for “ISI-free-flat” structure with N_{sc}=384, Nₛₑ=19,

$$SE = \frac{19}{174} ≅ 10 \% ,$$

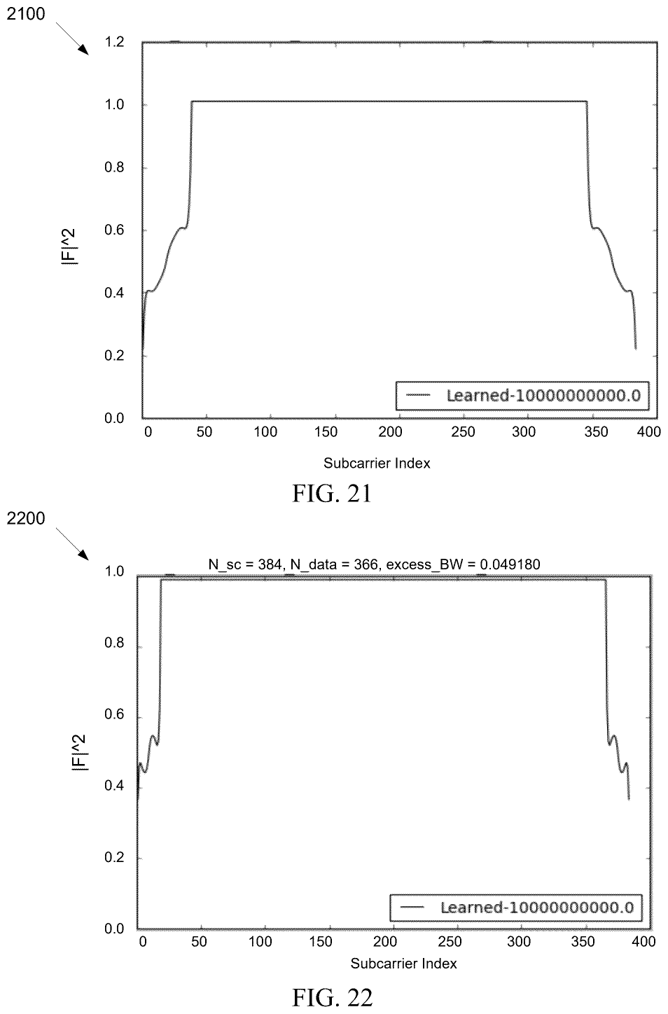

QPSK, the polynomial coefficients are given as follows for this scenario, and the FDSS shape is illustrated in FIG. 21: α₀=0.345744, α₁=−0.655265, α₂=0.539516, α₃=2.38131, α₄=4.77284, α₅=5.8637, α₆=6.75173, α₇=7.38183, α₈=7.44501, α₉=8.12848.

In one embodiment of polynomial design for “ISI-free-flat” structure with N_{sc}=384, Nₛₑₐ=9,

$$S E = \frac{3}{61} ≅ 5 \% ,$$

QPSK, the polynomial coefficients are given as follows for this scenario, and the FDSS shape is illustrated in FIG. 22: α₀=−0.337349, α₁=0.129025, α₂=−0.527591, α₃=−1.93165, α₄=−3.67291, α₅=−4.78389, α₆=−5.2212, α₇=−6.12413, α₈=−6.48221, α₉=−7.09173.

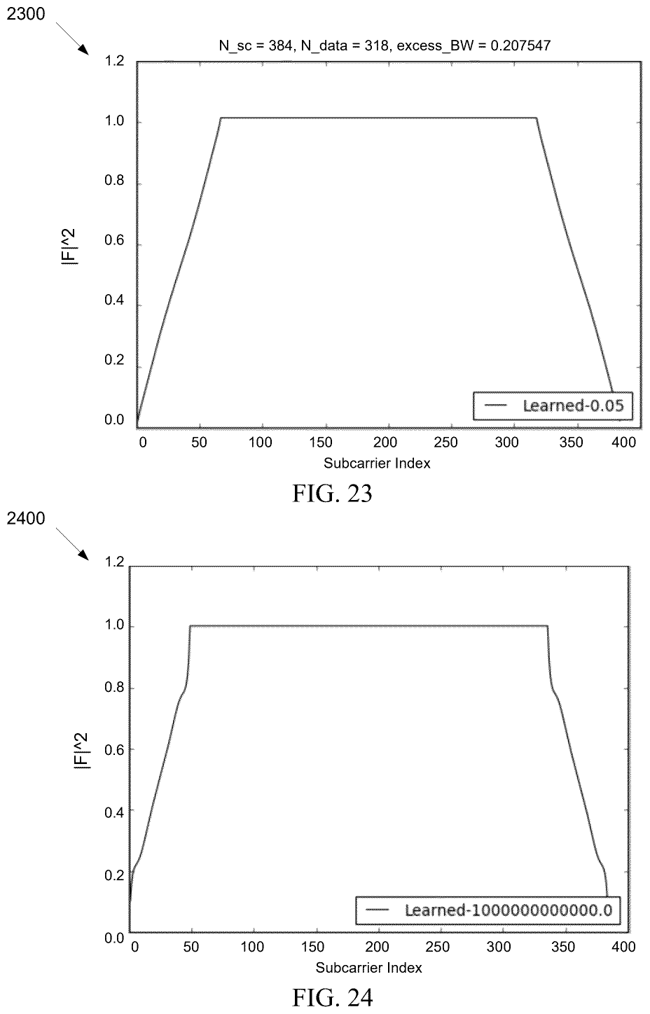

The π/2-BPSK modulation, is a constellation-rotated BPSK modulation offers a much smaller PAPR of the transmitted signal than the QPSK. The π/2-BPSK modulation increases the number of supported cell-edge users that are power-limited and could increase the overall spectral efficiency of the system. Basic pulse shaping without spectral extension has been defined in 5G(since Rel-15) for π/2-BPSK, while the exact pulse shape is not defined in the specifications. It can be shown that by using spectral extension, the pulse-shaping can achieve much better PAPR performance for π/2 BPSK. Simulation results of AI-based pulse shaping demonstrate PAPR improvement compared to RRC. For instance, for SE=14%, non-flat offers about 0.7 dB PAPR gain and less than 0.05 dB SNR loss due to SER. TABLE 3 summarizes PAPR gain and SNR loss compared to RRC for three different filter structures. Additionally, FIGS. 23 to 31 illustrate corresponding shapes of pulses.

The 10^{th} order polynomial function (D=10) is utilized to learn example FDSS coefficients α_{d}, d=0, . . . ,10. The given filter values may need to be normalized to have unit energy.

TABLE 3
PAPR gain and SNR Loss due to SER compared to RRC as FDSS (same
SE for fairness is considered for RRC and designs) for π/2-BPSK

| | SNR loss at | | PAPR gain at | |
|---|---|---|---|---|
| | SER = 10⁻² | | CCDF = 10⁻³ | |
| Polynomial Design for “non-flat” structure with N_{sc} = 384, | 0.1 | dB | 0.65 | dB |
| Nₛₑ = 33, SE = 33/160 ≅ 20% | | | | |
| Polynomial Design for “non-flat” structure with N_{sc} = 384, | 0.05 | dB | 0.7 | dB |
| Nₛₑ = 24, SE = 1/7 ≅ 14% | | | | |
| Polynomial Design for “non-flat” structure with N_{sc} = 384, | 0.23 | dB | 1.15 | dB |
| Nₛₑ = 19, SE = 19/174 ≅ 10% | | | | |
| Polynomial Design for “flat” structure with N_{sc} = 384, Nₛₑ = 33, | 0 | dB | 0.3 | dB |
| SE = 33/160 ≅ 20% | | | | |
| Polynomial Design for “flat” structure with N_{sc} = 384, Nₛₑ = 24, | 0 | dB | 0.43 | dB |
| SE = 1/7 ≅ 14% | | | | |
| Polynomial Design for “flat” structure with N_{sc} = 384, Nₛₑ = 19, | 0 | dB | 0.5 | dB |
| SE = 19/174 ≅ 10% | | | | |
| Polynomial Design for “ISI-free-flat” structure with N_{sc} = 384, | 0 | dB | 0.25 | dB |
| Nₛₑ = 33, SE = 33/160 ≅ 20% | | | | |
| Polynomial Design for “ISI-free-flat” structure with N_{sc} = 384, | 0 | dB | 0.3 | dB |
| Nₛₑ = 24, SE = 1/7 ≅ 14% | | | | |
| Polynomial Design for “ISI-free-flat” structure with N_{sc} = 384, | 0 | dB | 0.35 | dB |
| Nₛₑ = 19, SE = 19/174 ≅ 10%, | | | | |

In one embodiment of polynomial design for “ISI-free-flat” structure with N_{sc}=384, Nₛₑ=33,

$$SE = \frac{33}{160} ≅ 20 \% ,$$

π/2-BPSK, the polynomial coefficients are given as follows for this scenario, and the FDSS shape is illustrated in FIG. 23: α₀=−0.00409211, α₁=0.0164978, α₂=0.118567, α₃=−0.338082, α₄=−0.695622, α₅=0.121879, α₆=1.63479, α₇=4.1589, α₈=5.84059, α₉=7.14029.

In one embodiment of polynomial design for “ISI-free-flat” structure with N_{sc}=384, Nₛₑ=24,

$$SE = \frac{1}{7} ≅ 14 \% ,$$

π/2-BPSK, the polynomial coefficients are given as follows for this scenario, and the FDSS shape is illustrated in FIG. 24: α₀=0.138997, α₁=−0.490228, α₂=0.0286486, α₃=0.971856, α₄=3.08936, α₅=5.3024, α₆=6.46434, α₇=7.22015, α₈=7.32841, α₉=7.68999.

In one embodiment of polynomial design for “ISI-free-flat” structure with N_{sc}=384, Nₛₑ=19,

$$SE = \frac{19}{174} ≅ 10 \% ,$$

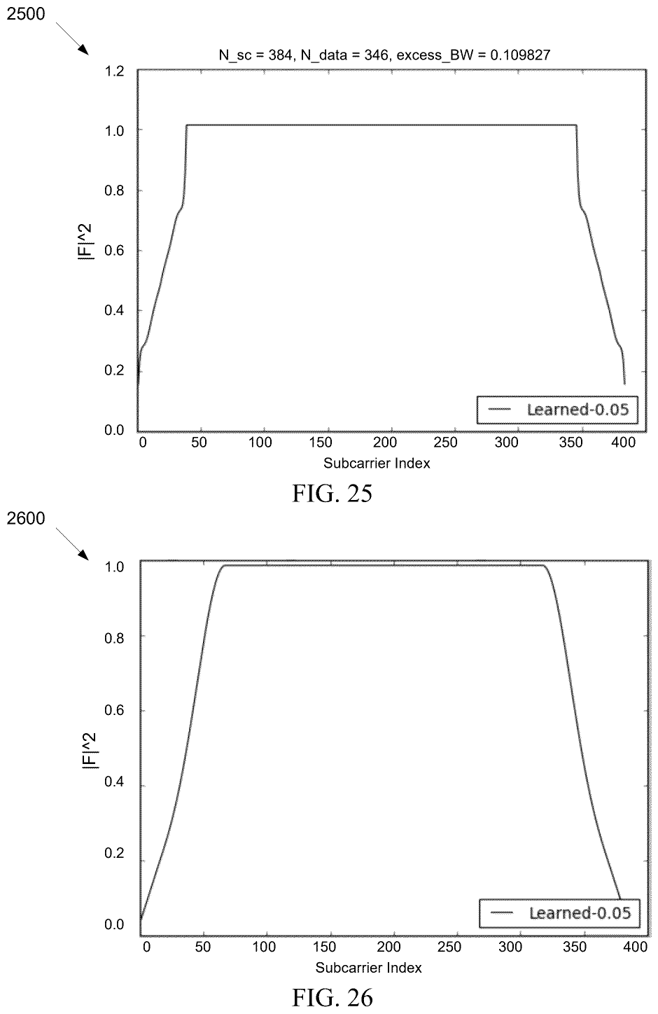

π/2-BPSK, the polynomial coefficients are given as follows for this scenario, and the FDSS shape is illustrated in FIG. 25: α₀=0.296817, α₀=−1.02818, α₀=0.479901, α₀=2.11964, α₀=3.90394, α₀=5.3266, α₀=6.29524, α₀=6.53246, α₀=7.45458, α₀=7.3522.

FIGS. 26-28 illustrate examples of polynomial design for flat structure 2600-2800 according to embodiments of the present disclosure. An embodiment of the polynomial design for flat structure 2600-2800 shown in FIGS. 26-28 is for illustration only.

In one embodiment of polynomial design for “flat” structure with N_{sc}=384, Nₛₑ=33,

$$S E = \frac{33}{160} ≅ 20 \% ,$$

π/2-BPSK, the polynomial coefficients are given as follows for this scenario, and the FDSS shape is illustrated in FIG. 26: α₀=−0.0372303, α₂=0.13728, α₄=−0.516097, α₆=0.776478, α₈=1.33191, α₁₀=1.39945.

In one embodiment of polynomial design for “flat” structure with N_{sc}=384, Nₛₑ=24,

$$SE = \frac{1}{7} ≅ 14 \% ,$$

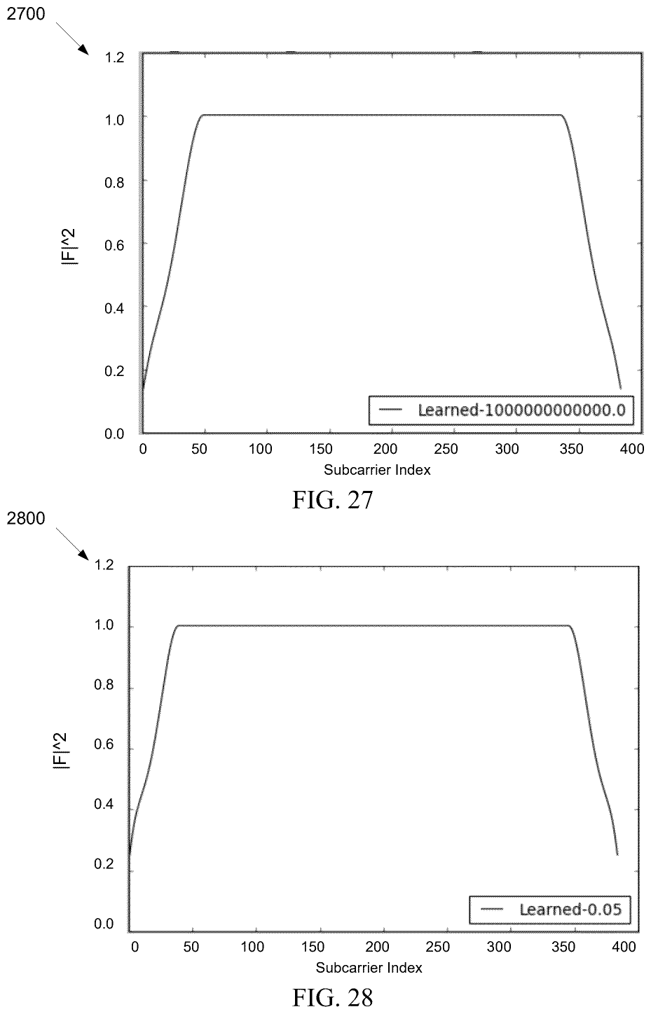

π/2-BPSK, the polynomial coefficients are given as follows for this scenario, and the FDSS shape is illustrated in FIG. 27: α₀=−0.0383037, α₂=0.104352, α₄=−0.400534, α₆=0.555483, α₈=1.17259, α₁₀=1.1632.

In one embodiment of polynomial design for “flat” structure with N_{sc}=384, Nₛₑ=19,

$$S E = \frac{19}{174} ≅ 10 \% ,$$

π/2-BPSK, the polynomial coefficients are given as follows for this scenario, and the FDSS shape is illustrated in FIG. 28: α₀=0.0249272, α₂=−0.0626382, α₄=0.288912, α₆=−0.402606, α₈=−0.834465, α₁₀=−0.504439.

FIGS. 29-31 illustrate examples of polynomial design for non-flat structure 2900-3100 according to embodiments of the present disclosure. An embodiment of the polynomial design for non-flat structure 2900-3100 shown in FIGS. 29-31 are for illustration only.

In one embodiment of polynomial design for “non-flat” structure with N_{sc}=384, Nₛₑ=33,

$$SE = \frac{33}{160} ≅ 20 \% ,$$

π/2-BPSK, the polynomial coefficients are given as follows for this scenario, and the FDSS shape is illustrated in FIG. 29: α₀=−0.0501793, α₂=0.0205293, α₄=0.172039, α₆=0.399671, α₈=1.31189, α₁₀=2.34951.

In one embodiment of polynomial design for “non-flat” structure with N_{sc}=384, Nₛₑ=24,

$$S E = \frac{1}{7} ≅ 14 \% ,$$

π/2-BPSK, the polynomial coefficients are given as follows for this scenario, and the FDSS shape is illustrated in FIG. 30: α₀=−0.0543595, α₂=0.0137555, α₄=−0.0088079, α₆=0.58645, α₈=1.773, α₁₀=3.86848.

In one embodiment of polynomial design for “non-flat” structure with N_{sc}=384, Nₛₑ=19,

$$S E = \frac{19}{174} ≅ 10 \% ,$$

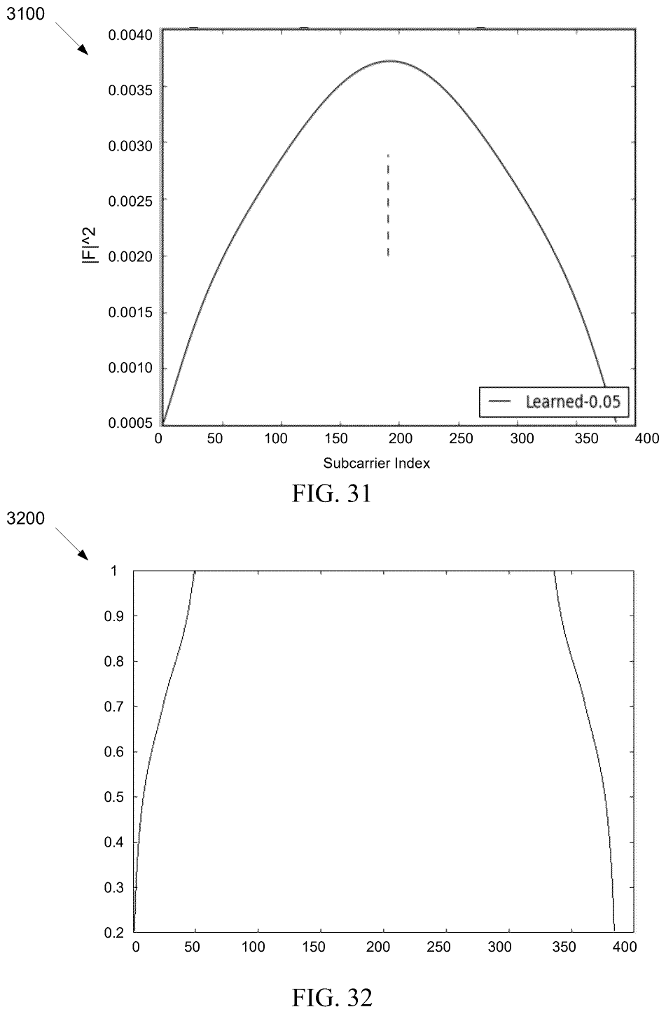

π/2-BPSK, the polynomial coefficients are given as follows for this scenario, and the FDSS shape is illustrated in FIG. 31: α₀=−0.0665738, α₂=0.0813722, α₄=−0.147726, α₆=0.207828, α₈=2.03229, α₁₀=3.80312.

Multiple examples of complete reference FDSS frequency domain tap values for N_{sc}_{_{ref}}=384 and Nₛₑ_{_{ref}}=24 subcarriers, corresponding to SE=14.2% are given in TABLE 4 under QPSK modulation. Filter taps for different filter structures, including “ISI-free-flat,” two “flat” structures (Flat1 and Flat2) as well as “non-flat” structure (AlmostFlat 1, AlmostFlat 2) that has none-zeros weight for flatness constraint in loss function are represented. The Filter shapes are illustrated in FIGS. 32 to 36 and their tap values are shown in TABLE 5.

As it can be seen, FDSS-DFT-S-OFDM, achieves about 0.5 dB, 0.7 dB and 1.1 dB PAPR gains respectively compared with RRC based FDSS-DFT-s-OFDM at 10⁻³ CCDF level at 10⁻² SER.

TABLE 4
PAPR gain and SNR loss compared to RRC under QPSK

| | SNR loss at | PAPR gain at |
|---|---|---|
| | SER = 10⁻² | CCDF = 10⁻³ |
| AlmostFlat 1 | 0.10 dB | 1.15 dB |
| AlmostFlat 2 | 0.05 dB | 0.8 dB |
| Flat 1 | 0.10 dB | 0.75 dB |
| Flat 2 | 0.05 dB | 0.65 dB |
| ISI-free-flat | 0 dB | 0.5 dB |

FIG. 32 illustrates an example of ISI-free flat 3200 according to embodiments of the present disclosure. An embodiment of the ISI-free flat 3200 shown in FIG. 32 is for illustration only.

FIG. 33 illustrates an example of flat 2 design 3300 according to embodiments of the present disclosure. An embodiment of the flat 2 design 3300 shown in FIG. 33 is for illustration only.

FIG. 34 illustrates an example of flat 1 design 3400 according to embodiments of the present disclosure. An embodiment of the flat 1 design 3400 shown in FIG. 34 is for illustration only.

FIG. 35 illustrates an example of almost flat 2 design 3500 according to embodiments of the present disclosure. An embodiment of the almost flat 2 design 3500 shown in FIG. 35 is for illustration only.

FIG. 36 illustrates an example of almost flat 1 design 3600 according to embodiments of the present disclosure. An embodiment of the almost flat 1 design 3600 shown in FIG. 36 is for illustration only.

TABLE 5 shows complete FDSS taps for N_{sc}=384 and Nₛₑ=24 subcarriers, tap values for subcarrier index (SCI) of 1 to 192 is shown, the rest of subcarriers 193 to 384 has same values as first half of filter.

TABLE 5
FDSS taps

| SCI | Almost Flat 1 | Almost Flat 2 | Flat 1 | Flat 2 | ISI-Free-Flat |
|---|---|---|---|---|---|
| 1 | 0.728270688933295 | 0.756972092634894 | 0.809201176035659 | 0.783204314634011 | 0.451473710198470 |
| 2 | 0.738250063737033 | 0.761532403260170 | 0.817443527515124 | 0.795842183610648 | 0.530966397497602 |
| 3 | 0.747718259095448 | 0.766187399470892 | 0.825229415485623 | 0.806708263515297 | 0.581062031664297 |
| 4 | 0.756699142882349 | 0.770923312384018 | 0.832619417192642 | 0.815948269430366 | 0.617447774679814 |
| 5 | 0.765215683446600 | 0.775727083383805 | 0.839666033534185 | 0.823720509985401 | 0.645692575707321 |
| 6 | 0.773289981027748 | 0.780586402133001 | 0.846414498089381 | 0.830190821122144 | 0.668513762165457 |
| 7 | 0.780943305756791 | 0.785489623280657 | 0.852903572677877 | 0.835528138700957 | 0.687474595345490 |
| 8 | 0.788196097544929 | 0.790425753396358 | 0.859166260770367 | 0.839900801652063 | 0.703571024969519 |
| 9 | 0.795068021553321 | 0.795384470863129 | 0.865230402896013 | 0.843473445996571 | 0.717482951136083 |
| 10 | 0.801577953815214 | 0.800356016999559 | 0.871119280247386 | 0.846404440300948 | 0.729697981422827 |
| 11 | 0.807744079500184 | 0.805331260722603 | 0.876852147885356 | 0.848843785851002 | 0.740579055409534 |
| 12 | 0.813583790176837 | 0.810301612268903 | 0.882444675039354 | 0.850931553697473 | 0.750404146840697 |
| 13 | 0.819113850577974 | 0.815259051695489 | 0.887909419308646 | 0.852796570228118 | 0.759391291426596 |
| 14 | 0.824350311565815 | 0.820196043599699 | 0.893256166674689 | 0.854555590090664 | 0.767714998235070 |
| 15 | 0.829308581571851 | 0.825105598962900 | 0.898492272726056 | 0.856312607796949 | 0.775517659989909 |
| 16 | 0.834003445905059 | 0.829981168400249 | 0.903623049122833 | 0.858158635131464 | 0.782917517521341 |
| 17 | 0.838449058148347 | 0.834816681837483 | 0.908651954432288 | 0.860171532714461 | 0.790014622349655 |
| 18 | 0.842659011501175 | 0.839606520998524 | 0.913580889504557 | 0.862416139129922 | 0.796895160334506 |
| 19 | 0.846646286590652 | 0.844345471005742 | 0.918410407876575 | 0.864944505810032 | 0.803634676388220 |
| 20 | 0.850423343821681 | 0.849028738493292 | 0.923139927445409 | 0.867796376713614 | 0.810300518950308 |
| 21 | 0.854002104163495 | 0.853651926170435 | 0.927767913128920 | 0.870999673019012 | 0.816953492788126 |
| 22 | 0.857393958104488 | 0.858210976261283 | 0.932292011560646 | 0.874571116617991 | 0.823649059476292 |
| 23 | 0.860609812624174 | 0.862702211712922 | 0.936709190524974 | 0.878516965147693 | 0.830437973712348 |
| 24 | 0.863660061360806 | 0.867122291628706 | 0.941015903435756 | 0.882833771790821 | 0.837366541177561 |
| 25 | 0.866554676718473 | 0.871468199948749 | 0.945208157625286 | 0.887509196924736 | 0.844382383841714 |
| 26 | 0.869303153216121 | 0.875737224269968 | 0.949281639921914 | 0.892522851364349 | 0.850978568773107 |
| 27 | 0.871914542157003 | 0.879926956459260 | 0.953231778264035 | 0.897847159094646 | 0.857143388503251 |
| 28 | 0.874397504030405 | 0.884035241636329 | 0.957053840771955 | 0.903448225991865 | 0.862952927202757 |
| 29 | 0.876760266122404 | 0.888060232291415 | 0.960742992220089 | 0.909286721452415 | 0.868475873876350 |
| 30 | 0.879010691277542 | 0.892000317739309 | 0.964294338842055 | 0.915318728249397 | 0.873774768138111 |
| 31 | 0.881156242312744 | 0.895854107039400 | 0.967703011032447 | 0.921496590353994 | 0.878907096812316 |
| 32 | 0.883204036903908 | 0.899620473896499 | 0.970964175457929 | 0.927769727652441 | 0.883926476123547 |
| 33 | 0.885160829549595 | 0.903298488941807 | 0.974073105316756 | 0.934085430151814 | 0.888883601599205 |
| 34 | 0.887033043174287 | 0.906887434994333 | 0.977025190776894 | 0.940389635747433 | 0.893827313689434 |
| 35 | 0.888826789219149 | 0.910386791990401 | 0.979815988078511 | 0.946627638185967 | 0.898805495945913 |
| 36 | 0.890547846325247 | 0.913796222556308 | 0.982441209847768 | 0.952744785310759 | 0.903865886782790 |
| 37 | 0.892201698725096 | 0.917115548168638 | 0.984896793004617 | 0.958687148459948 | 0.909056879580282 |
| 38 | 0.893793543378075 | 0.920344785945906 | 0.987178908150598 | 0.964402078839703 | 0.914427979286648 |
| 39 | 0.895328316405454 | 0.923484075546903 | 0.989283940421043 | 0.969838833683435 | 0.920030264951776 |
| 40 | 0.896810648714020 | 0.926533726723148 | 0.991208557369800 | 0.974949072805468 | 0.925916428159896 |
| 41 | 0.898244941288543 | 0.929494167350996 | 0.992949680829333 | 0.979687323534956 | 0.932140558875117 |
| 42 | 0.899635349621877 | 0.932365961606821 | 0.994504517066533 | 0.984011422727130 | 0.938757482711019 |
| 43 | 0.900985777845663 | 0.935149798526515 | 0.995870549113502 | 0.987882954386581 | 0.945821652602725 |
| 44 | 0.902299922224072 | 0.937846471160275 | 0.997045587098613 | 0.991267493067015 | 0.953385374215598 |
| 45 | 0.903581224670091 | 0.940456866007334 | 0.998027714208379 | 0.994135034486851 | 0.961496425950338 |
| 46 | 0.904832965070704 | 0.942981991707381 | 0.998815348038574 | 0.996460137293091 | 0.970194719647383 |
| 47 | 0.906058184420101 | 0.945422929706522 | 0.999407188316102 | 0.998222202612968 | 0.979508214221633 |
| 48 | 0.907259746691626 | 0.947780834253775 | 0.999802289334639 | 0.999405651769899 | 0.989447622505010 |
| 49 | 0.908440330958112 | 0.950056961476423 | 1 | 1 | 1 |
| 50 | 0.909602443127732 | 0.952252620991077 | 1 | 1 | 1 |
| 51 | 0.910748417611459 | 0.954369176378640 | 1 | 1 | 1 |
| 52 | 0.911880418861062 | 0.956408074504719 | 1 | 1 | 1 |
| 53 | 0.913000482066215 | 0.958370797876475 | 1 | 1 | 1 |
| 54 | 0.914110455408980 | 0.960258875013833 | 1 | 1 | 1 |
| 55 | 0.915212079785708 | 0.962073890722228 | 1 | 1 | 1 |
| 56 | 0.916306960285663 | 0.963817439119762 | 1 | 1 | 1 |
| 57 | 0.917396547597961 | 0.965491181806200 | 1 | 1 | 1 |
| 58 | 0.918482207343135 | 0.967096782004222 | 1 | 1 | 1 |
| 59 | 0.919565152411660 | 0.968635934168817 | 1 | 1 | 1 |
| 60 | 0.920646512063654 | 0.970110355438688 | 1 | 1 | 1 |
| 61 | 0.921727293547312 | 0.971521767712561 | 1 | 1 | 1 |
| 62 | 0.922808421680395 | 0.972871927058783 | 1 | 1 | 1 |
| 63 | 0.923890719929629 | 0.974162586883811 | 1 | 1 | 1 |
| 64 | 0.924974901305930 | 0.975395489622006 | 1 | 1 | 1 |
| 65 | 0.926061627075003 | 0.976572405464927 | 1 | 1 | 1 |
| 66 | 0.927151458704111 | 0.977695076864621 | 1 | 1 | 1 |
| 67 | 0.928244887399414 | 0.978765275971391 | 1 | 1 | 1 |
| 68 | 0.929342324855172 | 0.979784749197508 | 1 | 1 | 1 |
| 69 | 0.930444122971935 | 0.980755218276680 | 1 | 1 | 1 |
| 70 | 0.931550574193053 | 0.981678437389488 | 1 | 1 | 1 |
| 71 | 0.932661892620016 | 0.982556091062727 | 1 | 1 | 1 |
| 72 | 0.933778243264037 | 0.983389898004120 | 1 | 1 | 1 |
| 73 | 0.934899761504945 | 0.984181537090637 | 1 | 1 | 1 |
| 74 | 0.936026495802334 | 0.984932657593365 | 1 | 1 | 1 |
| 75 | 0.937158465601796 | 0.985644917252880 | 1 | 1 | 1 |
| 76 | 0.938295651954835 | 0.986319917745866 | 1 | 1 | 1 |
| 77 | 0.939437988209645 | 0.986959261327744 | 1 | 1 | 1 |
| 78 | 0.940585369833084 | 0.987564504932191 | 1 | 1 | 1 |
| 79 | 0.941737664164353 | 0.988137207330734 | 1 | 1 | 1 |
| 80 | 0.942894691579908 | 0.988678864639799 | 1 | 1 | 1 |
| 81 | 0.944056254273930 | 0.989190957396991 | 1 | 1 | 1 |
| 82 | 0.945222126896090 | 0.989674960335368 | 1 | 1 | 1 |
| 83 | 0.946392056731085 | 0.990132268636756 | 1 | 1 | 1 |
| 84 | 0.947565754418353 | 0.990564281941061 | 1 | 1 | 1 |
| 85 | 0.948742941429946 | 0.990972367638999 | 1 | 1 | 1 |
| 86 | 0.949923293396647 | 0.991357833494782 | 1 | 1 | 1 |
| 87 | 0.951106468676520 | 0.991721974371208 | 1 | 1 | 1 |
| 88 | 0.952292117885463 | 0.992066054029977 | 1 | 1 | 1 |
| 89 | 0.953479883954941 | 0.992391277694131 | 1 | 1 | 1 |
| 90 | 0.954669392798909 | 0.992698838635661 | 1 | 1 | 1 |
| 91 | 0.955860253427070 | 0.992989881425774 | 1 | 1 | 1 |
| 92 | 0.957052067422190 | 0.993265529941414 | 1 | 1 | 1 |
| 93 | 0.958244438345352 | 0.993526850607375 | 1 | 1 | 1 |
| 94 | 0.959436943698693 | 0.993774898835243 | 1 | 1 | 1 |
| 95 | 0.960629181744122 | 0.994010663758238 | 1 | 1 | 1 |
| 96 | 0.961820734096206 | 0.994235133090671 | 1 | 1 | 1 |
| 97 | 0.963011175131144 | 0.994449219377691 | 1 | 1 | 1 |
| 98 | 0.964200072027509 | 0.994653843265476 | 1 | 1 | 1 |
| 99 | 0.965387012660009 | 0.994849850515101 | 1 | 1 | 1 |
| 100 | 0.966571568369831 | 0.995038076753850 | 1 | 1 | 1 |
| 101 | 0.967753312581216 | 0.995219301421657 | 1 | 1 | 1 |
| 102 | 0.968931820777284 | 0.995394303231504 | 1 | 1 | 1 |
| 103 | 0.970106688954161 | 0.995563777212172 | 1 | 1 | 1 |
| 104 | 0.971277487338238 | 0.995728436262538 | 1 | 1 | 1 |
| 105 | 0.972443806613441 | 0.995888909750225 | 1 | 1 | 1 |
| 106 | 0.973605230160071 | 0.996045835797643 | 1 | 1 | 1 |
| 107 | 0.974761370861736 | 0.996199796777845 | 1 | 1 | 1 |
| 108 | 0.975911824984761 | 0.996351337809639 | 1 | 1 | 1 |
| 109 | 0.977056199776474 | 0.996500976015807 | 1 | 1 | 1 |
| 110 | 0.978194113377034 | 0.996649218982178 | 1 | 1 | 1 |
| 111 | 0.979325185578393 | 0.996796518713774 | 1 | 1 | 1 |
| 112 | 0.980449037788919 | 0.996943299313154 | 1 | 1 | 1 |
| 113 | 0.981565320393210 | 0.997089966213367 | 1 | 1 | 1 |
| 114 | 0.982673676073020 | 0.997236869361743 | 1 | 1 | 1 |
| 115 | 0.983773748934385 | 0.997384367705771 | 1 | 1 | 1 |
| 116 | 0.984865211774769 | 0.997532764749352 | 1 | 1 | 1 |
| 117 | 0.985947720437577 | 0.997682345406423 | 1 | 1 | 1 |
| 118 | 0.987020968364858 | 0.997833376011838 | 1 | 1 | 1 |
| 119 | 0.988084631932197 | 0.997986067528173 | 1 | 1 | 1 |
| 120 | 0.989138406759090 | 0.998140630781281 | 1 | 1 | 1 |
| 121 | 0.990182016628299 | 0.998297258060593 | 1 | 1 | 1 |
| 122 | 0.991215150006017 | 0.998456104736541 | 1 | 1 | 1 |
| 123 | 0.992237550533711 | 0.998617289286210 | 1 | 1 | 1 |
| 124 | 0.993248935491949 | 0.998780930094328 | 1 | 1 | 1 |
| 125 | 0.994249068029618 | 0.998947117874337 | 1 | 1 | 1 |
| 126 | 0.995237675844803 | 0.999115915688797 | 1 | 1 | 1 |
| 127 | 0.996214541309493 | 0.999287368159686 | 1 | 1 | 1 |
| 128 | 0.997179420271456 | 0.999461501482795 | 1 | 1 | 1 |
| 129 | 0.998132096038021 | 0.999638332628538 | 1 | 1 | 1 |
| 130 | 0.999072352301117 | 0.999817841797379 | 1 | 1 | 1 |
| 131 | 1 | 1 | 1 | 1 | 1 |
| 132 | 1.00091482343643 | 1.00018476906632 | 1 | 1 | 1 |
| 133 | 1.00181666089790 | 1.00037208329694 | 1 | 1 | 1 |
| 134 | 1.00270531499510 | 1.00056185866744 | 1 | 1 | 1 |
| 135 | 1.00358062425047 | 1.00075401119858 | 1 | 1 | 1 |
| 136 | 1.00444243614580 | 1.00094842943722 | 1 | 1 | 1 |
| 137 | 1.00529058922971 | 1.00114500200091 | 1 | 1 | 1 |
| 138 | 1.00612493986165 | 1.00134359007008 | 1 | 1 | 1 |
| 139 | 1.00694536211728 | 1.00154406409076 | 1 | 1 | 1 |
| 140 | 1.00775171211873 | 1.00174624876966 | 1 | 1 | 1 |
| 141 | 1.00854387252656 | 1.00194998727462 | 1 | 1 | 1 |
| 142 | 1.00932173465551 | 1.00215511373064 | 1 | 1 | 1 |
| 143 | 1.01008518955096 | 1.00236143491002 | 1 | 1 | 1 |
| 144 | 1.01083413684218 | 1.00256876689819 | 1 | 1 | 1 |
| 145 | 1.01156847583436 | 1.00277689845841 | 1 | 1 | 1 |
| 146 | 1.01228813206013 | 1.00298563683702 | 1 | 1 | 1 |
| 147 | 1.01299301292988 | 1.00319475282691 | 1 | 1 | 1 |
| 148 | 1.01368304315362 | 1.00340403571385 | 1 | 1 | 1 |
| 149 | 1.01435816466987 | 1.00361326580984 | 1 | 1 | 1 |
| 150 | 1.01501830125417 | 1.00382220531518 | 1 | 1 | 1 |
| 151 | 1.01566340269572 | 1.00403062577346 | 1 | 1 | 1 |
| 152 | 1.01629340060532 | 1.00423829891732 | 1 | 1 | 1 |
| 153 | 1.01690827016579 | 1.00444496924157 | 1 | 1 | 1 |
| 154 | 1.01750794189838 | 1.00465040886830 | 1 | 1 | 1 |
| 155 | 1.01809239863614 | 1.00485438096396 | 1 | 1 | 1 |
| 156 | 1.01866158737220 | 1.00505663060909 | 1 | 1 | 1 |
| 157 | 1.01921548091774 | 1.00525691221568 | 1 | 1 | 1 |
| 158 | 1.01975405145558 | 1.00545498951334 | 1 | 1 | 1 |
| 159 | 1.02027727932332 | 1.00565062640428 | 1 | 1 | 1 |
| 160 | 1.02078514420766 | 1.00584356869967 | 1 | 1 | 1 |
| 161 | 1.02127761636602 | 1.00603358063994 | 1 | 1 | 1 |
| 162 | 1.02175469173701 | 1.00622042661932 | 1 | 1 | 1 |
| 163 | 1.02221635680231 | 1.00640387117855 | 1 | 1 | 1 |
| 164 | 1.02266259737180 | 1.00658366987476 | 1 | 1 | 1 |
| 165 | 1.02309340734427 | 1.00675961488468 | 1 | 1 | 1 |
| 166 | 1.02350877993108 | 1.00693147113011 | 1 | 1 | 1 |
| 167 | 1.02390871641100 | 1.00709901276301 | 1 | 1 | 1 |
| 168 | 1.02429321736288 | 1.00726202314823 | 1 | 1 | 1 |
| 169 | 1.02466226517117 | 1.00742030396105 | 1 | 1 | 1 |
| 170 | 1.02501587652716 | 1.00757364782327 | 1 | 1 | 1 |
| 171 | 1.02535405865936 | 1.00772183830030 | 1 | 1 | 1 |
| 172 | 1.02567680061156 | 1.00786470456160 | 1 | 1 | 1 |
| 173 | 1.02598410821801 | 1.00800203935294 | 1 | 1 | 1 |
| 174 | 1.02627599534367 | 1.00813368098569 | 1 | 1 | 1 |
| 175 | 1.02655246641051 | 1.00825944043953 | 1 | 1 | 1 |
| 176 | 1.02681352514126 | 1.00837916511198 | 1 | 1 | 1 |
| 177 | 1.02705918328849 | 1.00849269326145 | 1 | 1 | 1 |
| 178 | 1.02728943444930 | 1.00859986310691 | 1 | 1 | 1 |
| 179 | 1.02750429770503 | 1.00870055833374 | 1 | 1 | 1 |
| 180 | 1.02770378270718 | 1.00879462614127 | 1 | 1 | 1 |
| 181 | 1.02788788096818 | 1.00888194096181 | 1 | 1 | 1 |
| 182 | 1.02805661819234 | 1.00896239533883 | 1 | 1 | 1 |
| 183 | 1.02820998450665 | 1.00903588171159 | 1 | 1 | 1 |
| 184 | 1.02834799550492 | 1.00910230150734 | 1 | 1 | 1 |
| 185 | 1.02847066608437 | 1.00916156513126 | 1 | 1 | 1 |
| 186 | 1.02857798430421 | 1.00921360105565 | 1 | 1 | 1 |
| 187 | 1.02866995496947 | 1.00925831941705 | 1 | 1 | 1 |
| 188 | 1.02874659962290 | 1.00929568479688 | 1 | 1 | 1 |
| 189 | 1.02880790426431 | 1.00932563432902 | 1 | 1 | 1 |
| 190 | 1.02885388034818 | 1.00934813228427 | 1 | 1 | 1 |
| 191 | 1.02888453864148 | 1.00936315186930 | 1 | 1 | 1 |
| 192 | 1.02889986308958 | 1.00937066612658 | 1 | 1 | 1 |

FIGS. 37 and 38 illustrate examples of filter design for non-flat structure 3700 and 3800 according to embodiments of the present disclosure. An embodiment of the filter design for non-flat structure 3700 and 3800 shown in FIGS. 37 and 38 are for illustration only.

Multiple complete reference FDSS frequency domain tap values for N_{sc}_{_{ref}}=384 and Nₛₑ_{_{ref}}=64, 96 subcarriers, corresponding to SE=50%, 100%, are given in TABLE 7 under π/2-BPSK modulation. Example filters are based on “non-flat” structure. The Filter shapes are illustrated in FIGS. 37 and 38. The PAPR gain and SNR loss due to SER compared to RRC is shown in TABLE 6. As it can be seen, the provided filters are outperforming RRC in terms of PAPER.

TABLE 6
PAPR gain and SNR loss compared to RRC under π/2-BPSK

| | SNR loss at | PAPR gain at |
|---|---|---|
| | SER = 10⁻² | CCDF = 10⁻³ |
| ″Non-flat″ structure with N_{sc}_{_{ref}} = 384, | 0.1 dB | 1.1 dB |
| Nₛₑ_{_{ref}} = 64, SE = 50% | | |
| ″Non-flat″ structure with N_{sc}_{_{ref}} = 384, | 0.12 dB | 1.5 dB |
| Nₛₑ_{_{ref}} = 96, SE = 100% | | |

TABLE 7
FDSS taps for N_sc = 384 and SE = 50, 100% subcarriers under
π/2-BPSK; tap values for subcarrier index of 1 to 192 are shown, the
rest of subcarriers 193 to 384 has same values as first half of filter

| | “Non-flat” structure | “Non-flat” structure with |
|---|---|---|
| | with N_{sc}_{_{ref}} = 384, | N_{sc}_{_{ref}} = 384, Nₛₑ_{_{ref}} = 96, |
| subcarrier index | Nₛₑ_{_{ref}} = 64, SE = 50% | SE = 100% |
| 1 | 0.001991854 | 0.002483272 |
| 2 | 0.002128916 | 0.001752227 |
| 3 | 0.00227669 | 0.001178456 |
| 4 | 0.002435619 | 0.000741561 |
| 5 | 0.00260614 | 0.000422732 |
| 6 | 0.002788684 | 0.000204689 |
| 7 | 0.002983675 | 7.16E−05 |
| 8 | 0.003191528 | 9.12E−06 |
| 9 | 0.003412642 | 4.12E−06 |
| 10 | 0.003647404 | 4.49E−05 |
| 11 | 0.003896182 | 0.000120754 |
| 12 | 0.004159326 | 0.00022241 |
| 13 | 0.004437165 | 0.000341511 |
| 14 | 0.004730004 | 0.000470774 |
| 15 | 0.005038127 | 0.000603888 |
| 16 | 0.00536179 | 0.000735449 |
| 17 | 0.005701221 | 0.000860908 |
| 18 | 0.006056622 | 0.000976505 |
| 19 | 0.006428165 | 0.001079218 |
| 20 | 0.00681599 | 0.001166707 |
| 21 | 0.007220208 | 0.001237259 |
| 22 | 0.007640898 | 0.001289738 |
| 23 | 0.008078104 | 0.001323535 |
| 24 | 0.008531842 | 0.001338517 |
| 25 | 0.009002089 | 0.001334985 |
| 26 | 0.009488795 | 0.001313626 |
| 27 | 0.009991872 | 0.00127547 |
| 28 | 0.010511202 | 0.001221855 |
| 29 | 0.011046632 | 0.001154381 |
| 30 | 0.011597978 | 0.001074876 |
| 31 | 0.012165023 | 0.000985363 |
| 32 | 0.012747518 | 0.000888026 |
| 33 | 0.013345186 | 0.000785178 |
| 34 | 0.013957715 | 0.000679232 |
| 35 | 0.014584768 | 0.000572675 |
| 36 | 0.015225978 | 0.000468042 |
| 37 | 0.015880949 | 0.000367893 |
| 38 | 0.016549261 | 0.00027479 |
| 39 | 0.017230466 | 0.000191278 |
| 40 | 0.017924095 | 0.000119865 |
| 41 | 0.018629653 | 6.30E−05 |
| 42 | 0.019346626 | 2.31E−05 |
| 43 | 0.020074477 | 2.43E−06 |
| 44 | 0.020812652 | 3.23E−06 |
| 45 | 0.021560578 | 2.76E−05 |
| 46 | 0.022317666 | 7.75E−05 |
| 47 | 0.023083314 | 0.000154897 |
| 48 | 0.023856903 | 0.000261441 |
| 49 | 0.024637806 | 0.000398768 |
| 50 | 0.025425381 | 0.000568342 |
| 51 | 0.026218981 | 0.000771487 |
| 52 | 0.027017949 | 0.001009378 |
| 53 | 0.027821623 | 0.001283043 |
| 54 | 0.028629336 | 0.001593359 |
| 55 | 0.029440416 | 0.001941056 |
| 56 | 0.03025419 | 0.002326714 |
| 57 | 0.031069987 | 0.002750767 |
| 58 | 0.031887132 | 0.003213502 |
| 59 | 0.032704955 | 0.003715067 |
| 60 | 0.033522789 | 0.004255466 |
| 61 | 0.034339971 | 0.004834572 |
| 62 | 0.035155843 | 0.005452123 |
| 63 | 0.035969756 | 0.006107732 |
| 64 | 0.036781068 | 0.00680089 |
| 65 | 0.037589144 | 0.007530971 |
| 66 | 0.038393362 | 0.008297236 |
| 67 | 0.039193111 | 0.009098842 |
| 68 | 0.03998779 | 0.009934846 |
| 69 | 0.040776813 | 0.010804212 |
| 70 | 0.041559607 | 0.011705814 |
| 71 | 0.042335613 | 0.012638449 |
| 72 | 0.043104289 | 0.013600835 |
| 73 | 0.043865108 | 0.014591624 |
| 74 | 0.044617559 | 0.015609405 |
| 75 | 0.045361149 | 0.016652711 |
| 76 | 0.046095405 | 0.017720026 |
| 77 | 0.046819869 | 0.018809791 |
| 78 | 0.047534104 | 0.01992041 |
| 79 | 0.04823769 | 0.021050256 |
| 80 | 0.04893023 | 0.022197675 |
| 81 | 0.049611344 | 0.023360997 |
| 82 | 0.050280673 | 0.024538536 |
| 83 | 0.050937879 | 0.025728598 |
| 84 | 0.051582644 | 0.026929488 |
| 85 | 0.052214669 | 0.02813951 |
| 86 | 0.05283368 | 0.029356978 |
| 87 | 0.053439418 | 0.030580215 |
| 88 | 0.05403165 | 0.031807562 |
| 89 | 0.054610161 | 0.03303738 |
| 90 | 0.055174756 | 0.034268054 |
| 91 | 0.055725263 | 0.035497998 |
| 92 | 0.056261528 | 0.036725656 |
| 93 | 0.056783418 | 0.03794951 |
| 94 | 0.057290819 | 0.039168076 |
| 95 | 0.057783639 | 0.040379915 |
| 96 | 0.058261804 | 0.04158363 |
| 97 | 0.058725258 | 0.042777869 |
| 98 | 0.059173965 | 0.043961329 |
| 99 | 0.059607908 | 0.045132759 |
| 100 | 0.060027085 | 0.046290957 |
| 101 | 0.060431516 | 0.047434775 |
| 102 | 0.060821235 | 0.048563122 |
| 103 | 0.061196293 | 0.04967496 |
| 104 | 0.061556759 | 0.050769309 |
| 105 | 0.061902716 | 0.051845246 |
| 106 | 0.062234262 | 0.052901906 |
| 107 | 0.062551512 | 0.053938483 |
| 108 | 0.062854594 | 0.054954228 |
| 109 | 0.06314365 | 0.055948452 |
| 110 | 0.063418834 | 0.056920523 |
| 111 | 0.063680315 | 0.057869868 |
| 112 | 0.063928271 | 0.058795969 |
| 113 | 0.064162896 | 0.059698369 |
| 114 | 0.064384391 | 0.060576664 |
| 115 | 0.064592969 | 0.061430506 |
| 116 | 0.064788855 | 0.062259602 |
| 117 | 0.064972279 | 0.063063712 |
| 118 | 0.065143484 | 0.063842648 |
| 119 | 0.065302719 | 0.064596273 |
| 120 | 0.065450243 | 0.065324499 |
| 121 | 0.065586319 | 0.066027288 |
| 122 | 0.065711219 | 0.066704646 |
| 123 | 0.06582522 | 0.067356627 |
| 124 | 0.065928607 | 0.067983326 |
| 125 | 0.066021667 | 0.068584882 |
| 126 | 0.066104693 | 0.069161473 |
| 127 | 0.066177983 | 0.069713315 |
| 128 | 0.066241837 | 0.070240662 |
| 129 | 0.06629656 | 0.070743804 |
| 130 | 0.066342458 | 0.071223061 |
| 131 | 0.06637984 | 0.071678787 |
| 132 | 0.066409016 | 0.072111365 |
| 133 | 0.0664303 | 0.072521205 |
| 134 | 0.066444003 | 0.072908746 |
| 135 | 0.066450439 | 0.073274447 |
| 136 | 0.066449922 | 0.073618793 |
| 137 | 0.066442765 | 0.073942287 |
| 138 | 0.066429282 | 0.074245454 |
| 139 | 0.066409782 | 0.074528833 |
| 140 | 0.066384578 | 0.074792982 |
| 141 | 0.066353977 | 0.07503847 |
| 142 | 0.066318286 | 0.07526588 |
| 143 | 0.06627781 | 0.075475805 |
| 144 | 0.066232849 | 0.075668847 |
| 145 | 0.066183703 | 0.075845617 |
| 146 | 0.066130667 | 0.076006732 |
| 147 | 0.066074033 | 0.076152811 |
| 148 | 0.066014089 | 0.07628448 |
| 149 | 0.06595112 | 0.076402365 |
| 150 | 0.065885406 | 0.076507093 |
| 151 | 0.065817223 | 0.076599291 |
| 152 | 0.065746842 | 0.076679585 |
| 153 | 0.065674529 | 0.076748596 |
| 154 | 0.065600546 | 0.076806942 |
| 155 | 0.065525149 | 0.076855238 |
| 156 | 0.06544859 | 0.07689409 |
| 157 | 0.065371113 | 0.076924098 |
| 158 | 0.06529296 | 0.076945855 |
| 159 | 0.065214364 | 0.076959944 |
| 160 | 0.065135553 | 0.07696694 |
| 161 | 0.065056751 | 0.076967405 |
| 162 | 0.064978174 | 0.076961893 |
| 163 | 0.064900033 | 0.076950944 |
| 164 | 0.064822531 | 0.076935086 |
| 165 | 0.064745866 | 0.076914835 |
| 166 | 0.06467023 | 0.076890691 |
| 167 | 0.064595808 | 0.076863143 |
| 168 | 0.064522778 | 0.076832662 |
| 169 | 0.064451313 | 0.076799706 |
| 170 | 0.064381577 | 0.076764718 |
| 171 | 0.064313729 | 0.076728122 |
| 172 | 0.064247922 | 0.076690328 |
| 173 | 0.0641843 | 0.076651729 |
| 174 | 0.064123001 | 0.076612701 |
| 175 | 0.064064158 | 0.076573601 |
| 176 | 0.064007895 | 0.076534772 |
| 177 | 0.06395433 | 0.076496535 |
| 178 | 0.063903574 | 0.076459197 |
| 179 | 0.063855731 | 0.076423043 |
| 180 | 0.063810898 | 0.076388341 |
| 181 | 0.063769167 | 0.076355343 |
| 182 | 0.06373062 | 0.076324278 |
| 183 | 0.063695333 | 0.076295359 |
| 184 | 0.063663377 | 0.07626878 |
| 185 | 0.063634814 | 0.076244713 |
| 186 | 0.063609699 | 0.076223315 |
| 187 | 0.063588082 | 0.076204721 |
| 188 | 0.063570004 | 0.076189048 |
| 189 | 0.0635555 | 0.076176393 |
| 190 | 0.063544597 | 0.076166834 |
| 191 | 0.063537317 | 0.076160428 |
| 192 | 0.063533673 | 0.076157216 |

Time domain representation of complete frequency domain reference FDSS taps of TABLE 5 using inverse Fourier transform is shown in TABLE 8. A UE or a gNB can calculate complete frequency domain

FDSS filter taps based on number of subcarriers directly from the inverse Fourier transform of tap values from TABLE 8 based on Equation 6.

TABLE 8
Time domain representations for given filters on TABLE 5 (N_{sc} = 384 and Nₛₑ = 24 subcarriers)
per time domain index (TDI).

| TDI | Almost-flat 1 | Almost-flat 2 | Flat 1 | Flat 2 | ISI-free flat |
|---|---|---|---|---|---|
| 1 | 0.948953688730984 + | 0.961981377256687 + | 0.982676906324051 + | 0.97464982321268 + | 0.222943141966376 + |
| | 0.00000000000000i | 0.00000000000000i | 0.00000000000000i | 0.00000000000000i | 0.00000000000000i |
| 2 | −0.0467083079673027 + | −0.0361357727970705 + | −0.016736036129274 + | −0.0241410219132066 + | 0.222943141966376 + |
| | 0.000382139976872223i | 0.000295641695918402i | 0.000136924430314421i | 0.000197507680261991i | 0.00000000000000i |
| 3 | −0.011197683917507 + | −0.0221560507253019 + | −0.0150830591766636 + | −0.0207722036455973 + | 0.222943141966376 + |
| | 0.000183238027721914i | 0.000362559888894853i | 0.000246818005929222i | 0.000339914723035390i | 0.00000000000000i |
| 4 | −0.0084692180700081 + | −0.0148526820856568 + | −0.0126603429980562 + | −0.01594642400361 + | 0.222943141966376 + |
| | 0.000207907633958709i | 0.000364612879824799i | 0.000310793976028661i | 0.000391462736853319i | 0.00000000000000i |
| 5 | −0.00719171509466074 + | −0.00806946177713652 + | −0.00987583710564786 + | −0.0106149788499581 + | 0.222943141966376 + |
| | 0.000235432375255005i | 0.000264166826440492i | 0.000323301431829572i | 0.000347498427153021i | 0.00000000000000i |
| 6 | −0.00565184784886804 + | −0.00477672254605813 + | −0.00714903951390531 + | −0.00572392545269545 + | 0.222943141966376 + |
| | 0.000231324400906268i | 0.000195506409728222i | 0.000292602937451793i | 0.000234274464136912i | 0.00000000000000i |
| 7 | −0.004391864397155 + | −0.00310078472214803 + | −0.00481697296383249 + | −0.00198216477291061 + | 0.222943141966376 + |
| | 0.000215758462446909i | 0.000152331785212430i | 0.000236642707137784i | 9.73775110171095e−05i | 0.00000000000000i |
| 8 | −0.00345208803157033 + | −0.00216255871708628 + | −0.00307260286182962 + | 0.00028023621507339 − | 0.222943141966376 + |
| | 0.000197912715887954i | 0.000123982315935037i | 0.000176156335431914i | 1.60663082482595e−05i | 0.00000000000000i |
| 9 | −0.00276044653412219 + | −0.00159162409063381 + | −0.00194954879933033 + | 0.00112985647041145 − | 0.222943141966376 + |
| | 0.000180929224762690i | 0.000104320554400292i | 0.000127780179235399i | 7.40547055549688e−05i | 0.00000000000000i |
| 10 | −0.00224631005514697 + | −0.00122021575028442 + | −0.00135102917743895 + | 0.000933768743362836 − | 0.222943141966376 + |
| | 0.000165697784241081i | 9.00085211544694e−05i | 9.96578992440265e−05i | 6.88789205275911e−05i | 0.00000000000000i |
| 11 | −0.00185764269279769 + | −0.000965499862978985 + | −0.00110741921177174 + | 0.000195322390845902 − | 0.222943141966376 + |
| | 0.000152318023549661i | 7.91664788048909e−05i | 9.08032024845188e−05i | 1.60155236763189e−05i | 0.00000000000000i |
| 12 | −0.00155847185779321 + | −0.000783290949090267 + | −0.00104012558524212 + | −0.000616076537001792 + | 0.222943141966376 + |
| | 0.000140632256504067i | 7.06820422319047e−05i | 9.38581004005662e−05i | 5.55930690339549e−05i | 0.00000000000000i |
| 13 | −0.00132416176014599 + | −0.000648425565471783 + | −0.00101125095364551 + | −0.00118656580330574 + | 0.222943141966376 + |
| | 0.000130418550028669i | 6.38643439159887e−05i | 9.95995255708171e−05i | 0.000116866531143203i | 0.00000000000000i |
| 14 | −0.00113769489689755 + | −0.000545765303890035 + | −0.000947010923651072 + | −0.00140171888534825 + | 0.222943141966376 + |
| | 0.000121458990786292i | 5.82652723479940e−05i | 0.000101101790439525i | 0.000149645886295837i | 0.00000000000000i |
| 15 | −0.000987139248257589 + | −0.000465773390164514 + | −0.000834057951441376 + | −0.00131551176813081 + | 0.222943141966376 + |
| | 0.000113561226936726i | 5.35829142189676e−05i | 9.59506416842418e−05i | 0.000151337443731804i | 0.00000000000000i |
| 16 | −0.000863983355666744 + | −0.000402203316118745 + | −0.000697267648867836 + | −0.00107263758760927 + | 0.222943141966376 + |
| | 0.000106562183139440i | 4.96070475784343e−05i | 8.59997619265700e−05i | 0.000132297228069695i | 0.00000000000000i |
| 17 | −0.000762053644118017 + | −0.000350826481518696 + | −0.00057199214001143 + | −0.000822989442665523 + | 0.222943141966376 + |
| | 0.000100326265543714i | 4.61871825117353e−05i | 7.53041938328636e−05i | 0.000108348615614975i | 0.00000000000000i |
| 18 | −0.000676796527974075 + | −0.000308695941795311 + | −0.000482514856367271 + | −0.000661222201309311 + | 0.222943141966376 + |
| | 9.47411514785207e−05i | 4.32127054049461e−05i | 6.75446921020240e−05i | 9.25609842041117e−05i | 0.00000000000000i |
| 19 | −0.000604802235926397 + | −0.000273706565626464 + | −0.0004330362619337 + | −0.000607126274975368 + | 0.222943141966376 + |
| | 8.97139369315469e−05i | 4.06005337079246e−05i | 6.42348615538499e−05i | 9.00586755589494e−05i | 0.00000000000000i |
| 20 | −0.000543481449436051 + | −0.000244322881627901 + | −0.000410920883900097 + | −0.000622931453112792 + | 0.222943141966376 + |
| | 8.51676632348904e−05i | 3.82872477517955e−05i | 6.43944176797623e−05i | 9.76180811179189e−05i | 0.00000000000000i |
| 21 | −0.000490841357715969 + | −0.00021940179849706 + | −0.000397024180551032 + | −0.000649914904699368 + | 0.222943141966376 + |
| | 8.10382361352730e−05i | 3.62233835344347e−05i | 6.55489574974341e−05i | 0.000107301385033934i | 0.00000000000000i |
| 22 | −0.000445329812424406 + | −0.000198079194668393 + | −0.000376336464924904 + | −0.000643237157375118 + | 0.222943141966376 + |
| | 7.72720526457333e−05i | 3.43700006858180e−05i | 6.53005712145639e−05i | 0.000111612234576868i | 0.00000000000000i |
| 23 | −0.000405723861344956 + | −0.000179690276265978 + | −0.000343862135332836 + | −0.00059009006817296 + | 0.222943141966376 + |
| | 7.38239640812182e−05i | 3.26957563127512e−05i | 6.25678407071035e−05i | 0.000107370534858549i | 0.00000000000000i |
| 24 | −0.000371050367924867 + | −0.000163718152966924 + | −0.000304151511652329 + | −0.00050737789872415 + | 0.222943141966376 + |
| | 7.06558064965972e−05i | 3.11753851659121e−05i | 5.79168549896328e−05i | 9.66154401985739e−05i | 0.00000000000000i |
| 25 | −0.000340527721735631 + | −0.000149755373765489 + | −0.000266276338905944 + | −0.000425372239223294 + | 0.222943141966376 + |
| | 6.77351752888284e−05i | 2.97881959235138e−05i | 5.29656569489694e−05i | 8.46117991214916e−05i | 0.00000000000000i |
| 26 | −0.000313522010566009 + | −0.000137477005084685 + | −0.000237795181263614 + | −0.000368739610300442 + | 0.222943141966376 + |
| | 6.50342943170409e−05i | 2.85170409387265e−05i | 4.93261757844457e−05i | 7.64881556460308e−05i | 0.00000000000000i |
| 27 | −0.000289515918074259 + | −0.000126621437140173 + | −0.000220933646827293 + | −0.000344901851448029 + | 0.222943141966376 + |
| | 6.25294450976625e−05i | 2.73476092593043e−05i | 4.77170942150763e−05i | 7.44916601741745e−05i | 0.00000000000000i |
| 28 | −0.000268082788952671 + | −0.000116976791964036 + | −0.000212399183837635 + | −0.000343860514613149 + | 0.222943141966376 + |
| | 6.02000033780020e−05i | 2.62680170513535e−05i | 4.76958317035706e−05i | 7.72164607140352e−05i | 0.00000000000000i |
| 29 | −0.000248869381542202 + | −0.00010836769033778 + | −0.000206133225498234 + | −0.000347052321069189 + | 0.222943141966376 + |
| | 5.80282010426136e−05i | 2.52678014566356e−05i | 4.80635270463976e−05i | 8.09212516803458e−05i | 0.00000000000000i |
| 30 | −0.000231580423402865 + | −0.000100651453016441 + | −0.000196967213904722 + | −0.000338801050439417 + | 0.222943141966376 + |
| | 5.59984613781486e−05i | 2.43385275040738e−05i | 4.76286413097081e−05i | 8.19254808291936e−05i | 0.00000000000000i |
| 31 | −0.000215967902256744 + | −9.37079315294563E−05 + | −0.000183098830051965 + | −0.000313934669420213 + | 0.222943141966376 + |
| | 5.40971433351853e−05i | 2.34726149146369e−05i | 4.58638693543012e−05i | 7.86365410417314e−05i | 0.00000000000000i |
| 32 | −0.000201823304919224 + | −8.74367744575193E−05 + | −0.000166319802573595 + | −0.000278370688566483 + | 0.222943141966376 + |
| | 5.23125120230377e−05i | 2.26635735496215e−05i | 4.31100198031276e−05i | 7.21535602557088e−05i | 0.00000000000000i |
| 33 | −0.000188968168967077 + | −0.000081754177112305 + | −0.000150296948962537 + | −0.000243713372064012 + | 0.222943141966376 + |
| | 5.06338682699158e−05i | 2.19059657351120e−05i | 4.02719460993733e−05i | 6.53028012292173e−05i | 0.00000000000000i |
| 34 | −0.000177251538157516 + | −7.65885056190813E−05 + | −0.000138171663176996 + | −0.000219825925349513 + | 0.222943141966376 + |
| | 4.90521067979043e−05i | 2.11948939691574e−05i | 3.82372488783630e−05i | 6.08340264873148e−05i | 0.00000000000000i |
| 35 | −0.00016654284786672 + | −7.18781616085949E−05 + | −0.000130876870117317 + | −0.000209684751237557 + | 0.222943141966376 + |
| | 4.75588470491448e−05i | 2.05259039214516e−05i | 3.73738838257509e−05i | 5.98786747097409e−05i | 0.00000000000000i |
| 36 | −0.0001567303030202 + | −6.75716871518342E−05 + | −0.000126948041882199 + | −0.000208861717286085 + | 0.222943141966376 + |
| | 4.61468148615683e−05i | 1.98954387045230e−05i | 3.73778884675631e−05i | 6.14961039029449e−05i | 0.00000000000000i |
| 37 | −0.000147716707640931 + | −6.36237142075123E−05 + | −0.00012367772523451 + | −0.000209122295678756 + | 0.222943141966376 + |
| | 4.48093733762709e−05i | 1.93000427036386e−05i | 3.75172277859888e−05i | 6.34365548625046e−05i | 0.00000000000000i |
| 38 | −0.000139417938157691 + | −5.99956109844392E−05 + | −0.0001187679074518 + | −0.000203514677078955 + | 0.222943141966376 + |
| | 4.35406643856548e−05i | 1.87368196446210e−05i | 3.70915942846346e−05i | 6.35582792956453e−05i | 0.00000000000000i |
| 39 | −0.000131760481241591 + | −5.66536528381941E−05 + | −0.000111501789465303 + | −0.000189949416188939 + | 0.222943141966376 + |
| | 4.23353735890162e−05i | 1.82031329537242e−05i | 3.58261435323854e−05i | 6.10318012016783e−05i | 0.00000000000000i |
| 40 | −0.000124680281109791 + | −5.35683472889779E−05 + | −0.000102869185479436 + | −0.00017155671165127 + | 0.222943141966376 + |
| | 4.11888013134262e−05i | 1.76965915823632e−05i | 3.39833885861635e−05i | 5.66746822135086e−05i | 0.00000000000000i |
| 41 | −0.000118121070626924 + | −5.07141102618963E−05 + | −9.47344702958589E−05 + | −0.000154118244356583 + | 0.222943141966376 + |
| | 4.00967004858106e−05i | 1.72151207128689e−05i | 3.21580194030953e−05i | 5.23160944153875e−05i | 0.00000000000000i |
| 42 | −0.000112032666017069 + | −4.80689649584376E−05 + | −8.86452727568556E−05 + | −0.000142418384732351 + | 0.222943141966376 + |
| | 3.90550153655734e−05i | 1.67570248196447e−05i | 3.09020807295353e−05i | 4.96475929905557e−05i | 0.00000000000000i |
| 43 | −0.000106371507827939 + | −4.56121510726409E−05 + | −8.49903305426602E−05 + | −0.000137680356392973 + | 0.222943141966376 + |
| | 3.80603340856892e−05i | 1.63202886152515e−05i | 3.04100265245764e−05i | 4.92628192300287e−05i | 0.00000000000000i |
| 44 | −0.000101098637409347 + | −4.33264364648467E−05 + | −8.29229463994418E−05 + | −0.000137348736331154 + | 0.222943141966376 + |
| | 3.71094331706773e−05i | 1.59034734761632e−05i | 3.04378339469233e−05i | 5.04154544766081e−05i | 0.00000000000000i |
| 45 | −9.61794349596176E−05 + | −4.11964863385531E−05 + | −0.000080986909480333 + | −0.000137012521154978 + | 0.222943141966376 + |
| | 3.61993760323144e−05i | 1.55052595266915e−05i | 3.04813143392305e−05i | 5.15678614301192e−05i | 0.00000000000000i |
| 46 | −9.15830064517244E−05 + | −3.92084609747411E−05 + | −7.80018703932101E−05 + | −0.000133109330638504 + | 0.222943141966376 + |
| | 3.53274639355122e−05i | 1.51243723559317e−05i | 3.00886416594234e−05i | 5.13459347951274e−05i | 0.00000000000000i |
| 47 | −8.72819270438495E−05 + | −3.73495917159484E−05 + | −0.000073679891415925 + | −0.000124800142430307 + | 0.222943141966376 + |
| | 3.44912958044413e−05i | 1.47594795358130e−05i | 2.91161643164595e−05i | 4.93174105429377e−05i | 0.00000000000000i |
| 48 | −8.32511979610567E−05 + | −3.56091966302064E−05 + | −6.86628005462433E−05 + | −0.000114074847975899 + | 0.222943141966376 + |
| | 3.36884974671976e−05i | 1.44096464659507e−05i | 2.77851447059634e−05i | 4.61616207481415e−05i | 0.00000000000000i |
| 49 | −0.000079469096206831 + | −3.39777521817598E−05 + | −6.40322699453828E−05 + | −0.000104254158323897 + | 0.222943141966376 + |
| | 3.29171774384170e−05i | 1.40740457726184e−05i | 2.65230346409127e−05i | 4.31834863115499e−05i | 0.00000000000000i |
| 50 | −7.59154851433899E−05 + | −3.24459379646303E−05 + | −6.06328083776099E−05 + | −9.79279359712863E−05 + | 0.222943141966376 + |
| | 3.21753570438881e−05i | 1.37516033344728e−05i | 2.56980806279309e−05i | 4.15049221973085e−05i | 0.00000000000000i |
| 51 | −7.25723405740275E−05 + | −3.10059473946225E−05 + | −5.86112782456323E−05 + | −9.55579050605175E−05 + | 0.222943141966376 + |
| | 3.14612652914436e−05i | 1.34415719388266e−05i | 2.54089224540792e−05i | 4.14258735218386e−05i | 0.00000000000000i |
| 52 | −6.94237851303656E−05 + | −2.96507223423126E−05 + | −5.74068422579074E−05 + | −9.54525253259385E−05 + | 0.222943141966376 + |
| | 3.07734474872007e−05i | 1.31432612791901e−05i | 2.54467030616722e−05i | 4.23111945008846e−05i | 0.00000000000000i |
| 53 | −6.64544241915745E−05 + | −2.83732462229672E−05 + | −5.61444770829453E−05 + | −9.49671870090544E−05 + | 0.222943141966376 + |
| | 3.01101078724243e−05i | 1.28557506119024e−05i | 2.54387316115316e−05i | 4.30290726308934e−05i | 0.00000000000000i |
| 54 | −6.36518210620001E−05 + | −0.000027168533554553 + | −5.41630960152586E−05 + | −9.21097666645453E−05 + | 0.222943141966376 + |
| | 2.94702716057447e−05i | 1.25788084240777e−05i | 2.50770696571739e−05i | 4.26460672429461e−05i | 0.00000000000000i |
| 55 | −6.10029233696511E−05 + | −2.60304930242217E−05 + | −5.13636330010016E−05 + | −8.65958813867411E−05 + | 0.222943141966376 + |
| | 2.88522339802440e−05i | 1.23115062995393e−05i | 2.42931891712828e−05i | 4.09568016331914e−05i | 0.00000000000000i |
| 56 | −5.84973811610456E−05 + | −2.49545656740484E−05 + | −4.81991434938293E−05 + | −7.98157496469016E−05 + | 0.222943141966376 + |
| | 2.82551258139094e−05i | 1.20534351924320e−05i | 2.32809202140429e−05i | 3.85522223977155e−05i | 0.00000000000000i |
| 57 | −5.61246427309316E−05 + | −2.39364106998913E−05 + | −4.53512218814332E−05 + | −7.38498488181733E−05 + | 0.222943141966376 + |
| | 2.76776108503994e−05i | 1.18041314522588e−05i | 2.23647476357593e−05i | 3.64187151577863e−05i | 0.00000000000000i |
| 58 | −5.38759571758539E−05 + | −2.29719405888423E−05 + | −4.33103802527779E−05 + | −7.01954491967754E−05 + | 0.222943141966376 + |
| | 2.71188778785297e−05i | 1.15631031747276e−05i | 2.18006133814710e−05i | 3.53334198440672e−05i | 0.00000000000000i |
| 59 | −5.17423083966345E−05 + | −2.20569110102447E−05 + | −4.21097864434991E−05 + | −6.89604811447618E−05 + | 0.222943141966376 + |
| | 2.65776660970123e−05i | 1.13296301252740e−05i | 2.16298784919425e−05i | 3.54218568623815e−05i | 0.00000000000000i |
| 60 | −4.97166597293641E−05 + | −2.11891219562386E−05 + | −4.13486856165986E−05 + | −6.89367156887039E−05 + | 0.222943141966376 + |
| | 2.60534226302591e−05i | 1.11039066682085e−05i | 2.16682855895635e−05i | 3.61254637450849e−05i | 0.00000000000000i |
| 61 | −4.77916582371936E−05 + | −2.03642282375208E−05 + | −4.04628000936289E−05 + | −6.84210431717816E−05 + | 0.222943141966376 + |
| | 2.55451735333419e−05i | 1.08849067679995e−05i | 2.16278172417954e−05i | 3.65718095086871e−05i | 0.00000000000000i |
| 62 | −4.59609446368233E−05 + | −1.95801441636573E−05 + | −3.90622419600335E−05 + | −6.62398525096538E−05 + | 0.222943141966376 + |
| | 2.50522169778033e−05i | 1.06726705449741e−05i | 2.12918983488034e−05i | 3.61057669889600e−05i | 0.00000000000000i |
| 63 | −4.42179263929571E−05 + | −1.88341778221052E−05 + | −3.71365198981245E−05 + | −6.23692932065082E−05 + | 0.222943141966376 + |
| | 2.45734896781577e−05i | 1.04668290004172e−05i | 2.06380977771177e−05i | 3.46608560795878e−05i | 0.00000000000000i |
| 64 | −4.25577019057338E−05 + | −0.000018124143435432 + | −3.50217124372394E−05 + | −5.78345101580051E−05 + | 0.222943141966376 + |
| | 2.41086403418777e−05i | 1.02672004366525e−05i | 1.98395550393304e−05i | 3.27628453208470e−05i | 0.00000000000000i |
| 65 | −4.09751054538021E−05 + | −1.74468574314648E−05 + | −3.31712097379087E−05 + | −5.40144053409384E−05 + | 0.222943141966376 + |
| | 2.36569881638275e−05i | 1.00729478345688e−05i | 1.91514068715270e−05i | 3.11852314637087e−05i | 0.00000000000000i |
| 66 | −3.94654958854367E−05 + | −1.68012112819832E−05 + | −3.18802697446574E−05 + | −5.18075706777831E−05 + | 0.222943141966376 + |
| | 2.32179692452151e−05i | 9.88433055446330e−06i | 1.87555003644016e−05i | 3.04789425719572e−05i | 0.00000000000000i |
| 67 | −3.80236360643991E−05 + | −1.61849885364487E−05 + | −3.11272778968681E−05 + | −5.11524563799101E−05 + | 0.222943141966376 + |
| | 2.27904903917163e−05i | 9.70090880064772e−06i | 1.86569723796899e−05i | 3.06596024552889e−05i | 0.00000000000000i |
| 68 | −3.66466869797688E−05 + | −1.55967705792916E−05 + | −3.06126363666636E−05 + | −5.11460613829026E−05 + | 0.222943141966376 + |
| | 2.23747206145294e−05i | 9.52264482716362e−06i | 1.86906168723092e−05i | 3.12273476346662e−05i | 0.00000000000000i |
| 69 | −3.53307529928903E−05 + | −1.50343795338167E−05 + | 0.000029955156204473 + | −5.06389220700124E−05 + | 0.222943141966376 + |
| | 2.19700740302798e−05i | 9.34897796896099e−06i | 1.86273131380289e−05i | 3.14893052779165e−05i | 0.00000000000000i |
| 70 | −3.40717008416352E−05 + | −0.000014496542711652 + | −2.89186061588471E−05 + | −4.89206229498118E−05 + | 0.222943141966376 + |
| | 2.15756666072588e−05i | 9.17983443086456e−06i | 1.83125053876797e−05i | 3.09786428300252e−05i | 0.00000000000000i |
| 71 | −3.28665402602684E−05 + | −1.39821972302684E−05 + | −2.75347963175461E−05 + | −4.60916619130604E−05 + | 0.222943141966376 + |
| | 2.11911896393250e−05i | 9.01522918855066e−06i | 1.77534685982963e−05i | 2.97182831127529e−05i | 0.00000000000000i |
| 72 | −3.17125546148118E−05 + | −1.34893881199278E−05 + | −2.60608301121531E−05 + | −4.29335017620105E−05 + | 0.222943141966376 + |
| | 2.08164021336021e−05i | 8.85455401027465e−06i | 1.71065600403143e−05i | 2.81819313687270e−05i | 0.00000000000000i |
| 73 | −3.06064796745673E−05 + | −1.30171280735815E−05 + | −2.48093040448056E−05 + | −4.03946393497991E−05 + | 0.222943141966376 + |
| | 2.04505959004726e−05i | 8.69776690581581e−06i | 1.65770469843840e−05i | 2.69908350999901e−05i | 0.00000000000000i |
| 74 | −2.95464565957063E−05 + | −1.25651951151762E−05 + | −2.39604799100764E−05 + | −3.90226768928911E−05 + | 0.222943141966376 + |
| | 2.00938890710609e−05i | 8.54531019591747e−06i | 1.62949903601089e−05i | 2.65384560819206e−05i | 0.00000000000000i |
| 75 | −2.85292312568558E−05 + | −1.21311902413939E−05 + | −2.34668684329136E−05 + | −3.86762344656576E−05 + | 0.222943141966376 + |
| | 1.97453693273448e−05i | 8.39611938856575e−06i | 1.62416568463514e−05i | 2.67682128144198e−05i | 0.00000000000000i |
| 76 | −2.75532118188044E−05 + | −1.17148457081799E−05 + | −2.30980924000741E−05 + | −3.86610647265796E−05 + | 0.222943141966376 + |
| | 1.94051611648542e−05i | 8.25052521947508e−06i | 1.62675120625351e−05i | 2.72281938221038e−05i | 0.00000000000000i |
| 77 | −2.66157089411227E−05 + | −1.13152569632292E−05 + | −0.000022588686775327 + | −3.81771070717399E−05 + | 0.222943141966376 + |
| | 1.90725473061584e−05i | 8.10839847212020e−06i | 1.61868240316081e−05i | 2.73573280444576e−05i | 0.00000000000000i |
| 78 | −2.57150944858473E−05 + | −1.09312228864295E−05 + | −2.17947298854179E−05 + | −0.000036791857452823 + | 0.222943141966376 + |
| | 1.87474730796259e−05i | 7.96935849889729e−06i | 1.58893490369821e−05i | 2.68229369145755e−05i | 0.00000000000000i |
| 79 | −0.000024849391926839 + | −1.05621756981333E−05 + | −2.07674795515879E−05 + | −3.46626221625436E−05 + | 0.222943141966376 + |
| | 1.84295650970655e−05i | 7.83344337634519e−06i | 1.54022125541285e−05i | 2.57075526620717e−05i | 0.00000000000000i |
| 80 | −2.40168280324183E−05 + | −1.02073115624653E−05 + | −1.97075683145794E−05 + | −3.23977862191743E−05 + | 0.222943141966376 + |
| | 1.81185238970511e−05i | 7.70049309673744e−06i | 1.48675773078154e−05i | 2.44411986058846e−05i | 0.00000000000000i |
| 81 | −2.32158132342253E−05 + | −9.86648753632043E−06 + | −1.88355826585325E−05 + | −3.06656104114111E−05 + | 0.222943141966376 + |
| | 1.78141200425001e−05i | 7.57082216317520e−06i | 1.44530509082007e−05i | 2.35305504715237e−05i | 0.00000000000000i |
| 82 | −2.24448760628869E−05 + | −9.53787267083091E−06 + | −0.000018260795214492 + | −2.97977182514759E−05 + | 0.222943141966376 + |
| | 1.75161531994602e−05i | 7.44342888912601e−06i | 1.42508644567617e−05i | 2.32543675636620e−05i | 0.00000000000000i |
| 83 | −2.17026241964607E−05 + | −9.22166257768614E−06 + | −1.79247529251943E−05 + | −2.96189117085766E−05 + | 0.222943141966376 + |
| | 1.72244274716660e−05i | 7.31883189791650e−06i | 1.42260956054298e−05i | 2.35072400413822e−05i | 0.00000000000000i |
| 84 | −2.09873794459182E−05 + | −8.91703416274323E−06 + | −1.76471034577907E−05 + | −2.95858304533586E−05 + | 0.222943141966376 + |
| | 1.69384606414998e−05i | 7.19674567249924e−06i | 1.42425960385631e−05i | 2.38780847304756e−05i | 0.00000000000000i |
| 85 | −2.02980766116509E−05 + | −8.62360465858026E−06 + | −1.72394123949163E−05 + | −0.000029130826167827 + | 0.222943141966376 + |
| | 1.66582009698016e−05i | 7.07720944380608e−06i | 1.41480201188565e−05i | 2.39070511952521e−05i | 0.00000000000000i |
| 86 | −1.96334536705898E−05 + | −8.34054973936325E−06 + | −1.66155409587544E−05 + | −2.79952522794441E−05 + | 0.222943141966376 + |
| | 1.63833916297405e−05i | 6.95988057322850e−06i | 1.38650549839356e−05i | 2.33610035994130e−05i | 0.00000000000000i |
| 87 | −1.89928440096789E−05 + | −8.06766191909926E−06 + | −1.58342977941012E−05 + | −0.000026358101392814 + | 0.222943141966376 + |
| | 1.61142280868767e−05i | 6.84490138632966e−06i | 1.34344011944529e−05i | 2.23631836055941e−05i | 0.00000000000000i |
| 88 | −1.83742808850714E−05 + | −7.80472421452304E−06 + | −1.50542150918766E−05 + | −2.46992952955608E−05 + | 0.222943141966376 + |
| | 1.58497636924197e−05i | 6.73240140707628e−06i | 1.29858552437217e−05i | 2.13057586445118e−05i | 0.00000000000000i |
| 89 | −1.77775817921779E−05 + | −7.55065287661323E−06 + | −1.44330803296123E−05 + | −2.34962860606681E−05 + | 0.222943141966376 + |
| | 1.55905208006686e−05i | 6.62174485301984e−06i | 1.26574717375536e−05i | 2.06056898429501e−05i | 0.00000000000000i |
| 90 | −0.000017201323493207 + | −7.30542180564555E−06 + | −1.40348871430306E−05 + | −2.29432000272844E−05 + | 0.222943141966376 + |
| | 1.53359207796440e−05i | 6.51318313486366e−06i | 1.25128695743532e−05i | 2.04551177814259e−05i | 0.00000000000000i |
| 91 | −1.66451032478681E−05 + | −7.06870081817987E−06 + | −0.000013798202763344 + | −0.000022855478067466 + | 0.222943141966376 + |
| | 1.50862422067396e−05i | 6.40669697521284e−06i | 1.25059620121090e−05i | 2.07149978430271e−05i | 0.00000000000000i |
| 92 | −1.61074455389255E−05 + | −6.83996348124959E−06 + | −1.35803051534177E−05 + | −2.28032264737825E−05 + | 0.222943141966376 + |
| | 1.48407666006827e−05i | 6.30207324538838e−06i | 1.25123588753333e−05i | 2.10099957204317e−05i | 0.00000000000000i |
| 93 | −1.55876892946814E−05 + | −6.61893354818187E−06 + | −1.32460935810181E−05 + | −2.23796228952416E−05 + | 0.222943141966376 + |
| | 1.45994642108920e−05i | 6.19930777578008e−06i | 1.24063204952511e−05i | 2.09608042177117e−05i | 0.00000000000000i |
| 94 | −1.50855176169472E−05 + | −6.4054552684313E−06 + | −1.27466195766229E−05 + | −2.14378872016017E−05 + | 0.222943141966376 + |
| | 1.43626067402856e−05i | 6.09850038619687e−06i | 1.21357906898321e−05i | 2.04105653539722e−05i | 0.00000000000000i |
| 95 | −1.45996091138111E−05 + | −6.19878010263723E−06 + | −1.21418362432875E−05 + | −2.01598419967795E−05 + | 0.222943141966376 + |
| | 1.41294883990909e−05i | 5.99917373581543e−06i | 1.17508580542008e−05i | 1.95106767174720e−05i | 0.00000000000000i |
| 96 | −1.41299377254854E−05 + | −5.99905354854684E−06 + | −1.15578717438913E−05 + | −1.89268931157661E−05 + | 0.222943141966376 + |
| | 1.39006082409947e−05i | 5.90168865675356e−06i | 1.13702869986313e−05i | 1.86197088432312e−05i | 0.00000000000000i |
| 97 | −1.36750943734073E−05 + | −5.80575369527973E−06 + | −1.11081858416758E−05 + | −1.80820927900838E−05 + | 0.222943141966376 + |
| | 1.36750943734073e−05i | 5.80575369527973e−06i | 1.11081858416758e−05i | 1.80820927900838e−05i | 0.00000000000000i |
| 98 | −1.32350753445074E−05 + | −5.61848598297499E−06 + | −1.08272698564323E−05 + | −1.77301300375209E−05 + | 0.222943141966376 + |
| | 1.34534249989442e−05i | 5.71117865308720e−06i | 1.10058960123176e−05i | 1.80226382149234e−05i | 0.00000000000000i |
| 99 | −1.28089909085535E−05 + | −5.43746960901696E−06 + | −1.06550603105481E−05 + | −1.76903780099367E−05 + | 0.222943141966376 + |
| | 1.32351756217339e−05i | 5.61838678214057e−06i | 1.10095787776771e−05i | 1.82789777467980e−05i | 0.00000000000000i |
| 100 | −1.23964335228826E−05 + | −5.26218025328452E−06 + | −1.04780107908637E−05 + | −1.76208692539946E−05 + | 0.222943141966376 + |
| | 1.30203813053170e−05i | 5.52704076286015e−06i | 1.10053988969007e−05i | 1.85077777567692e−05i | 0.00000000000000i |
| 101 | −1.19970383790813E−05 + | −5.09234080248783E−06 + | −1.01990894587911E−05 + | −1.72294837592602E−05 + | 0.222943141966376 + |
| | 1.28091075129959e−05i | 5.43703693951725e−06i | 1.08894569879949e−05i | 1.83957325876886e−05i | 0.00000000000000i |
| 102 | −1.16099893699238E−05 + | −4.92776267097199E−06 + | −9.79369913380781E−06 + | −1.64426132290241E−05 + | 0.222943141966376 + |
| | 1.26009172245183e−05i | 5.34835369270970e−06i | 1.06296042291484e−05i | 1.78460118826975e−05i | 0.00000000000000i |
| 103 | −1.12349313890648E−05 + | −4.76841440895287E−06 + | −9.3194712948082E−06 + | −1.54346563186522E−05 + | 0.222943141966376 + |
| | 1.23958365768735e−05i | 5.26113455410791e−06i | 1.02824520375497e−05i | 1.70295189815131e−05i | 0.00000000000000i |
| 104 | −1.08712370675916E−05 + | −4.6140369043531E−06 + | −8.87700556668027E−06 + | −1.45095588670513E−05 + | 0.222943141966376 + |
| | 1.21935727406213e−05i | 5.17527069562935e−06i | 9.95677055179819e−06i | 1.62744460800273e−05i | 0.00000000000000i |
| 105 | −1.05187134217165E−05 + | −4.46400308399949E−06 + | −8.54768183774795E−06 + | −1.39132387867117E−05 + | 0.222943141966376 + |
| | 1.19942938785627e−05i | 5.09021994588697e−06i | 9.74676310989966e−06i | 1.58650082115444e−05i | 0.00000000000000i |
| 106 | −0.000010177027207973 + | −4.31900431337005E−06 + | −8.34658406459314E−06 + | −1.36916276651737E−05 + | 0.222943141966376 + |
| | 1.17980028045358e−05i | 5.00692628216275e−06i | 9.67601050778434e−06i | 1.58724014676710e−05i | 0.00000000000000i |
| 107 | −9.84564884231432E−06 + | −4.1782184938702E−06 + | −8.21737532173921E−06 + | −1.36752502028717E−05 + | 0.222943141966376 + |
| | 1.16044573545806e−05i | 4.92460772334810e−06i | 9.68531206169676e−06i | 1.61181716242426e−05i | 0.00000000000000i |
| 108 | −9.52407494936888E−06 + | −4.0414667288093E−06 + | −8.06963298635998E−06 + | −1.35918412858348E−05 + | 0.222943141966376 + |
| | 1.14134172276172e−05i | 4.84319435038194e−06i | 9.67044974306483e−06i | 1.62881283811227e−05i | 0.00000000000000i |
| 109 | −9.21195818968695E−06 + | −3.9090484498346E−06 + | −7.83409428361486E−06 + | −1.32329443526828E−05 + | 0.222943141966376 + |
| | 1.12248035317010e−05i | 4.76318931783754e−06i | 9.54587150437336e−06i | 1.61243893476536e−05i | 0.00000000000000i |
| 110 | −8.90962061444456E−06 + | −3.78050221030233E−06 + | −7.50215594870096E−06 + | −1.25730013430628E−05 + | 0.222943141966376 + |
| | 1.10393495909768e−05i | 4.68418211447791e−06i | 9.29544879491979e−06i | 1.55784138562403e−05i | 0.00000000000000i |
| 111 | −8.61569655314138E−06 + | −3.65589422053828E−06 + | −7.12724066463962E−06 + | −1.17734492633358E−05 + | 0.222943141966376 + |
| | 1.08557004168158e−05i | 4.60639394260551e−06i | 8.98025934138144e−06i | 1.48344405222513e−05i | 0.00000000000000i |
| 112 | −8.33056987281471E−06 + | −3.53458419177286E−06 + | −6.7894521080365E−06 + | −0.000011076136975829 + | 0.222943141966376 + |
| | 1.06746387862306e−05i | 4.52915107642698e−06i | 8.69987886977826e−06i | 1.41927578987889e−05i | 0.00000000000000i |
| 113 | −0.000008053844274384 + | −3.41724295536183E−06 + | −6.54652404966295E−06 + | −1.06554415418167E−05 + | 0.222943141966376 + |
| | 1.04959742072864e−05i | 4.45343772458962e−06i | 8.53159624543647e−06i | 1.38864417761216e−05i | 0.00000000000000i |
| 114 | −7.78517620526561E−06 + | −3.30292535620158E−06 + | −6.40082869670525E−06 + | −1.05188219831868E−05 + | 0.222943141966376 + |
| | 1.03195624095141e−05i | 4.37815965221519e−06i | 8.48455442326167e−06i | 1.39431192137534e−05i | 0.00000000000000i |
| 115 | −7.5241403246204E−06 + | −3.19206642766918E−06 + | −6.30101237669101E−06 + | −1.05117719697848E−05 + | 0.222943141966376 + |
| | 1.01451288109277e−05i | 4.30400333918902e−06i | 8.49593168691584e−06i | 1.41734837554196e−05i | 0.00000000000000i |
| 116 | −7.27045378635643E−06 + | −3.0846435075279E−06 + | −6.17530926852018E−06 + | −1.04182587604604E−05 + | 0.222943141966376 + |
| | 9.97256565068952e−06i | 4.23107151104378e−06i | 8.47040348557306e−06i | 1.42902730018789e−05i | 0.00000000000000i |
| 117 | −7.02416522350529E−06 + | −2.97975571578671E−06 + | −5.97503555142271E−06 + | −1.00918300675099E−05 + | 0.222943141966376 + |
| | 9.80221121710003e−06i | 4.15824428556728e−06i | 8.33815245529189e−06i | 1.40831325490213e−05i | 0.00000000000000i |
| 118 | −6.7850793413237E−06 + | −2.87840114279628E−06 + | −5.70197009758239E−06 + | −9.53813066471854E−06 + | 0.222943141966376 + |
| | 9.63407243623183e−06i | 4.08701559925942e−06i | 8.09617547355310e−06i | 1.35431049671721e−05i | 0.00000000000000i |
| 119 | −6.55269530486924E−06 + | −2.77969093680512E−06 + | −5.40433930750906E−06 + | −8.90277854730802E−06 + | 0.222943141966376 + |
| | 9.46770640797871e−06i | 4.01625536823446e−06i | 7.80849642963776e−06i | 1.28632401751533e−05i | 0.00000000000000i |
| 120 | −6.32694816253482E−06 + | −2.68397433082775E−06 + | −5.1455480090061E−06 + | −8.37710419155574E−06 + | 0.222943141966376 + |
| | 9.30327118889333e−06i | 3.94656956596912e−06i | 7.56611676174641e−06i | 1.23178616403325e−05i | 0.00000000000000i |
| 121 | −6.10754271140052E−06 + | −2.59084065163377E−06 + | −4.96568499560241E−06 + | −8.08213222879635E−06 + | 0.222943141966376 + |
| | 9.14058361761223e−06i | 3.87746704937987e−06i | 7.43167278000013e−06i | 1.20957656682411e−05i | 0.00000000000000i |
| 122 | −5.89418808345345E−06 + | −2.50026627144628E−06 + | −4.8589869682161E−06 + | −8.00067889751989E−06 + | 0.222943141966376 + |
| | 8.97944612650748e−06i | 3.80900744402756e−06i | 7.40237859613088e−06i | 1.21885600049796e−05i | 0.00000000000000i |
| 123 | −5.68711556983935E−06 + | −2.41223322460952E−06 + | −4.77971060591615E−06 + | −7.99507349013048E−06 + | 0.222943141966376 + |
| | 8.82044925377871e−06i | 3.74126048339683e−06i | 7.41310675500063e−06i | 1.23999836356299e−05i | 0.00000000000000i |
| 124 | −5.4857185073839E−06 + | −2.32687282914592E−06 + | −4.67135780695371E−06 + | −7.89525190880586E−06 + | 0.222943141966376 + |
| | 8.66289618241462e−06i | 3.67453374091629e−06i | 7.37688010386843e−06i | 1.24679652315215e−05i | 0.00000000000000i |
| 125 | −5.28993121612483E−06 + | −2.24376971543177E−06 + | −4.5006542639715E−06 + | −7.60115685340157E−06 + | 0.222943141966376 + |
| | 8.50690138270400e−06i | 3.60827521471258e−06i | 7.23764079664176e−06i | 1.22236545437954e−05i | 0.00000000000000i |
| 126 | −5.09975692307587E−06 + | −2.16304364997967E−06 + | −4.27589424029223E−06 + | −7.13800633916804E−06 + | 0.222943141966376 + |
| | 8.35269404488016e−06i | 3.54276528989748e−06i | 7.00332131435958e−06i | 1.16910636998620e−05i | 0.00000000000000i |
| 127 | −4.91474507432859E−06 + | −2.08442531296549E−06 + | −4.03964687998577E−06 + | −6.63429243150497E−06 + | 0.222943141966376 + |
| | 8.19975677765547e−06i | 3.47765353625456e−06i | 6.73974364540624e−06i | 1.10686482223316e−05i | 0.00000000000000i |
| 128 | −4.73500709956754E−06 + | −2.00816483711876E−06 + | −3.84155713331423E−06 + | −6.23980163563571E−06 + | 0.222943141966376 + |
| | 8.04848181302762e−06i | 3.41344328091743e−06i | 6.52981126976685e−06i | 1.06063051068899e−05i | 0.00000000000000i |
| 129 | −4.56032631564973E−06 + | −1.93413022012442E−06 + | −3.70845357911223E−06 + | −6.03553462447952E−06 + | 0.222943141966376 + |
| | 7.89871687779812e−06i | 3.35001180971033e−06i | 6.42323001653385e−06i | 1.04538526204399e−05i | 0.00000000000000i |
| 130 | −4.39038569209389E−06 + | −1.8620146429097E−06 + | −3.62962793034618E−06 + | −5.98935835020857E−06 + | 0.222943141966376 + |
| | 7.75011460148785e−06i | 3.28691552046234e−06i | 6.40718934365007e−06i | 1.05726960815780e−05i | 0.00000000000000i |
| 131 | −4.22522979458867E−06 + | −1.79190555565007E−06 + | −3.56518007313068E−06 + | −5.9811685056778E−06 + | 0.222943141966376 + |
| | 7.60294538941869e−06i | 3.22438322764529e−06i | 6.41524147021946e−06i | 1.07626093075022e−05i | 0.00000000000000i |
| 132 | −4.06467726094049E−06 + | −1.7237547726995E−06 + | −3.47121619812976E−06 + | −5.87883135257348E−06 + | 0.222943141966376 + |
| | 7.45708081333657e−06i | 3.16241064596286e−06i | 6.36831365647371e−06i | 1.07853385815797e−05i | 0.00000000000000i |
| 133 | −3.90873743416044E−06 + | −1.65756193119109E−06 + | −3.32603394139168E−06 + | −5.61708973300842E−06 + | 0.222943141966376 + |
| | 7.31273339556098e−06i | 3.10108025765730e−06i | 6.22257183748915e−06i | 1.05088357476719e−05i | 0.00000000000000i |
| 134 | −3.75697822946891E−06 + | −1.5932360925047E−06 + | −3.14171035889643E−06 + | −5.23247552149358E−06 + | 0.222943141966376 + |
| | 7.16928485350546e−06i | 3.04030598220204e−06i | 5.99519483862593e−06i | 9.98491479358352e−06i | 0.00000000000000i |
| 135 | −3.60984988807525E−06 + | −0.000001530864210462 + | −2.95501932041702E−06 + | −4.8359344072922E−06 + | 0.222943141966376 + |
| | 7.02777909439423e−06i | 2.98033874765367e−06i | 5.75293257266906e−06i | 9.41476232618136e−06i | 0.00000000000000i |
| 136 | −3.46638589648273E−06 + | −1.47010086209645E−06 + | −2.80420069774959E−06 + | −4.54282259666352E−06 + | 0.222943141966376 + |
| | 6.88652601890665e−06i | 2.92058880331220e−06i | 5.57098997167961e−06i | 9.02503845371760e−06i | 0.00000000000000i |
| 137 | −3.32723727331964E−06 + | −1.41100060877389E−06 + | −2.70614210182067E−06 + | −4.40415163148933E−06 + | 0.222943141966376 + |
| | 6.74696975310977e−06i | 2.86122619067997e−06i | 5.48751333576953e−06i | 8.93073604460428e−06i | 0.00000000000000i |
| 138 | −3.19188908506142E−06 + | −1.35357087986952E−06 + | −2.64749107558063E−06 + | −4.37981016526714E−06 + | 0.222943141966376 + |
| | 6.60825768967635e−06i | 2.80233583844996e−06i | 5.48117518883869e−06i | 9.06764409183801e−06i | 0.00000000000000i |
| 139 | −3.0605701236846E−06 + | −1.29804195370373E−06 + | −2.5942046636354E−06 + | −4.36733826504976E−06 + | 0.222943141966376 + |
| | 6.47103183935518e−06i | 2.74447912374357e−06i | 5.48498492038093e−06i | 9.23396093677238e−06i | 0.00000000000000i |
| 140 | −2.93272676068604E−06 + | −1.24371664522127E−06 + | −2.51284940618238E−06 + | −4.26610360210084E−06 + | 0.222943141966376 + |
| | 6.33429516674664e−06i | 2.68626059550781e−06i | 5.42741658094803e−06i | 9.21420972109289e−06i | 0.00000000000000i |
| 141 | −2.80881050478187E−06 + | −1.19105217993008E−06 + | −2.39035632392245E−06 + | −4.03682113381721E−06 + | 0.222943141966376 + |
| | 6.19917688602721e−06i | 2.62870817782566e−06i | 5.27562882843200e−06i | 8.90945409922612e−06i | 0.00000000000000i |
| 142 | −2.68826903097643E−06 + | −1.13990987058611E−06 + | −2.24058809625384E−06 + | −3.72134006329444E−06 + | 0.222943141966376 + |
| | 6.06463775814194e−06i | 2.57159546249669e−06i | 5.05468575221042e−06i | 8.39520866352741e−06i | 0.00000000000000i |
| 143 | −2.57132931899095E−06 + | −1.09034027362702E−06 + | −2.09455455607598E−06 + | −3.41316820352272E−06 + | 0.222943141966376 + |
| | 5.93133764129103e−06i | 2.51511008683428e−06i | 4.83155159801438e−06i | 7.87322451935683e−06i | 0.00000000000000i |
| 144 | −2.45774759567458E−06 + | −1.04212811822378E−06 + | −1.98100261255456E−06 + | −3.19899856278914E−06 + | 0.222943141966376 + |
| | 5.79888207086505e−06i | 2.45882777830554e−06i | 4.67403591504122e−06i | 7.54781143643325e−06i | 0.00000000000000i |
| 145 | −2.34747600149908E−06 + | −9.95375354400714E−07 + | −1.9094497104474E−06 + | −3.10759732265829E−06 + | 0.222943141966376 + |
| | 5.66730840025380e−06i | 2.40304868026464e−06i | 4.60981938763149e−06i | 7.50240360275597e−06i | 0.00000000000000i |
| 146 | −2.24047673901362E−06 + | −9.50039822983919E−07 + | −1.8656000303631E−06 + | −3.09599405393515E−06 + | 0.222943141966376 + |
| | 5.53667828933000e−06i | 2.34774357185897e−06i | 4.61028093031043e−06i | 7.65083732574929e−06i | 0.00000000000000i |
| 147 | −2.1366098908148E−06 + | −9.06010491978336E−07 + | −1.82116208183306E−06 + | −3.0790539161482E−06 + | 0.222943141966376 + |
| | 5.40679682400574e−06i | 2.29270428429593e−06i | 4.60854056811154e−06i | 7.79169796336890e−06i | 0.00000000000000i |
| 148 | −2.03582306639197E−06 + | −8.63221593835029E−07 + | −1.75141118889001E−06 + | −2.98237935696531E−06 + | 0.222943141966376 + |
| | 5.27767284297389e−06i | 2.23781783321387e−06i | 4.54036277567299e−06i | 7.73152775384894e−06i | 0.00000000000000i |
| 149 | −1.93819190412567E−06 + | −8.21802995929199E−07 + | −1.64961607059838E−06 + | −2.78576548920979E−06 + | 0.222943141966376 + |
| | 5.14965235908559e−06i | 2.18347818277885e−06i | 4.38292476170984e−06i | 7.40160135475718e−06i | 0.00000000000000i |
| 150 | −1.84345989790385E−06 + | −7.81609250676243E−07 + | −1.52993897672029E−06 + | −2.53193610702601E−06 + | 0.222943141966376 + |
| | 5.02220777503972e−06i | 2.12936775042051e−06i | 4.16807082863253e−06i | 6.89784964514436e−06i | 0.00000000000000i |
| 151 | −1.75163456436284E−06 + | −7.42685954137005E−07 + | −1.41775966534372E−06 + | −2.29739977261955E−06 + | 0.222943141966376 + |
| | 4.89549065322305e−06i | 2.07566819058076e−06i | 3.96237282102418e−06i | 6.42080222803384e−06i | 0.00000000000000i |
| 152 | −1.66276471663688E−06 + | −7.0506672056723E−07 + | −1.33391525848387E−06 + | −2.14498135977766E−06 + | 0.222943141966376 + |
| | 4.76978340477226e−06i | 2.02254444623558e−06i | 3.82645048913849e−06i | 6.15306326328214e−06i | 0.00000000000000i |
| 153 | −1.57660753427403E−06 + | −6.6851978613695E−07 + | −1.28258557250644E−06 + | −2.08733461966834E−06 + | 0.222943141966376 + |
| | 4.64453602542348e−06i | 1.96939578362203e−06i | 3.77837525680513e−06i | 6.14908950224302e−06i | 0.00000000000000i |
| 154 | −1.49315544548771E−06 + | −6.33145079692906E−07 + | −1.24980675882625E−06 + | −2.08246658611817E−06 + | 0.222943141966376 + |
| | 4.51984604425037e−06i | 1.91655751082597e−06i | 3.78321905601556e−06i | 6.30371632772820e−06i | 0.00000000000000i |
| 155 | −1.41251907419096E−06 + | −5.98863619893189E−07 + | −1.21285227179435E−06 + | −2.06199205410979E−06 + | 0.222943141966376 + |
| | 4.39618638505379e−06i | 1.86384463076102e−06i | 3.77476293366296e−06i | 6.41754264420462e−06i | 0.00000000000000i |
| 156 | −1.33456880817401E−06 + | −5.65724748587273E−07 + | −1.15423685248838E−06 + | −1.9733100133391E−06 + | 0.222943141966376 + |
| | 4.27331172343011e−06i | 1.81146014020340e−06i | 3.69588577460285e−06i | 6.31857178312583e−06i | 0.00000000000000i |
| 157 | −1.25907457396318E−06 + | −5.33854039607113E−07 + | −1.07172888600744E−06 + | −1.80975651224719E−06 + | 0.222943141966376 + |
| | 4.15061262249310e−06i | 1.75988091666399e−06i | 3.53301665692427e−06i | 5.96596768662815e−06i | 0.00000000000000i |
| 158 | −1.18623456112399E−06 + | −5.02932150033725E−07 + | −9.78666815623798E−07 + | −1.61155536170936E−06 + | 0.222943141966376 + |
| | 4.02885665621398e−06i | 1.70812890358087e−06i | 3.32388588526786e−06i | 5.47339097903518e−06i | 0.00000000000000i |
| 159 | −1.11580759806741E−06 + | −4.7313489221172E−07 + | −8.95008163052746E−07 + | −1.43885936690059E−06 + | 0.222943141966376 + |
| | 3.90736501373359e−06i | 1.65683647234633e−06i | 3.13416362227587e−06i | 5.03863637391671e−06i | 0.00000000000000i |
| 160 | −1.04787063470668E−06 + | −4.44266027167126E−07 + | −8.35034100649728E−07 + | −1.33472148975805E−06 + | 0.222943141966376 + |
| | 3.78651792791585e−06i | 1.60537114119089e−06i | 3.01742551780648e−06i | 4.82306372784895e−06i | 0.00000000000000i |
| 161 | −9.82409889742272E−07 + | −4.16483677815491E−07 + | −7.99244658270946E−07 + | −1.30068877393468E−06 + | 0.222943141966376 + |
| | 3.66640362237727e−06i | 1.55433824612431e−06i | 2.98282167234466e−06i | 4.85423658915773e−06i | 0.00000000000000i |
| 162 | −9.19308068965127E−07 + | −3.89715370120625E−07 + | −7.74989578598552E−07 + | −1.29870516118648E−06 + | 0.222943141966376 + |
| | 3.54671923679883e−06i | 1.50353406734938e−06i | 2.98993399441109e−06i | 5.01044506581574e−06i | 0.00000000000000i |
| 163 | −8.58604220547458E−07 + | −3.64058905267158E−07 + | −7.44869145340402E−07 + | −1.27641276784483E−06 + | 0.222943141966376 + |
| | 3.42774019011372e−06i | 1.45340462031274e−06i | 2.97368431782450e−06i | 5.09572540969788e−06i | 0.00000000000000i |
| 164 | −8.00118113582555E−07 + | −3.39205475152303E−07 + | −6.97369025424346E−07 + | −1.19917842440056E−06 + | 0.222943141966376 + |
| | 3.30887111815960e−06i | 1.40277689106852e−06i | 2.88395449091354e−06i | 4.95917638491903e−06i | 0.00000000000000i |
| 165 | −7.43982403457744E−07 + | −3.15404283366161E−07 + | −6.33238990157219E−07 + | −1.06930066075265E−06 + | 0.222943141966376 + |
| | 3.19076651179863e−06i | 1.35269519865881e−06i | 2.71581391491431e−06i | 4.58598042576877e−06i | 0.00000000000000i |
| 166 | −6.90023790827521E−07 + | −2.92541930308927E−07 + | −5.64118980042497E−07 + | −9.2186927887136E−07 + | 0.222943141966376 + |
| | 3.07281548021676e−06i | 1.30274837477923e−06i | 2.51213589675851e−06i | 4.10527032328990e−06i | 0.00000000000000i |
| 167 | −6.38244736574881E−07 + | −2.70590627325296E−07 + | −5.04795489385566E−07 + | −8.01444638081832E−07 + | 0.222943141966376 + |
| | 2.95511995311527e−06i | 1.25285445553257e−06i | 2.33724014855278e−06i | 3.71074746973542e−06i | 0.00000000000000i |
| 168 | −5.88734833346332E−07 + | −2.49640570998249E−07 + | −4.64178277787079E−07 + | −7.34886175981203E−07 + | 0.222943141966376 + |
| | 2.83821529208465e−06i | 1.20348524666867e−06i | 2.23774407704346e−06i | 3.54279221217755e−06i | 0.00000000000000i |
| 169 | −5.41375346190713E−07 + | −2.29532386125348E−07 + | −4.40476495856053E−07 + | −7.16829307704285E−07 + | 0.222943141966376 + |
| | 2.72167765802347e−06i | 1.15393722952926e−06i | 2.21442488297034e−06i | 3.60374428773486e−06i | 0.00000000000000i |
| 170 | −4.96119872199518E−07 + | −2.10378715110723E−07 + | −4.23126070124477E−07 + | −7.15493013007467E−07 + | 0.222943141966376 + |
| | 2.60538333990552e−06i | 1.10480799124466e−06i | 2.22205494187960e−06i | 3.75742573593958e−06i | 0.00000000000000i |
| 171 | −4.53037340898521E−07 + | −1.92025730135952E−07 + | −3.99779059224068E−07 + | −6.93728462609332E−07 + | 0.222943141966376 + |
| | 2.48981562518766e−06i | 1.05534052090201e−06i | 2.19711723166962e−06i | 3.81261280234186e−06i | 0.00000000000000i |
| 172 | −4.11975891031146E−07 + | −1.74654964922512E−07 + | −3.63764398869384E−07 + | −6.31483580755008E−07 + | 0.222943141966376 + |
| | 2.37427556271154e−06i | 1.00656136472442e−06i | 2.09642588708976e−06i | 3.63932954979301e−06i | 0.00000000000000i |
| 173 | −3.72986526724463E−07 + | −1.58110377403591E−07 + | −3.17518756090172E−07 + | −5.36129649915732E−07 + | 0.222943141966376 + |
| | 2.25914607620257e−06i | 9.57660433078739e−07i | 1.92318274400184e−06i | 3.24728940097745e−06i | 0.00000000000000i |
| 174 | −3.36010924272948E−07 + | −1.42471536289746E−07 + | −2.70282456966232E−07 + | −4.35518281900452E−07 + | 0.222943141966376 + |
| | 2.14419061430343e−06i | 9.09155354329416e−07i | 1.72475674322640e−06i | 2.77917813067735e−06i | 0.00000000000000i |
| 175 | −3.01074572697089E−07 + | −1.27614802162335E−07 + | −2.31952472782056E−07 + | −3.59469047948798E−07 + | 0.222943141966376 + |
| | 2.02967990232451e−06i | 8.60309114982991e−07i | 1.56369655557823e−06i | 2.42334347796607e−06i | 0.00000000000000i |
| 176 | −2.68145683889405E−07 + | −1.1367453137276E−07 + | −2.07134725791917E−07 + | −3.2186161289944E−07 + | 0.222943141966376 + |
| | 1.91553580482864e−06i | 8.12049747673287e−07i | 1.47969558160126e−06i | 2.29926297811347e−06i | 0.00000000000000i |
| 177 | 2.37125838234771E−07 + | −1.00544784922173E−07 + | −1.92951890898737E−07 + | −3.14039997681194E−07 + | 0.222943141966376 + |
| | 1.80114956100722e−06i | 7.63713463584662e−07i | 1.46561511885315e−06i | 2.38537060394721e−06i | 0.00000000000000i |
| 178 | −2.08160532842937E−07 + | −8.8216607275242E−08 + | −1.8155791302135E−07 + | −3.1239039969463E−07 + | 0.222943141966376 + |
| | 1.68772101306071e−06i | 7.15241356103610e−07i | 1.47203266973889e−06i | 2.53279444784885e−06i | 0.00000000000000i |
| 179 | −1.81091168395491E−07 + | −7.67795144360951E−08 + | −1.65362043832373E−07 + | −2.94075254798165E−07 + | 0.222943141966376 + |
| | 1.57414818999727e−06i | 6.67411529510811e−07i | 1.43742162745188e−06i | 2.55627060206043e−06i | 0.00000000000000i |
| 180 | −1.55927087299093E−07 + | −6.6129690414233E−08 + | −1.41513487547817E−07 + | −2.50536302883538E−07 + | 0.222943141966376 + |
| | 1.46055430200086e−06i | 6.19430565257459e−07i | 1.32554347424212e−06i | 2.34674989010010e−06i | 0.00000000000000i |
| 181 | −1.32732949506698E−07 + | −5.6269988339859E−08 + | −1.13003174876422E−07 + | −1.9080727710988E−07 + | 0.222943141966376 + |
| | 1.34766025240760e−06i | 5.71318779379897e−07i | 1.14734048886115e−06i | 1.93729879569166e−06i | 0.00000000000000i |
| 182 | −1.11418825964121E−07 + | −4.72260529072767E−08 + | −8.60961407342072E−08 + | −1.33776226133227E−07 + | 0.222943141966376 + |
| | 1.23473169674604e−06i | 5.23354145341095e−07i | 9.54108365568818e−07i | 1.48249405116128e−06i | 0.00000000000000i |
| 183 | −9.19851264979058E−08 + | −3.89843362828231E−08 + | −6.61043842911325E−08 + | −9.54528948608684E−08 + | 0.222943141966376 + |
| | 1.12183374035927e−06i | 4.75445818833531e−07i | 8.06196952782833e−07i | 1.16412600762974e−06i | 0.00000000000000i |
| 184 | −7.44533528872852E−08 + | −3.15671243482247E−08 + | −5.4313972845716E−08 + | −7.97158732005413E−08 + | 0.222943141966376 + |
| | 1.00933947911355e−06i | 4.27945063644228e−07i | 7.36316565106593e−07i | 1.08068172634418e−06i | 0.00000000000000i |
| 185 | −5.87803181085686E−08 + | −2.49092575243965E−08 + | −4.78295442358015E−08 + | −7.78482675002793E−08 + | 0.222943141966376 + |
| | 8.96814351611151e−07i | 3.80041829566623e−07i | 7.29737828640334e−07i | 1.18773504108988e−06i | 0.00000000000000i |
| 186 | −4.49713245478182E−08 + | −1.90496613273247E−08 + | −4.20442663923564E−08 + | −7.59803701838938E−08 + | 0.222943141966376 + |
| | 7.84411302390035e−07i | 3.32273283088253e−07i | 7.33356157326192e−07i | 1.32528587345829e−06i | 0.00000000000000i |
| 187 | −3.30161743402011E−08 + | −1.39923873198414E−08 + | −3.38013872801535E−08 + | −6.46131575885005E−08 + | 0.222943141966376 + |
| | 6.72059668002618e−07i | 2.84821587086837e−07i | 6.88043044459219e−07i | 1.31523103744163e−06i | 0.00000000000000i |
| 188 | −2.29229189305004E−08 + | −9.72379840969567E−09 + | −2.31079490669676E−08 + | −4.37786653476856E−08 + | 0.222943141966376 + |
| | 5.60065646082157e−07i | 2.37577310979395e−07i | 5.64586406413697e−07i | 1.06962497082469e−06i | 0.00000000000000i |
| 189 | −1.46610133816213E−08 + | −6.21442744254871E−09 + | −1.24852955905054E−08 + | −2.10812523300287E−08 + | 0.222943141966376 + |
| | 4.47847629840494e−07i | 1.89831120649321e−07i | 3.81386326597340e−07i | 6.43965641646727e−07i | 0.00000000000000i |
| 190 | −8.24783720805809E−09 + | −3.4913246686058E−09 + | −4.74255794647345E−09 + | −4.98919864218757E−09 + | 0.222943141966376 + |
| | 3.35979639412973e−07i | 1.42220799781647e−07i | 1.93190392716118e−07i | 2.03237420843906e−07i | 0.00000000000000i |
| 191 | −3.666890417466E−09 + | −1.55270637204145E−09 + | −9.45094082854814E−10 + | 1.28514447752618E−09 − | 0.222943141966376 + |
| | 2.24083834299654e−07i | 9.48859545703205e−08i | 5.77547408757479e−08i | 7.85352353993494e−08i | 0.00000000000000i |
| 192 | −9.13758314384043E−10 + | −3.89663632379319E−10 + | −5.83136953076953E−12 + | 1.01549318491193E−09 − | 0.222943141966376 + |
| | 1.11687096939760e−07i | 4.76279111716428e−08i | 7.12758018766325e−10i | 1.24121974510566e−07i | 0.00000000000000i |
| 193 | 0 + 0.00000000000000i | 0 + 0.00000000000000i | 0 + 0.00000000000000i | 0 + 0.00000000000000i | 0.222943141966376 + |
| | | | | | 0.00000000000000i |
| 194 | −9.13758319009972E−10 − | −3.89663630066354E−10 − | −5.83136779604606E−12 − | 1.01549318491193E−09 + | 0.222943141966376 + |
| | 1.11687096940121e−07i | 4.76279111720403e−08i | 7.12758018513345e−10i | 1.24121974510246e−07i | 0.00000000000000i |
| 195 | −3.666890417466E−09 − | −1.552706368572E−09 − | −9.45094081698332E−10 − | 1.28514447810442E−09 + | 0.222943141966376 + |
| | 2.24083834299767e−07i | 9.48859545703386e−08i | 5.77547408758202e−08i | 7.85352353997650e−08i | 0.00000000000000i |
| 196 | −8.24783720719073E−09 − | −3.49132466802756E−09 − | −4.74255794589521E−09 − | −4.98919864218757E−09 − | 0.222943141966376 + |
| | 3.35979639413100e−07i | 1.42220799781665e−07i | 1.93190392715847e−07i | 2.03237420844466e−07i | 0.00000000000000i |
| 197 | −1.46610133801757E−08 − | −6.21442744254871E−09 − | −1.24852955902162E−08 − | −2.1081252330607E−08 − | 0.222943141966376 + |
| | 4.47847629840602e−07i | 1.89831120649565e−07i | 3.81386326597195e−07i | 6.43965641647305e−07i | 0.00000000000000i |
| 198 | −2.29229189299222E−08 − | −9.72379840882831E−09 − | −2.31079490669676E−08 − | −4.37786653479747E−08 − | 0.222943141966376 + |
| | 5.60065646082139e−07i | 2.37577310979160e−07i | 5.64586406413670e−07i | 1.06962497082458e−06i | 0.00000000000000i |
| 199 | −3.30161743402011E−08 − | −1.3992387319986E−08 − | −3.38013872802981E−08 − | −6.46131575885005E−08 − | 0.222943141966376 + |
| | 6.72059668002555e−07i | 2.84821587086819e−07i | 6.88043044459011e−07i | 1.31523103744159e−06i | 0.00000000000000i |
| 200 | −4.49713245476736E−08 − | −1.90496613271078E−08 − | −4.20442663922119E−08 − | −7.59803701837131E−08 − | 0.222943141966376 + |
| | 7.84411302389954e−07i | 3.32273283088077e−07i | 7.33356157326029e−07i | 1.32528587345850e−06i | 0.00000000000000i |
| 201 | 5.87803181082795E−08 − | −2.49092575243965E−08 − | −4.78295442360906E−08 − | −7.784826750046E−08 − | 0.222943141966376 + |
| | 8.96814351611115e−07i | 3.80041829566469e−07i | 7.29737828640347e−07i | 1.18773504108983e−06i | 0.00000000000000i |
| 202 | −7.44533528872852E−08 − | −3.15671243481524E−08 − | −5.43139728457522E−08 − | −7.97158732006136E−08 − | 0.222943141966376 + |
| | 1.00933947911362e−06i | 4.27945063644259e−07i | 7.36316565106663e−07i | 1.08068172634415e−06i | 0.00000000000000i |
| 203 | −9.19851264978335E−08 − | 3.89843362824255E−08 − | −6.61043842909518E−08 − | −9.54528948608063E−08 − | 0.222943141966376 + |
| | 1.12183374035925e−06i | 4.75445818833585e−07i | 8.06196952782891e−07i | 1.16412600763019e−06i | 0.00000000000000i |
| 204 | −1.11418825963471E−07 − | −4.72260529071321E−08 − | −8.60961407342433E−08 − | −1.33776226132884E−07 − | 0.222943141966376 + |
| | 1.23473169674542e−06i | 5.23354145341181e−07i | 9.54108365568838e−07i | 1.48249405116057e−06i | 0.00000000000000i |
| 205 | −1.32732949506698E−07 − | −5.62699883399313E−08 − | −1.13003174876458E−07 − | −1.90807277109844E−07 − | 0.222943141966376 + |
| | 1.34766025240760e−06i | 5.71318779379901e−07i | 1.14734048886115e−06i | 1.93729879569169e−06i | 0.00000000000000i |
| 206 | −1.55927087299382E−07 − | −6.61296904139981E−08 − | −1.41513487547781E−07 − | −2.50536302884008E−07 − | 0.222943141966376 + |
| | 1.46055430200127e−06i | 6.19430565257323e−07i | 1.32554347424213e−06i | 2.34674989010086e−06i | 0.00000000000000i |
| 207 | −1.81091168395455E−07 − | −7.6779514436077E−08 − | −1.65362043832373E−07 − | −2.94075254797984E−07 − | 0.222943141966376 + |
| | 1.57414818999699e−06i | 6.67411529511079e−07i | 1.43742162745184e−06i | 2.55627060206025e−06i | 0.00000000000000i |
| 208 | −2.08160532842901E−07 − | −8.82166072752781E−08 − | −1.81557913021332E−07 − | −3.12390399694557E−07 − | 0.222943141966376 + |
| | 1.68772101306073e−06i | 7.15241356103646e−07i | 1.47203266973891e−06i | 2.53279444784886e−06i | 0.00000000000000i |
| 209 | −2.37125838234735E−07 − | −1.00544784922164E−07 − | −1.92951890898484E−07 − | −3.14039997681411E−07 − | 0.222943141966376 + |
| | 1.80114956100736e−06i | 7.63713463584830e−07i | 1.46561511885335e−06i | 2.38537060394786e−06i | 0.00000000000000i |
| 210 | −2.68145683889676E−07 − | −1.13674531372715E−07 − | −2.07134725791908E−07 − | −3.21861612899259E−07 − | 0.222943141966376 + |
| | 1.91553580482831e−06i | 8.12049747673741e−07i | 1.47969558160135e−06i | 2.29926297811339e−06i | 0.00000000000000i |
| 211 | −3.01074572697053E−07 − | −1.27614802162389E−07 − | −2.3195247278202E−07 − | −3.59469047948753E−07 − | 0.222943141966376 + |
| | 2.02967990232467e−06i | 8.60309114983119e−07i | 1.56369655557842e−06i | 2.42334347796614e−06i | 0.00000000000000i |
| 212 | −3.36010924272966E−07 − | −1.42471536289881E−07 − | −2.70282456965898E−07 − | −4.35518281900561E−07 − | 0.222943141966376 + |
| | 2.14419061430382e−06i | 9.09155354329477e−07i | 1.72475674322663e−06i | 2.77917813067773e−06i | 0.00000000000000i |
| 213 | −3.72986526724644E−07 − | −1.58110377403789E−07 − | −3.17518756090316E−07 − | −5.36129649916039E−07 − | 0.222943141966376 + |
| | 2.25914607620218e−06i | 9.57660433078914e−07i | 1.92318274400172e−06i | 3.24728940097738e−06i | 0.00000000000000i |
| 214 | −4.11975891031037E−07 − | −1.74654964922568E−07 − | −3.63764398869655E−07 − | −6.31483580754647E−07 − | 0.222943141966376 + |
| | 2.37427556271140e−06i | 1.00656136472454e−06i | 2.09642588709012e−06i | 3.63932954979317e−06i | 0.00000000000000i |
| 215 | −4.53037340898435E−07 − | −1.92025730135277E−07 − | −3.99779059223991E−07 − | −6.93728462609928E−07 − | 0.222943141966376 + |
| | 2.48981562518760e−06i | 1.05534052090270e−06i | 2.19711723167027e−06i | 3.81261280234172e−06i | 0.00000000000000i |
| 216 | −4.96119872198253E−07 − | −2.10378715111336E−07 − | −4.23126070124222E−07 − | −7.15493013006884E−07 − | 0.222943141966376 + |
| | 2.60538333990328e−06i | 1.10480799124451e−06i | 2.22205494187866e−06i | 3.75742573594026e−06i | 0.00000000000000i |
| 217 | −5.41375346190713E−07 − | −2.29532386125348E−07 − | −4.40476495856053E−07 − | −7.16829307704285E−07 − | 0.222943141966376 + |
| | 2.72167765802347e−06i | 1.15393722952926e−06i | 2.21442488297034e−06i | 3.60374428773486e−06i | 0.00000000000000i |
| 218 | −5.88734833346124E−07 − | −2.49640570997286E−07 − | −4.64178277786634E−07 − | −7.34886175981181E−07 − | 0.222943141966376 + |
| | 2.83821529208622e−06i | 1.20348524666997e−06i | 2.23774407704441e−06i | 3.54279221217767e−06i | 0.00000000000000i |
| 219 | −6.38244736574416E−07 − | −2.70590627325673E−07 − | −5.04795489385137E−07 − | −8.01444638080206E−07 − | 0.222943141966376 + |
| | 2.95511995311497e−06i | 1.25285445553250e−06i | 2.33724014855278e−06i | 3.71074746973556e−06i | 0.00000000000000i |
| 220 | −6.90023790827729E−07 − | −2.92541930309033E−07 − | −5.64118980042226E−07 − | −9.21869278871695E−07 − | 0.222943141966376 + |
| | 3.07281548021676e−06i | 1.30274837477922e−06i | 2.51213589675843e−06i | 4.10527032329015e−06i | 0.00000000000000i |
| 221 | −7.43982403457943E−07 − | −3.15404283365998E−07 − | −6.33238990157915E−07 − | −1.06930066075317E−06 − | 0.222943141966376 + |
| | 3.19076651179885e−06i | 1.35269519865946e−06i | 2.71581391491494e−06i | 4.58598042576886e−06i | 0.00000000000000i |
| 222 | −8.00118113582067E−07 − | −3.3920547515219E−07 − | −6.97369025424599E−07 − | −1.19917842440012E−06 − | 0.222943141966376 + |
| | 3.30887111815989e−06i | 1.40277689106819e−06i | 2.88395449091337e−06i | 4.95917638491890e−06i | 0.00000000000000i |
| 223 | −8.58604220547467E−07 − | −3.64058905267133E−07 − | −7.44869145340484E−07 − | −1.27641276784488E−06 − | 0.222943141966376 + |
| | 3.42774019011370e−06i | 1.45340462031281e−06i | 2.97368431782447e−06i | 5.09572540969782e−06i | 0.00000000000000i |
| 224 | −9.19308068965263E−07 − | −3.89715370120643E−07 − | −7.7498957859857E−07 − | −1.29870516118677E−06 − | 0.222943141966376 + |
| | 3.54671923679830e−06i | 1.50353406734963e−06i | 2.98993399441112e−06i | 5.01044506581551e−06i | 0.00000000000000i |
| 225 | −9.82409889742403E−07 − | −4.164836778155E−07 − | −7.99244658271004E−07 − | −1.30068877393504E−06 − | 0.222943141966376 + |
| | 3.66640362237715e−06i | 1.55433824612431e−06i | 2.98282167234459e−06i | 4.85423658915779e−06i | 0.00000000000000i |
| 226 | −1.0478706347067E−06 − | −4.44266027167144E−07 − | −8.35034100649759E−07 − | −1.33472148975803E−06 − | 0.222943141966376 + |
| | 3.78651792791586e−06i | 1.60537114119087e−06i | 3.01742551780648e−06i | 4.82306372784899e−06i | 0.00000000000000i |
| 227 | −1.11580759806704E−06 − | −4.73134892211932E−07 − | −8.95008163052805E−07 − | −1.43885936690054E−06 − | 0.222943141966376 + |
| | 3.90736501373391e−06i | 1.65683647234677e−06i | 3.13416362227583e−06i | 5.03863637391651e−06i | 0.00000000000000i |
| 228 | −1.18623456112424E−06 − | −5.02932150034107E−07 − | −9.78666815623952E−07 − | −1.61155536170967E−06 − | 0.222943141966376 + |
| | 4.02885665621356e−06i | 1.70812890358047e−06i | 3.32388588526770e−06i | 5.47339097903487e−06i | 0.00000000000000i |
| 229 | −1.25907457396316E−06 − | −5.3385403960709E−07 − | −1.07172888600749E−06 − | −1.80975651224731E−06 − | 0.222943141966376 + |
| | 4.15061262249311e−06i | 1.75988091666398e−06i | 3.53301665692423e−06i | 5.96596768662814e−06i | 0.00000000000000i |
| 230 | −1.3345688081732E−06 − | −5.6572474858743E−07 − | −1.1542368524885E−06 − | −1.97331001333882E−06 − | 0.222943141966376 + |
| | 4.27331172343004e−06i | 1.81146014020377e−06i | 3.69588577460297e−06i | 6.31857178312629e−06i | 0.00000000000000i |
| 231 | −1.41251907419094E−06 − | −5.98863619893175E−07 − | −1.21285227179426E−06 − | −2.06199205411004E−06 − | 0.222943141966376 + |
| | 4.39618638505353e−06i | 1.86384463076098e−06i | 3.77476293366299e−06i | 6.41754264420478e−06i | 0.00000000000000i |
| 232 | −1.49315544548763E−06 − | −6.33145079693007E−07 − | −1.24980675882634E−06 − | −2.08246658611816E−06 − | 0.222943141966376 + |
| | 4.51984604425037e−06i | 1.91655751082597e−06i | 3.78321905601554e−06i | 6.30371632772821e−06i | 0.00000000000000i |
| 233 | −0.000001576607534274 − | −6.68519786137129E−07 − | −1.28258557250659E−06 − | −2.08733461966839E−06 − | 0.222943141966376 + |
| | 4.64453602542376e−06i | 1.96939578362259e−06i | 3.778375256805 16e−06i | 6.14908950224291e−06i | 0.00000000000000i |
| 234 | −1.66276471663688E−06 − | −7.05066720567083E−07 − | −1.33391525848379E−06 − | −2.14498135977755E−06 − | 0.222943141966376 + |
| | 4.76978340477233e−06i | 2.02254444623578e−06i | 3.82645048913854e−06i | 6.15306326328215e−06i | 0.00000000000000i |
| 235 | −1.75163456436293E−06 − | −7.42685954137143E−07 − | −1.41775966534388E−06 − | −2.29739977261959E−06 − | 0.222943141966376 + |
| | 4.89549065322320e−06i | 2.07566819058070e−06i | 3.96237282102408e−06i | 6.42080222803388e−06i | 0.00000000000000i |
| 236 | −1.84345989790412E−06 − | −7.81609250676575E−07 − | −1.52993897671999E−06 − | −2.53193610702616E−06 − | 0.222943141966376 + |
| | 5.02220777503961e−06i | 2.12936775042068e−06i | 4.16807082863257e−06i | 6.89784964514455e−06i | 0.00000000000000i |
| 237 | −1.93819190412534E−06 − | −8.21802995929396E−07 − | −1.64961607059816E−06 − | −2.78576548921015E−06 − | 0.222943141966376 + |
| | 5.14965235908486e−06i | 2.18347818277954e−06i | 4.38292476170931e−06i | 7.40160135475720e−06i | 0.00000000000000i |
| 238 | −2.0358230663923E−06 − | −8.63221593834391E−07 − | −1.7514111888903E−06 − | −2.98237935696573E−06 − | 0.222943141966376 + |
| | 5.27767284297390e−06i | 2.23781783321330e−06i | 4.54036277567313e−06i | 7.73152775384886e−06i | 0.00000000000000i |
| 239 | −2.13660989081474E−06 − | −9.06010491978406E−07 − | −1.82116208183314E−06 − | −3.07905391614833E−06 − | 0.222943141966376 + |
| | 5.40679682400545e−06i | 2.29270428429578e−06i | 4.60854056811209e−06i | 7.79169796336946e−06i | 0.00000000000000i |
| 240 | −2.24047673900996E−06 − | −9.5003982298475E−07 − | −1.86560003036182E−06 − | −3.09599405393564E−06 − | 0.222943141966376 + |
| | 5.53667828932838e−06i | 2.34774357185898e−06i | 4.61028093031062e−06i | 7.65083732575070e−06i | 0.00000000000000i |
| 241 | −2.34747600149908E−06 − | −9.95375354400714E−07 − | −1.9094497104474E−06 − | −3.10759732265829E−06 − | 0.222943141966376 + |
| | 5.66730840025380e−06i | 2.40304868026464e−06i | 4.60981938763149e−06i | 7.50240360275597e−06i | 0.00000000000000i |
| 242 | −2.45774759567256E−06 − | −1.04212811822447E−06 − | −1.98100261255447E−06 − | −3.19899856278892E−06 − | 0.222943141966376 + |
| | 5.79888207086657e−06i | 2.45882777830546e−06i | 4.67403591504125e−06i | 7.54781143643228e−06i | 0.00000000000000i |
| 243 | −2.57132931899137E−06 − | −1.09034027362747E−06 − | −2.09455455607664E−06 − | −3.41316820352236E−06 − | 0.222943141966376 + |
| | 5.93133764129175e−06i | 2.51511008683532e−06i | 4.83155159801475e−06i | 7.87322451935820e−06i | 0.00000000000000i |
| 244 | −2.68826903097613E−06 − | −1.13990987058583E−06 − | −2.24058809625394E−06 − | −3.72134006329339E−06 − | 0.222943141966376 + |
| | 6.06463775814189e−06i | 2.57159546249733e−06i | 5.05468575221078e−06i | 8.39520866352668e−06i | 0.00000000000000i |
| 245 | −2.80881050478164E−06 − | −1.19105217993041E−06 − | −2.39035632392218E−06 − | −4.03682113381713E−06 − | 0.222943141966376 + |
| | 6.19917688602730e−06i | 2.62870817782516e−06i | 5.27562882843171e−06i | 8.90945409922588e−06i | 0.00000000000000i |
| 246 | −2.93272676068601E−06 − | −1.24371664522103E−06 − | −2.51284940618256E−06 − | −4.2661036021006E−06 − | 0.222943141966376 + |
| | 6.33429516674655e−06i | 2.68626059550781e−06i | 5.42741658094879e−06i | 9.21420972109347e−06i | 0.00000000000000i |
| 247 | −3.06057012368457E−06 − | −1.29804195370362E−06 − | −2.59420466363536E−06 − | −4.36733826504973E−06 − | 0.222943141966376 + |
| | 6.47103183935485e−06i | 2.74447912374345e−06i | 5.48498492038097e−06i | 9.23396093677228e−06i | 0.00000000000000i |
| 248 | −3.19188908506086E−06 − | −1.35357087986936E−06 − | −2.64749107558056E−06 − | −4.37981016526727E−06 − | 0.222943141966376 + |
| | 6.60825768967591e−06i | 2.80233583845010e−06i | 5.48117518883866e−06i | 9.06764409183786e−06i | 0.00000000000000i |
| 249 | −3.32723727331963E−06 − | −1.41100060877443E−06 − | −2.70614210182059E−06 − | −4.4041516314894E−06 − | 0.222943141966376 + |
| | 6.74696975310985e−06i | 2.86122619067990e−06i | 5.48751333576957e−06i | 8.93073604460428e−06i | 0.00000000000000i |
| 250 | −3.46638589648287E−06 − | −1.47010086209648E−06 − | −2.80420069774954E−06 − | −4.54282259666351E−06 − | 0.222943141966376 + |
| | 6.88652601890666e−06i | 2.92058880331223e−06i | 5.57098997167965e−06i | 9.02503845371758e−06i | 0.00000000000000i |
| 251 | −3.60984988807534E−06 − | −1.53086421046197E−06 − | −2.95501932041684E−06 − | −4.83593440729229E−06 − | 0.222943141966376 + |
| | 7.02777909439451e−06i | 2.98033874765338e−06i | 5.75293257266920e−06i | 9.41476232618155e−06i | 0.00000000000000i |
| 252 | −3.75697822946873E−06 − | −1.59323609250527E−06 − | −3.14171035889639E−06 − | −5.23247552149335E−06 − | 0.222943141966376 + |
| | 7.16928485350488e−06i | 3.04030598220187e−06i | 5.99519483862579e−06i | 9.98491479358339e−06i | 0.00000000000000i |
| 253 | −3.90873743416045E−06 − | −1.65756193119108E−06 − | −3.32603394139171E−06 − | −5.6170897330084E−06 − | 0.222943141966376 + |
| | 7.31273339556093e−06i | 3.10108025765729e−06i | 6.22257183748917e−06i | 1.05088357476719e−05i | 0.00000000000000i |
| 254 | −4.06467726094038E−06 − | −1.72375477269973E−06 − | −3.47121619812964E−06 − | −5.87883135257373E−06 − | 0.222943141966376 + |
| | 7.45708081333788e−06i | 3.16241064596268e−06i | 6.36831365647398e−06i | 1.07853385815802e−05i | 0.00000000000000i |
| 255 | −4.22522979458862E−06 − | −1.79190555564997E−06 − | −3.56518007313084E−06 − | −5.98116850567819E−06 − | 0.222943141966376 + |
| | 7.60294538941857e−06i | 3.22438322764580e−06i | 6.41524147021933e−06i | 1.07626093075021e−05i | 0.00000000000000i |
| 256 | −4.39038569209384E−06 − | −1.8620146429097E−06 − | −3.62962793034617E−06 − | −5.98935835020857E−06 − | 0.222943141966376 + |
| | 7.75011460148784e−06i | 3.28691552046233e−06i | 6.40718934365007e−06i | 1.05726960815781e−05i | 0.00000000000000i |
| 257 | −4.56032631564953E−06 − | −1.93413022012481E−06 − | −3.7084535791121E−06 − | −6.03553462447944E−06 − | 0.222943141966376 + |
| | 7.89871687779827e−06i | 3.35001180971053e−06i | 6.42323001653404e−06i | 1.04538526204402e−05i | 0.00000000000000i |
| 258 | −4.73500709956752E−06 − | −2.0081648371186E−06 − | −3.84155713331437E−06 − | −6.23980163563601E−06 − | 0.222943141966376 + |
| | 8.04848181302762e−06i | 3.41344328091782e−06i | 6.52981126976660e−06i | 1.06063051068901e−05i | 0.00000000000000i |
| 259 | −4.91474507432876E−06 − | −2.08442531296557E−06 − | −4.03964687998592E−06 − | −6.63429243150508E−06 − | 0.222943141966376 + |
| | 8.19975677765547e−06i | 3.47765353625457e−06i | 6.73974364540631e−06i | 1.10686482223317e−05i | 0.00000000000000i |
| 260 | −5.09975692307538E−06 − | −2.16304364997998E−06 − | −4.27589424029192E−06 − | −7.13800633916729E−06 − | 0.222943141966376 + |
| | 8.35269404488054e−06i | 3.54276528989736e−06i | 7.00332131435928e−06i | 1.16910636998623e−05i | 0.00000000000000i |
| 261 | −5.28993121612486E−06 − | −2.24376971543151E−06 − | −4.50065426397124E−06 − | −7.60115685340124E−06 − | 0.222943141966376 + |
| | 8.50690138270382e−06i | 3.60827521471192e−06i | 7.23764079664138e−06i | 1.22236545437951e−05i | 0.00000000000000i |
| 262 | −5.48571850738394E−06 − | −2.32687282914536E−06 − | −4.67135780695345E−06 − | −7.89525190880559E−06 − | 0.222943141966376 + |
| | 8.66289618241448e−06i | 3.67453374091639e−06i | 7.37688010386803e−06i | 1.24679652315212e−05i | 0.00000000000000i |
| 263 | −5.68711556983977E−06 − | −2.41223322460985E−06 − | −4.7797106059169E−06 − | −7.99507349013129E−06 − | 0.222943141966376 + |
| | 8.82044925377844e−06i | 3.74126048339523e−06i | 7.41310675500008e−06i | 1.23999836356307e−05i | 0.00000000000000i |
| 264 | −5.8941880834504E−06 − | −2.50026627144455E−06 − | −4.85898696821519E−06 − | −0.000008000678897519 − | 0.222943141966376 + |
| | 8.97944612650498e−06i | 3.80900744402590e−06i | 7.40237859613020e−06i | 1.21885600049786e−05i | 0.00000000000000i |
| 265 | −6.10754271140052E−06 − | −2.59084065163377E−06 − | −4.96568499560241E−06 − | −8.08213222879635E−06 − | 0.222943141966376 + |
| | 9.14058361761223e−06i | 3.87746704937987e−06i | 7.43167278000013e−06i | 1.20957656682411e−05i | 0.00000000000000i |
| 266 | −6.32694816253483E−06 − | −2.6839743308267E−06 − | −5.1455480090056E−06 − | −8.37710419155537E−06 − | 0.222943141966376 + |
| | 9.30327118889381e−06i | 3.94656956596883e−06i | 7.56611676174665e−06i | 1.23178616403318e−05i | 0.00000000000000i |
| 267 | −6.55269530486844E−06 − | −2.77969093680459E−06 − | −5.40433930750844E−06 − | −8.90277854730747E−06 − | 0.222943141966376 + |
| | 9.46770640797855e−06i | 4.01625536823576e−06i | 7.80849642963808e−06i | 1.28632401751527e−05i | 0.00000000000000i |
| 268 | −6.78507934132367E−06 − | −2.87840114279653E−06 − | −0.000005701970097583 − | −9.53813066471864E−06 − | 0.222943141966376 + |
| | 9.63407243623177e−06i | 4.08701559925878e−06i | 8.09617547355312e−06i | 1.35431049671715e−05i | 0.00000000000000i |
| 269 | −7.02416522350536E−06 − | −2.97975571578703E−06 − | −0.000005975035551423 − | −1.00918300675106E−05 − | 0.222943141966376 + |
| | 9.80221121709978e−06i | 4.15824428556668e−06i | 8.33815245529168e−06i | 1.40831325490214e−05i | 0.00000000000000i |
| 270 | −7.27045378635652E−06 − | −3.08464350752785E−06 − | −6.17530926852012E−06 − | −1.04182587604603E−05 − | 0.222943141966376 + |
| | 9.97256565068939e−06i | 4.23107151104399e−06i | 8.47040348557300e−06i | 1.42902730018788e−05i | 0.00000000000000i |
| 271 | −7.52414032462037E−06 − | −3.19206642766922E−06 − | −6.30101237669098E−06 − | −1.05117719697847E−05 − | 0.222943141966376 + |
| | 1.01451288109277e−05i | 4.30400333918908e−06i | 8.49593168691578e−06i | 1.41734837554195e−05i | 0.00000000000000i |
| 272 | −7.78517620526532E−06 − | −3.30292535620171E−06 − | −6.40082869670506E−06 − | −1.05188219831869E−05 − | 0.222943141966376 + |
| | 1.03 195624095141e−05i | 4.37815965221488e−06i | 8.48455442326185e−06i | 1.39431192137535e−05i | 0.00000000000000i |
| 273 | −8.0538442743835E−06 − | −3.41724295536166E−06 − | −6.54652404966284E−06 − | −1.06554415418168E−05 − | 0.222943141966376 + |
| | 1.04959742072863e−05i | 4.45343772458967e−06i | 8.53159624543639e−06i | 1.38864417761215e−05i | 0.00000000000000i |
| 274 | −8.33056987281468E−06 − | −3.53458419177281E−06 − | −6.78945210803642E−06 − | −0.000011076136975829 − | 0.222943141966376 + |
| | 1.06746387862306e−05i | 4.52915107642694e−06i | 8.69987886977825e−06i | 1.41927578987889e−05i | 0.00000000000000i |
| 275 | −8.61569655314124E−06 − | −3.65589422053863E−06 − | −7.12724066463955E−06 − | −1.17734492633357E−05 − | 0.222943141966376 + |
| | 1.08557004168161e−05i | 4.60639394260577e−06i | 8.98025934138161e−06i | 1.48344405222514e−05i | 0.00000000000000i |
| 276 | −8.90962061444408E−06 − | −3.78050221030249E−06 − | −7.50215594870066E−06 − | −1.25730013430629E−05 − | 0.222943141966376 + |
| | 1.10393495909774e−05i | 4.68418211447769e−06i | 9.29544879492007e−06i | 1.55784138562404e−05i | 0.00000000000000i |
| 277 | −9.21195818968696E−06 − | −3.9090484498346E−06 − | −7.83409428361484E−06 − | −1.32329443526828E−05 − | 0.222943141966376 + |
| | 1.12248035317010e−05i | 4.76318931783756e−06i | 9.54587150437331e−06i | 1.61243893476535e−05i | 0.00000000000000i |
| 278 | −9.52407494936915E−06 − | −4.0414667288093E−06 − | −8.06963298636008E−06 − | −1.35918412858349E−05 − | 0.222943141966376 + |
| | 1.14134172276173e−05i | 4.84319435038259e−06i | 9.67044974306501e−06i | 1.62881283811225e−05i | 0.00000000000000i |
| 279 | −9.84564884231415E−06 − | −4.17821849387055E−06 − | −8.21737532173941E−06 − | −0.000013675250202872 − | 0.222943141966376 + |
| | 1.16044573545808e−05i | 4.92460772334824e−06i | 9.68531206169674e−06i | 1.61181716242424e−05i | 0.00000000000000i |
| 280 | −0.000010177027207973 − | −4.31900431336998E−06 − | −8.34658406459322E−06 − | −1.36916276651737E−05 − | 0.222943141966376 + |
| | 1.17980028045357e−05i | 5.00692628216268e−06i | 9.67601050778418e−06i | 1.58724014676711e−05i | 0.00000000000000i |
| 281 | −1.05187134217165E−05 − | −4.46400308399943E−06 − | −8.54768183774762E−06 − | −1.39132387867116E−05 − | 0.222943141966376 + |
| | 1.19942938785628e−05i | 5.09021994588677e−06i | 9.74676310989988e−06i | 1.58650082115444e−05i | 0.00000000000000i |
| 282 | −1.08712370675915E−05 − | −4.61403690435318E−06 − | −8.87700556668045E−06 − | −1.45095588670514E−05 − | 0.222943141966376 + |
| | 1.21935727406214e−05i | 5.17527069562921e−06i | 9.95677055179806e−06i | 1.62744460800275e−05i | 0.00000000000000i |
| 283 | −1.12349313890646E−05 − | −4.76841440895287E−06 − | −9.31947129480816E−06 − | −1.54346563186522E−05 − | 0.222943141966376 + |
| | 1.23958365768735e−05i | 5.26113455410789e−06i | 1.02824520375500e−05i | 1.70295189815132e−05i | 0.00000000000000i |
| 284 | −1.16099893699239E−05 − | −4.92776267097128E−06 − | −9.79369913380729E−06 − | −1.64426132290239E−05 − | 0.222943141966376 + |
| | 1.26009172245179e−05i | 5.34835369270998e−06i | 1.06296042291488e−05i | 1.78460118826971e−05i | 0.00000000000000i |
| 285 | −1.19970383790805E−05 − | −5.09234080248723E−06 − | −1.01990894587907E−05 − | −1.72294837592603E−05 − | 0.222943141966376 + |
| | 1.28091075129969e−05i | 5.43703693951795e−06i | 1.08894569879953e−05i | 1.83957325876890e−05i | 0.00000000000000i |
| 286 | −1.23964335228823E−05 − | −5.26218025328432E−06 − | −1.04780107908638E−05 − | −1.76208692539942E−05 − | 0.222943141966376 + |
| | 1.30203813053166e−05i | 5.52704076285989e−06i | 1.10053988968999e−05i | 1.85077777567685e−05i | 0.00000000000000i |
| 287 | −1.28089909085531E−05 − | −5.43746960901696E−06 − | −0.000010655060310548 − | −0.000017690378009936 − | 0.222943141966376 + |
| | 1.32351756217338e−05i | 5.61838678214149e−06i | 1.10095787776779e−05i | 1.82789777467977e−05i | 0.00000000000000i |
| 288 | −1.32350753445056E−05 − | −5.61848598297296E−06 − | −1.08272698564313E−05 − | −1.77301300375189E−05 − | 0.222943141966376 + |
| | 1.34534249989419e−05i | 5.71117865308609e−06i | 1.10058960123182e−05i | 1.80226382149240e−05i | 0.00000000000000i |
| 289 | −1.36750943734073E−05 − | −5.80575369527973E−06 − | −1.11081858416758E−05 − | −1.80820927900838E−05 − | 0.222943141966376 + |
| | 1.36750943734073e−05i | 5.80575369527973e−06i | 1.11081858416758e−05i | 1.80820927900838e−05i | 0.00000000000000i |
| 290 | −1.41299377254835E−05 − | −5.99905354854713E−06 − | −1.15578717438915E−05 − | −1.89268931157664E−05 − | 0.222943141966376 + |
| | 1.39006082409969e−05i | 5.90168865675361e−06i | 1.13702869986312e−05i | 1.86197088432307e−05i | 0.00000000000000i |
| 291 | −1.45996091138113E−05 − | −6.19878010263723E−06 − | −1.21418362432874E−05 − | −2.01598419967788E−05 − | 0.222943141966376 + |
| | 1.41294883990913e−05i | 5.99917373581404e−06i | 1.17508580542005e−05i | 1.95106767174729e−05i | 0.00000000000000i |
| 292 | −1.50855176169474E−05 − | −6.40545526843168E−06 − | −1.27466195766224E−05 − | −2.14378872016018E−05 − | 0.222943141966376 + |
| | 1.43626067402861e−05i | 6.09850038619719e−06i | 1.21357906898330e−05i | 2.04105653539720e−05i | 0.00000000000000i |
| 293 | −1.55876892946814E−05 − | −6.61893354818215E−06 − | −1.32460935810183E−05 − | −2.23796228952405E−05 − | 0.222943141966376 + |
| | 1.45994642108913e−05i | 6.19930777578020e−06i | 1.24063204952509e−05i | 2.09608042177110e−05i | 0.00000000000000i |
| 294 | −1.61074455389253E−05 − | −6.8399634812499E−06 − | −0.000013580305153418 − | −2.28032264737829E−05 − | 0.222943141966376 + |
| | 1.48407666006827e−05i | 6.30207324538851e−06i | 1.25123588753334e−05i | 2.10099957204322e−05i | 0.00000000000000i |
| 295 | −0.000016645103247868 − | −7.06870081817972E−06 − | −1.37982027633438E−05 − | −0.000022855478067466 − | 0.222943141966376 + |
| | 1.50862422067398e−05i | 6.40669697521282e−06i | 1.25059620121090e−05i | 2.07149978430271e−05i | 0.00000000000000i |
| 296 | −1.72013234932069E−05 − | −7.3054218056457E−06 − | −1.40348871430305E−05 − | −2.29432000272846E−05 − | 0.222943141966376 + |
| | 1.53359207796439e−05i | 6.51318313486410e−06i | 1.25128695743530e−05i | 2.04551177814260e−05i | 0.00000000000000i |
| 297 | −1.77775817921779E−05 − | −7.55065287661389E−06 − | −1.44330803296124E−05 − | −2.34962860606684E−05 − | 0.222943141966376 + |
| | 1.55905208006691e−05i | 6.62174485301993e−06i | 1.26574717375535e−05i | 2.06056898429502e−05i | 0.00000000000000i |
| 298 | −1.83742808850713E−05 − | −7.80472421452308E−06 − | −1.50542150918765E−05 − | −2.46992952955608E−05 − | 0.222943141966376 + |
| | 1.58497636924197e−05i | 6.73240140707632e−06i | 1.29858552437218e−05i | 2.13057586445118e−05i | 0.00000000000000i |
| 299 | −1.89928440096789E−05 − | −8.06766191909946E−06 − | −0.000015834297794101 − | −2.63581013928143E−05 − | 0.222943141966376 + |
| | 1.61142280868769e−05i | 6.84490138632980e−06i | 1.34344011944532e−05i | 2.23631836055942e−05i | 0.00000000000000i |
| 300 | −1.96334536705901E−05 − | −8.34054973936361E−06 − | −1.66155409587543E−05 − | −0.000027995252279444 − | 0.222943141966376 + |
| | 1.63833916297421e−05i | 6.95988057322904e−06i | 1.38650549839358e−05i | 2.33610035994130e−05i | 0.00000000000000i |
| 301 | −2.02980766116509E−05 − | −8.62360465858025E−06 − | −1.72394123949163E−05 − | −0.000029130826167827 − | 0.222943141966376 + |
| | 1.66582009698015e−05i | 7.07720944380605e−06i | 1.41480201188566e−05i | 2.39070511952522e−05i | 0.00000000000000i |
| 302 | −2.09873794459185E−05 − | −8.91703416274343E−06 − | −1.76471034577909E−05 − | −2.95858304533589E−05 − | 0.222943141966376 + |
| | 1.69384606414986e−05i | 7.19674567249889e−06i | 1.42425960385629e−05i | 2.38780847304757e−05i | 0.00000000000000i |
| 303 | −2.17026241964607E−05 − | −9.22166257768597E−06 − | −1.79247529251944E−05 − | −2.96189117085764E−05 − | 0.222943141966376 + |
| | 1.72244274716662e−05i | 7.31883189791621e−06i | 1.42260956054297e−05i | 2.35072400413819e−05i | 0.00000000000000i |
| 304 | −2.24448760628869E−05 − | −9.53787267083092E−06 − | −0.000018260795214492 − | −0.000029797718251476 − | 0.222943141966376 + |
| | 1.75161531994601e−05i | 7.44342888912603e−06i | 1.42508644567617e−05i | 2.32543675636619e−05i | 0.00000000000000i |
| 305 | −2.32158132342255E−05 − | −9.86648753632047E−06 − | −1.88355826585324E−05 − | −0.000030665610411411 − | 0.222943141966376 + |
| | 1.78141200425000e−05i | 7.57082216317524e−06i | 1.44530509082007e−05i | 2.35305504715242e−05i | 0.00000000000000i |
| 306 | −0.000024016828032418 − | −1.02073115624655E−05 − | −1.97075683145796E−05 − | −3.23977862191745E−05 − | 0.222943141966376 + |
| | 1.81185238970516e−05i | 7.70049309673754e−06i | 1.48675773078154e−05i | 2.44411986058845e−05i | 0.00000000000000i |
| 307 | −2.48493919268389E−05 − | −1.05621756981333E−05 − | −2.07674795515879E−05 − | −3.46626221625437E−05 − | 0.222943141966376 + |
| | 1.84295650970654e−05i | 7.83344337634516e−06i | 1.54022125541285e−05i | 2.57075526620717e−05i | 0.00000000000000i |
| 308 | −2.57150944858475E−05 − | −0.00001093122288643 − | −2.17947298854179E−05 − | −3.67918574528231E−05 − | 0.222943141966376 + |
| | 1.87474730796260e−05i | 7.96935849889730e−06i | 1.58893490369824e−05i | 2.68229369145755e−05i | 0.00000000000000i |
| 309 | −2.66157089411227E−05 − | −1.13152569632293E−05 − | −2.25886867753267E−05 − | −3.81771070717402E−05 − | 0.222943141966376 + |
| | 1.90725473061588e−05i | 8.10839847211950e−06i | 1.61868240316080e−05i | 2.73573280444575e−05i | 0.00000000000000i |
| 310 | −2.75532118188045E−05 − | −1.17148457081801E−05 − | −2.30980924000742E−05 − | −3.86610647265799E−05 − | 0.222943141966376 + |
| | 1.94051611648547e−05i | 8.25052521947528e−06i | 1.62675120625354e−05i | 2.72281938221046e−05i | 0.00000000000000i |
| 311 | −2.85292312568563E−05 − | −1.21311902413939E−05 − | −0.000023466868432914 − | −3.86762344656577E−05 − | 0.222943141966376 + |
| | 1.97453693273446e−05i | 8.39611938856404e−06i | 1.62416568463511e−05i | 2.67682128144199e−05i | 0.00000000000000i |
| 312 | −2.95464565957051E−05 − | −1.25651951151749E−05 − | −2.39604799100754E−05 − | −3.90226768928902E−05 − | 0.222943141966376 + |
| | 2.00938890710612e−05i | 8.54531019591737e−06i | 1.62949903601090e−05i | 2.65384560819200e−05i | 0.00000000000000i |
| 313 | −3.06064796745673E−05 − | −1.30171280735815E−05 − | −2.48093040448056E−05 − | −4.03946393497991E−05 − | 0.222943141966376 + |
| | 2.04505959004726e−05i | 8.69776690581581e−06i | 1.65770469843840e−05i | 2.69908350999901e−05i | 0.00000000000000i |
| 314 | −3.17125546148127E−05 − | −1.34893881199275E−05 − | −2.60608301121539E−05 − | −4.29335017620113E−05 − | 0.222943141966376 + |
| | 2.08164021336012e−05i | 8.85455401027339e−06i | 1.71065600403141e−05i | 2.81819313687276e−05i | 0.00000000000000i |
| 315 | −0.000032866540260268 − | −1.39821972302682E−05 − | −2.75347963175462E−05 − | −4.60916619130606E−05 − | 0.222943141966376 + |
| | 2.11911896393253e−05i | 9.01522918855218e−06i | 1.77534685982966e−05i | 2.97182831127532e−05i | 0.00000000000000i |
| 316 | −0.000034071700841635 − | −1.44965427116516E−05 − | −0.000028918606158847 − | −4.89206229498114E−05 − | 0.222943141966376 + |
| | 2.15756666072587e−05i | 9.17983443086453e−06i | 1.83125053876797e−05i | 3.09786428300245e−05i | 0.00000000000000i |
| 317 | −3.53307529928901E−05 − | −1.50343795338168E−05 − | −0.000029955156204473 − | −5.06389220700128E−05 − | 0.222943141966376 + |
| | 2.19700740302798e−05i | 9.34897796896092e−06i | 1.86273131380286e−05i | 3.14893052779165e−05i | 0.00000000000000i |
| 318 | −3.66466869797692E−05 − | −1.55967705792916E−05 − | −3.06126363666638E−05 − | −5.11460613829027E−05 − | 0.222943141966376 + |
| | 2.23747206145297e−05i | 9.52264482716339e−06i | 1.86906168723092e−05i | 3.12273476346662e−05i | 0.00000000000000i |
| 319 | −3.80236360643992E−05 − | −1.61849885364487E−05 − | −0.000031127277896868 − | −5.11524563799101E−05 − | 0.222943141966376 + |
| | 2.27904903917164e−05i | 9.70090880064765e−06i | 1.86569723796899e−05i | 3.06596024552889e−05i | 0.00000000000000i |
| 320 | −3.94654958854362E−05 − | −1.68012112819837E−05 − | −3.18802697446574E−05 − | −5.18075706777835E−05 − | 0.222943141966376 + |
| | 2.32179692452151e−05i | 9.88433055446310e−06i | 1.87555003644016e−05i | 3.04789425719574e−05i | 0.00000000000000i |
| 321 | −4.09751054538024E−05 − | −1.74468574314648E−05 − | −3.31712097379085E−05 − | −5.40144053409384E−05 − | 0.222943141966376 + |
| | 2.36569881638277e−05i | 1.00729478345688e−05i | 1.91514068715272e−05i | 3.11852314637086e−05i | 0.00000000000000i |
| 322 | −4.25577019057339E−05 − | −0.000018124143435432 − | −3.50217124372394E−05 − | −5.78345101580052E−05 − | 0.222943141966376 + |
| | 2.41086403418777e−05i | 1.02672004366525e−05i | 1.98395550393303e−05i | 3.27628453208469e−05i | 0.00000000000000i |
| 323 | −4.42179263929572E−05 − | −1.88341778221057E−05 − | −3.71365198981245E−05 − | −6.23692932065085E−05 − | 0.222943141966376 + |
| | 2.45734896781578e−05i | 1.04668290004178e−05i | 2.06380977771182e−05i | 3.46608560795879e−05i | 0.00000000000000i |
| 324 | −4.59609446368236E−05 − | −1.95801441636574E−05 − | −3.90622419600333E−05 − | −6.62398525096543E−05 − | 0.222943141966376 + |
| | 2.50522169778040e−05i | 1.06726705449742e−05i | 2.12918983488037e−05i | 3.61057669889600e−05i | 0.00000000000000i |
| 325 | −4.77916582371936E−05 − | −2.03642282375208E−05 − | −4.04628000936289E−05 − | −6.84210431717816E−05 − | 0.222943141966376 + |
| | 2.55451735333419e−05i | 1.08849067679995e−05i | 2.16278172417954e−05i | 3.65718095086871e−05i | 0.00000000000000i |
| 326 | −4.97166597293641E−05 − | −2.11891219562385E−05 − | −4.13486856165988E−05 − | −6.89367156887037E−05 − | 0.222943141966376 + |
| | 2.60534226302589e−05i | 1.11039066682085e−05i | 2.16682855895636e−05i | 3.61254637450846e−05i | 0.00000000000000i |
| 327 | −5.17423083966349E−05 − | −2.20569110102448E−05 − | −4.21097864434995E−05 − | −0.000068960481144762 − | 0.222943141966376 + |
| | 2.65776660970125e−05i | 1.13296301252739e−05i | 2.16298784919426e−05i | 3.54218568623812e−05i | 0.00000000000000i |
| 328 | −5.38759571758538E−05 − | −2.29719405888422E−05 − | −4.33103802527778E−05 − | −7.01954491967754E−05 − | 0.222943141966376 + |
| | 2.71188778785298e−05i | 1.15631031747276e−05i | 2.18006133814711e−05i | 3.53334198440672e−05i | 0.00000000000000i |
| 329 | −5.61246427309316E−05 − | −2.39364106998914E−05 − | −4.53512218814331E−05 − | −7.38498488181735E−05 − | 0.222943141966376 + |
| | 2.76776108503997e−05i | 1.18041314522588e−05i | 2.23647476357594e−05i | 3.64187151577862e−05i | 0.00000000000000i |
| 330 | −5.84973811610458E−05 − | −2.49545656740484E−05 − | −4.81991434938293E−05 − | −7.98157496469018E−05 − | 0.222943141966376 + |
| | 2.82551258139093e−05i | 1.20534351924327e−05i | 2.32809202140430e−05i | 3.85522223977155e−05i | 0.00000000000000i |
| 331 | −6.10029233696508E−05 − | −2.60304930242216E−05 − | −5.13636330010015E−05 − | −8.65958813867411E−05 − | 0.222943141966376 + |
| | 2.88522339802439e−05i | 1.23115062995393e−05i | 2.42931891712826e−05i | 4.09568016331913e−05i | 0.00000000000000i |
| 332 | −6.36518210619999E−05 − | −2.71685335545529E−05 − | −5.41630960152589E−05 − | −9.21097666645459E−05 − | 0.222943141966376 + |
| | 2.94702716057447e−05i | 1.25788084240768e−05i | 2.50770696571733e−05i | 4.26460672429456e−05i | 0.00000000000000i |
| 333 | −6.64544241915751E−05 − | −0.000028373246222968 − | −5.61444770829455E−05 − | −9.49671870090555E−05 − | 0.222943141966376 + |
| | 3.01101078724246e−05i | 1.28557506119024e−05i | 2.54387316115317e−05i | 4.30290726308931e−05i | 0.00000000000000i |
| 334 | −6.94237851303654E−05 − | −2.96507223423127E−05 − | −5.74068422579071E−05 − | −9.54525253259385E−05 − | 0.222943141966376 + |
| | 3.07734474872007e−05i | 1.31432612791896e−05i | 2.54467030616716e−05i | 4.23111945008846e−05i | 0.00000000000000i |
| 335 | −7.25723405740277E−05 − | −3.10059473946233E−05 − | −5.86112782456336E−05 − | −9.55579050605189E−05 − | 0.222943141966376 + |
| | 3.14612652914429e−05i | 1.34415719388260e−05i | 2.54089224540792e−05i | 4.14258735218379e−05i | 0.00000000000000i |
| 336 | −7.59154851433915E−05 − | −3.24459379646289E−05 − | −6.06328083776101E−05 − | −0.000097927935971286 − | 0.222943141966376 + |
| | 3.21753570438915e−05i | 1.37516033344733e−05i | 2.56980806279310e−05i | 4.15049221973081e−05i | 0.00000000000000i |
| 337 | −0.000079469096206831 − | −3.39777521817598E−05 − | −6.40322699453828E−05 − | −0.000104254158323897 − | 0.222943141966376 + |
| | 3.29171774384170e−05i | 1.40740457726184e−05i | 2.65230346409127e−05i | 4.31834863115499e−05i | 0.00000000000000i |
| 338 | −8.32511979610567E−05 − | −3.56091966302074E−05 − | −6.86628005462429E−05 − | −0.000114074847975897 − | 0.222943141966376 + |
| | 3.36884974671954e−05i | 1.44096464659514e−05i | 2.77851447059633e−05i | 4.61616207481419e−05i | 0.00000000000000i |
| 339 | −8.72819270438487E−05 − | −3.73495917159477E−05 − | −7.36798914159257E−05 − | −0.000124800142430307 − | 0.222943141966376 + |
| | 3.44912958044415e−05i | 1.47594795358117e−05i | 2.91161643164583e−05i | 4.93174105429368e−05i | 0.00000000000000i |
| 340 | −0.000091583006451724 − | −3.92084609747408E−05 − | −7.80018703932088E−05 − | −0.000133109330638505 − | 0.222943141966376 + |
| | 3.53274639355126e−05i | 1.51243723559326e−05i | 3.00886416594240e−05i | 5.13459347951285e−05i | 0.00000000000000i |
| 341 | −9.61794349596169E−05 − | −4.11964863385522E−05 − | −0.000080986909480333 − | −0.000137012521154978 − | 0.222943141966376 + |
| | 3.61993760323146e−05i | 1.55052595266918e−05i | 3.04813143392310e−05i | 5.15678614301191e−05i | 0.00000000000000i |
| 342 | −0.000101098637409348 − | −4.33264364648468E−05 − | −0.000082922946399442 − | −0.000137348736331154 − | 0.222943141966376 + |
| | 3.71094331706775e−05i | 1.59034734761637e−05i | 3.04378339469234e−05i | 5.04154544766080e−05i | 0.00000000000000i |
| 343 | −0.000106371507827939 − | −4.56121510726411E−05 − | −8.49903305426602E−05 − | −0.000137680356392973 − | 0.222943141966376 + |
| | 3.80603340856893e−05i | 1.63202886152515e−05i | 3.04100265245765e−05i | 4.92628192300287e−05i | 0.00000000000000i |
| 344 | −0.00011203266601707 − | −4.80689649584376E−05 − | −8.86452727568561E−05 − | −0.000142418384732352 − | 0.222943141966376 + |
| | 3.90550153655732e−05i | 1.67570248196448e−05i | 3.09020807295353e−05i | 4.96475929905556e−05i | 0.00000000000000i |
| 345 | −0.000118121070626924 − | −5.07141102618967E−05 − | −9.47344702958592E−05 − | −0.000154118244356584 − | 0.222943141966376 + |
| | 4.00967004858107e−05i | 1.72151207128687e−05i | 3.21580194030951e−05i | 5.23160944153875e−05i | 0.00000000000000i |
| 346 | −0.000124680281109791 − | −5.35683472889779E−05 − | −0.000102869185479436 − | −0.00017155671165127 − | 0.222943141966376 + |
| | 4.11888013134261e−05i | 1.76965915823632e−05i | 3.39833885861635e−05i | 5.66746822135086e−05i | 0.00000000000000i |
| 347 | −0.000131760481241592 − | −5.66536528381939E−05 − | −0.000111501789465304 − | −0.000189949416188939 − | 0.222943141966376 + |
| | 4.23353735890160e−05i | 1.82031329537244e−05i | 3.58261435323855e−05i | 6.10318012016785e−05i | 0.00000000000000i |
| 348 | −0.000139417938157692 − | −5.99956109844393E−05 − | −0.0001187679074518 − | −0.000203514677078956 − | 0.222943141966376 + |
| | 4.35406643856549e−05i | 1.87368196446213e−05i | 3.70915942846347e−05i | 6.35582792956453e−05i | 0.00000000000000i |
| 349 | −0.000147716707640931 − | −6.36237142075123E−05 − | −0.00012367772523451 − | −0.000209122295678756 − | 0.222943141966376 + |
| | 4.48093733762709e−05i | 1.93000427036386e−05i | 3.75172277859888e−05i | 6.34365548625046e−05i | 0.00000000000000i |
| 350 | −0.0001567303030202 − | −6.75716871518345E−05 − | −0.000126948041882199 − | −0.000208861717286085 − | 0.222943141966376 + |
| | 4.61468148615685e−05i | 1.98954387045230e−05i | 3.73778884675630e−05i | 6.14961039029450e−05i | 0.00000000000000i |
| 351 | −0.000166542847866721 − | −7.18781616085955E−05 − | −0.000130876870117317 − | −0.000209684751237558 − | 0.222943141966376 + |
| | 4.75588470491449e−05i | 2.05259039214516e−05i | 3.73738838257508e−05i | 5.98786747097409e−05i | 0.00000000000000i |
| 352 | −0.000177251538157516 − | −7.65885056190812E−05 − | −0.000138171663176996 − | −0.000219825925349513 − | 0.222943141966376 + |
| | 4.90521067979044e−05i | 2.11948939691575e−05i | 3.82372488783630e−05i | 6.08340264873148e−05i | 0.00000000000000i |
| 353 | −0.000188968168967078 − | −8.17541771123051E−05 − | −0.000150296948962538 − | −0.000243713372064012 − | 0.222943141966376 + |
| | 5.06338682699159e−05i | 2.19059657351122e−05i | 4.02719460993736e−05i | 6.53028012292179e−05i | 0.00000000000000i |
| 354 | −0.000201823304919223 − | −8.74367744575196E−05 − | −0.000166319802573595 − | −0.000278370688566483 − | 0.222943141966376 + |
| | 5.23125120230373e−05i | 2.26635735496215e−05i | 4.31100198031276e−05i | 7.21535602557090e−05i | 0.00000000000000i |
| 355 | −0.000215967902256744 − | −9.37079315294562E−05 − | −0.000183098830051965 − | −0.000313934669420212 − | 0.222943141966376 + |
| | 5.40971433351853e−05i | 2.34726149146370e−05i | 4.58638693543011e−05i | 7.86365410417314e−05i | 0.00000000000000i |
| 356 | −0.000231580423402865 − | −0.000100651453016441 − | −0.000196967213904722 − | −0.000338801050439417 − | 0.222943141966376 + |
| | 5.59984613781491e−05i | 2.43385275040732e−05i | 4.76286413097081e−05i | 8.19254808291939e−05i | 0.00000000000000i |
| 357 | −0.000248869381542202 − | −0.00010836769033778 − | −0.000206133225498234 − | −0.000347052321069188 − | 0.222943141966376 + |
| | 5.80282010426138e−05i | 2.52678014566358e−05i | 4.80635270463980e−05i | 8.09212516803461e−05i | 0.00000000000000i |
| 358 | −0.000268082788952671 − | −0.000116976791964037 − | −0.000212399183837635 − | −0.00034386051461315 − | 0.222943141966376 + |
| | 6.02000033780020e−05i | 2.62680170513535e−05i | 4.76958317035705e−05i | 7.72164607140354e−05i | 0.00000000000000i |
| 359 | −0.000289515918074259 − | −0.000126621437140172 − | −0.000220933646827292 − | −0.000344901851448028 − | 0.222943141966376 + |
| | 6.25294450976623e−05i | 2.73476092593045e−05i | 4.77170942150768e−05i | 7.44916601741761e−05i | 0.00000000000000i |
| 360 | −0.00031352201056601 − | −0.000137477005084686 − | −0.000237795181263614 − | −0.000368739610300443 − | 0.222943141966376 + |
| | 6.50342943170423e−05i | 2.85170409387274e−05i | 4.93261757844462e−05i | 7.64881556460312e−05i | 0.00000000000000i |
| 361 | −0.000340527721735631 − | −0.000149755373765489 − | −0.000266276338905944 − | −0.000425372239223294 − | 0.222943141966376 + |
| | 6.77351752888284e−05i | 2.97881959235138e−05i | 5.29656569489694e−05i | 8.46117991214916e−05i | 0.00000000000000i |
| 362 | −0.000371050367924866 − | −0.000163718152966923 − | −0.000304151511652328 − | −0.000507377898724149 − | 0.222943141966376 + |
| | 7.06558064965982e−05i | 3.11753851659120e−05i | 5.79168549896329e−05i | 9.66154401985745e−05i | 0.00000000000000i |
| 363 | −0.000405723861344955 − | −0.000179690276265978 − | −0.000343862135332837 − | −0.00059009006817296 − | 0.222943141966376 + |
| | 7.38239640812182e−05i | 3.26957563127509e−05i | 6.25678407071030e−05i | 0.000107370534858548i | 0.00000000000000i |
| 364 | −0.000445329812424406 − | −0.000198079194668393 − | −0.000376336464924904 − | −0.000643237157375118 − | 0.222943141966376 + |
| | 7.72720526457333e−05i | 3.43700006858183e−05i | 6.53005712145638e−05i | 0.000111612234576868i | 0.00000000000000i |
| 365 | −0.00049084135771597 − | −0.000219401798497061 − | −0.000397024180551033 − | −0.000649914904699368 − | 0.222943141966376 + |
| | 8.10382361352729e−05i | 3.62233835344348e−05i | 6.55489574974343e−05i | 0.000107301385033934i | 0.00000000000000i |
| 366 | −0.000543481449436052 − | −0.000244322881627902 − | −0.000410920883900096 − | −0.000622931453112793 − | 0.222943141966376 + |
| | 8.51676632348910e−05i | 3.82872477517959e−05i | 6.43944176797625e−05i | 9.76180811179184e−05i | 0.00000000000000i |
| 367 | −0.000604802235926397 − | −0.000273706565626464 − | −0.0004330362619337 − | −0.000607126274975368 − | 0.222943141966376 + |
| | 8.97139369315469e−05i | 4.06005337079245e−05i | 6.42348615538498e−05i | 9.00586755589494e−05i | 0.00000000000000i |
| 368 | −0.000676796527974074 − | −0.000308695941795312 − | −0.000482514856367271 − | −0.000661222201309312 − | 0.222943141966376 + |
| | 9.47411514785205e−05i | 4.32127054049460e−05i | 6.75446921020236e−05i | 9.25609842041118e−05i | 0.00000000000000i |
| 369 | −0.000762053644118018 − | −0.000350826481518697 − | −0.00057199214001143 − | −0.000822989442665524 − | 0.222943141966376 + |
| | 0.000100326265543713i | 4.61871825117350e−05i | 7.53041938328635e−05i | 0.000108348615614975i | 0.00000000000000i |
| 370 | −0.000863983355666744 − | −0.000402203316118745 − | −0.000697267648867836 − | −0.00107263758760927 − | 0.222943141966376 + |
| | 0.000106562183139441i | 4.96070475784343e−05i | 8.59997619265700e−05i | 0.000132297228069695i | 0.00000000000000i |
| 371 | −0.000987139248257589 − | −0.000465773390164515 − | −0.000834057951441377 − | −0.00131551176813081 − | 0.222943141966376 + |
| | 0.000113561226936726i | 5.35829142189677e−05i | 9.59506416842419e−05i | 0.000151337443731804i | 0.00000000000000i |
| 372 | −0.00113769489689755 − | −0.000545765303890035 − | −0.000947010923651072 − | −0.00140171888534825 − | 0.222943141966376 + |
| | 0.000121458990786292i | 5.82652723479941e−05i | 0.000101101790439525i | 0.000149645886295837i | 0.00000000000000i |
| 373 | −0.00132416176014599 − | −0.000648425565471783 − | −0.00101125095364551 − | −0.00118656580330574 − | 0.222943141966376 + |
| | 0.000130418550028669i | 6.38643439159887e−05i | 9.95995255708171e−05i | 0.000116866531143203i | 0.00000000000000i |
| 374 | −0.00155847185779321 − | −0.000783290949090267 − | −0.00104012558524212 − | −0.000616076537001793 − | 0.222943141966376 + |
| | 0.000140632256504066i | 7.06820422319056e−05i | 9.38581004005655e−05i | 5.55930690339550e−05i | 0.00000000000000i |
| 375 | −0.00185764269279769 − | −0.000965499862978986 − | −0.00110741921177174 − | 0.000195322390845901 + | 0.222943141966376 + |
| | 0.000152318023549662i | 7.91664788048912e−05i | 9.08032024845183e−05i | 1.60155236763189e−05i | 0.00000000000000i |
| 376 | −0.00224631005514697 − | −0.00122021575028442 − | −0.00135102917743895 − | 0.000933768743362836 + | 0.222943141966376 + |
| | 0.000165697784241081i | 9.00085211544694e−05i | 9.96578992440265e−05i | 6.88789205275911e−05i | 0.00000000000000i |
| 377 | −0.00276044653412219 − | −0.00159162409063382 − | −0.00194954879933034 − | 0.00112985647041145 + | 0.222943141966376 + |
| | 0.000180929224762691i | 0.000104320554400293i | 0.000127780179235400i | 7.40547055549687e−05i | 0.00000000000000i |
| 378 | −0.00345208803157033 − | −0.00216255871708628 − | −0.00307260286182962 − | 0.00028023621507339 + | 0.222943141966376 + |
| | 0.000197912715887953i | 0.000123982315935037i | 0.000176156335431914i | 1.60663082482599e−05i | 0.00000000000000i |
| 379 | −0.004391864397155 − | −0.00310078472214803 − | −0.00481697296383249 − | −0.00198216477291061 − | 0.222943141966376 + |
| | 0.000215758462446909i | 0.000152331785212430i | 0.000236642707137784i | 9.73775110171095e−05i | 0.00000000000000i |
| 380 | −0.00565184784886804 − | −0.00477672254605813 − | −0.00714903951390531 − | −0.00572392545269545 − | 0.222943141966376 + |
| | 0.000231324400906269i | 0.000195506409728221i | 0.000292602937451793i | 0.000234274464136911i | 0.00000000000000i |
| 381 | −0.00719171509466074 − | −0.00806946177713652 − | −0.00987583710564786 − | −0.0106149788499581 − | 0.222943141966376 + |
| | 0.000235432375255003i | 0.000264166826440490i | 0.000323301431829571i | 0.000347498427153020i | 0.00000000000000i |
| 382 | −0.0084692180700081 − | −0.0148526820856568 − | −0.0126603429980562 − | −0.01594642400361 − | 0.222943141966376 + |
| | 0.000207907633958708i | 0.000364612879824798i | 0.000310793976028661i | 0.000391462736853319i | 0.00000000000000i |
| 383 | −0.011197683917507 − | −0.0221560507253019 − | −0.0150830591766636 − | −0.0207722036455973 − | 0.222943141966376 + |
| | 0.000183238027721913i | 0.000362559888894852i | 0.000246818005929220i | 0.000339914723035389i | 0.00000000000000i |
| 384 | −0.0467083079673027 − | −0.0361357727970705 − | −0.016736036129274 − | −0.0241410219132066 − | 0.222943141966376 + |
| | 0.000382139976872221i | 0.000295641695918402i | 0.000136924430314419i | 0.000197507680261989i | 0.00000000000000i |

FIG. 39 illustrates a flowchart of a method of UE 1900 according to embodiments of the present disclosure. The method 1100 as may be performed by a UE (e.g., 111-116 as illustrated in FIG. 1). One or more of the components illustrated in FIG. 39 can be implemented in specialized circuitry configured to perform the noted functions or one or more of the components can be implemented by one or more processors executing instructions to perform the noted functions.

As illustrated in FIG. 39, the method 1900 begins at step 3902. In step 3902, a UE converts, using a DFT, a modulated block of data symbols to a first symbol block in a frequency domain.

In step 3904, the UE extends, based on a spectral extension ratio associated with Nₛₑ, the first symbol block to a second symbol block with a length that is identified based on N_{SC}, wherein the second symbol block is symmetrically extended DFT symbol block.

In step 3906, the UE generates, using an FDSS filter with Nₚ, third symbol block based on the second symbol block that is symmetrically extended DFT symbol block.

In step 3908, the UE maps the generated third symbol block to the N_{SC}.

In step 3910, the UE generates, based on the mapped third symbol block, OFDM symbols in a time domain using an IFFT.

In step 3912, the UE transmits, to a BS, signals including the OFDM symbols.

In one embodiment, the UE identifies the Nₚ based on a number of extended subcarriers and a number of total subcarriers.

In such embodiment, based on the Nₚ, the FDSS filter is identified as one of: (1) an ISI-free-flat FDSS filter with the number of Nₛₑ, (2) a flat FDSS filter with twice the Nₛₑ, or (3) a non-flat FDSS filter with the N_{SC}.

In one embodiment, the UE identifies polynomial coefficients with a D^{th} order and applies a set of FDSS parameters including the polynomial coefficients to the FDSS filter.

In one embodiment, the UE identifies Pₘ in the frequency domain, each of the Pₘ in the frequency domain corresponding to a set of reference FDSS subcarriers and applies a set of FDSS parameters including the Pₘ in the frequency domain to the FDSS filter.

In one embodiment, the UE re-samples a set of reference taps (N_{p_ref}) to obtain the Nₚ for the FDSS filter and utilizes the number Nₚ to obtain the N_{SC} for the FDSS filter.

In one embodiment, the UE maps the Nₚ to a set of subcarrier indexes based on the Pₘ in the frequency domain and constructs the FDSS filter based on the mapped set of subcarrier indexes.

In one embodiment, the UE identifies h in the time domain based on N_{p_ref} and applies a set of FDSS parameters including the h in the time domain to the FDSS filter.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to:
convert, using a discrete Fourier transform (DFT), a modulated block of data symbols to a first symbol block in a frequency domain;
extend, based on a spectral extension ratio associated with extended subcarriers (Nₛₑ), the first symbol block to a second symbol block with a length that is identified based on a number of scheduled subcarriers (N_{SC}), wherein the second symbol block is symmetrically extended DFT symbol block,
generate, using a frequency domain spectrum shaping (FDSS) filter with a number of tap values (N_{P}), third symbol block based on the second symbol block that is symmetrically extended DFT symbol block, and
map the generated third symbol block to the N_{SC}, and
generate, based on the mapped third symbol block, orthogonal frequency division multiplexing (OFDM) symbols in a time domain using an inverse fast Fourier transform (IFFT); and
a transceiver operably coupled to the processor, the transceiver configured to transmit, to a base station (BS), signals including the OFDM symbols.

2. The UE of claim 1, wherein the processor is further configured to identify the Nₚ based on a number of extended subcarriers and a number of total subcarriers.

3. The UE of claim 2, wherein, based on the Nₚ, the FDSS filter is identified as one of:
an inter symbol interference-free-flat (ISI-Free-Flat) FDSS filter with the number of Nₛₑ,
a flat FDSS filter with twice the Nₛₑ, or
a non-flat FDSS filter with the N_{sc}/2.

4. The UE of claim 1, wherein the processor is further configured to:
identify polynomial coefficients with a D^{th} order; and
apply a set of FDSS parameters including the polynomial coefficients to the FDSS filter.

5. The UE of claim 1, wherein the processor is further configured to:
identify tap values (Pₘ) in the frequency domain, each of the Pₘ in the frequency domain corresponding to a set of reference FDSS subcarriers; and
apply a set of FDSS parameters including the Pₘ in the frequency domain to the FDSS filter.

6. The UE of claim 5, wherein the processor is further configured to:
re-sample a set of reference taps (N_{p_ref}) to obtain the Nₚ for the FDSS filter; and
utilize the number Nₚ to obtain the N_{SC} for the FDSS filter.

7. The UE of claim 6, wherein the processor is further configured to:
map the Nₚ to a set of subcarrier indexes based on the Pₘ in the frequency domain; and
construct the FDSS filter based on the mapped set of subcarrier indexes.

8. The UE of claim 1, wherein the processor is further configured to:
identify tap values (h) in the time domain based on a set of reference taps (N_{p_ref}); and
apply a set of FDSS parameters including the h in the time domain to the FDSS filter.

9. A method of a user equipment (UE) in a wireless communication system, the method comprising:
converting, using a discrete Fourier transform (DFT), a modulated block of data symbols to a first symbol block in a frequency domain;
extending, based on a spectral extension ratio associated with extended subcarriers (Nₛₑ), the first symbol block to a second symbol block with a length that is identified based on a number of scheduled subcarriers (N_{SC}), wherein the second symbol block is symmetrically extended DFT symbol block;
generating, using a frequency domain spectrum shaping (FDSS) filter with a number of tap values (N_{P}), third symbol block based on the second symbol block that is symmetrically extended DFT symbol block;
mapping the generated third symbol block to the N_{SC};
generating, based on the mapped third symbol block, orthogonal frequency division multiplexing (OFDM) symbols in a time domain using an inverse fast Fourier transform (IFFT); and
transmitting, to a base station (BS), signals including the OFDM symbols.

10. The method of claim 9, further comprising identifying the Nₚ based on a number of extended subcarriers and a number of total subcarriers.

11. The method of claim 10, wherein, based on the Nₚ, the FDSS filter is identified as one of:
an inter symbol interference-free-flat (ISI-Free-Flat) FDSS filter with the number of Nₛₑ,
a flat FDSS filter with twice the Nₛₑ, or
a non-flat FDSS filter with the N_{sc}/2.

12. The method of claim 9, further comprising:
identifying polynomial coefficients with a D^{th} order; and
applying a set of FDSS parameters including the polynomial coefficients to the FDSS filter.

13. The method of claim 9, further comprising:
identifying tap values (Pₘ) in the frequency domain, each of the Pₘ in the frequency domain corresponding to a set of reference FDSS subcarriers; and
applying a set of FDSS parameters including the Pₘ in the frequency domain to the FDSS filter.

14. The method of claim 13, further comprising:
re-sample a set of reference taps (N_{p_ref}) to obtain the Nₚ for the FDSS filter; and
utilize the number Nₚ to obtain the N_{SC} for the FDSS filter.

15. The method of claim 13, further comprising:
mapping the Nₚ to a set of subcarrier indexes based on the Pₘ in the frequency domain; and
constructing the FDSS filter based on the mapped set of subcarrier indexes.

16. The method of claim 9, further comprising:
identifying tap values (h) in the time domain based on a set of reference taps (N_{p_ref}); and
applying a set of FDSS parameters including the h in the time domain to the FDSS filter.

17. A base station (BS) in a wireless communication system, the BS comprising:
a processor; and
a transceiver operably coupled to the processor, the transceiver configured to receive, from a user equipment (UE), signals including orthogonal frequency division multiplexing (OFDM) symbols,
wherein:
a modulated block of data symbols is converted to a first symbol block in a frequency domain using a discrete Fourier transform (DFT),
based on a spectral extension ratio associated with extended subcarriers (Nₛₑ), the first symbol block is extended to a second symbol block with a length that is identified based on a number of scheduled subcarriers (N_{SC}), wherein the second symbol block is symmetrically extended DFT symbol block,
using a frequency domain spectrum shaping (FDSS) filter with a number of tap values (N_{P}), third symbol block is generated based on the second symbol block that is symmetrically extended DFT symbol block,
the generated third symbol block is mapped to the N_{SC}, and
based on the mapped third symbol block, the OFDM symbols are generated in a time domain using an inverse fast Fourier transform (IFFT).

18. The BS of claim 1, wherein the Nₚ is identified based on a number of extended subcarriers and a number of total subcarriers.

19. The BS of claim 18, wherein, based on the Nₚ, the FDSS filter is identified as one of:
an inter symbol interference-free-flat (ISI-Free-Flat) FDSS filter with the number of Nₛₑ,
a flat FDSS filter with twice the Nₛₑ, or
a non-flat FDSS filter with the N_{sc}/2.

20. The BS of claim 17, wherein:
polynomial coefficients are identified with a D^{th} order;
a set of FDSS parameters including the polynomial coefficients is applied to the FDSS filter;
tap values (Pₘ) in the frequency domain are identified, each of the Pₘ in the frequency domain corresponding to a set of reference FDSS subcarriers; and
a set of FDSS parameters including the Pₘ in the frequency domain is applied to the FDSS filter.
